(19) United States
(12) Patent Application Publication
(10) Pub. No.: US 2026/0291767 A1
(43) Pub. Date: Sep. 24, 2026

(54) System

(71) Applicant: Softbank Group Corp., Tokyo (JP)

(72) Inventor: Junya Hirooka, Tokyo (JP)

(21) Appl. No.: 19/083,708

(22) Filed: Mar. 19, 2025

(51) Int. Cl. H04L 12/18; G06F 40/30

(52) U.S. Cl. CPC H04L 12/1831; G06F 40/30

(57) ABSTRACT

A system including: theme input means that accepts theme input from a user; generative AI means that generates ideas and questions related to said theme; evaluation means that supports expansion for ideas generated by said generative AI means; emotion recognition means that recognizes emotions of said user; means for evaluating ideas and questions based on the emotions recognized by said emotion recognition means; and means for linking said input means and system including means for evaluating ideas and questions based on the emotion and generating new ideas and questions, and means for interfacing with the input means and the conferencing tool.

### TECHNICAL FIELD

The technology of this disclosure relates to a system.

### RELATED ART

JP 2022-180282 discloses a persona chatbot control method, carried out by at least one processor, comprising the steps of: receiving a user utterance; adding said user utterance to a prompt containing a description of the chatbot character and associated instructions The method is disclosed, including the steps of adding the prompt to a prompt, encoding said prompt, and inputting said encoded prompt into a language model to generate a chatbot utterance in response to said user utterance.

In conventional brainstorming, the generation of ideas, organization of information, and evaluation are done by human hands, resulting in variations in the quality and quantity of ideas, as well as significant time and effort.

### SUMMARY

The invention uses a generative AI to generate relevant ideas and questions based on theme input from the user. The system also provides evaluation buttons for the generated ideas, such as “original,” “realistic,” “review from a manager's perspective,” etc., to support idea expansion. Furthermore, in addition to input from the WebUI, information from meeting minutes will be utilized through linkage with web conferencing tools. This will streamline the brainstorming process, including idea generation, information organization, and evaluation, and improve the quality and quantity of ideas.

### BRIEF DESCRIPTION OF THE DRAWINGS

Exemplary embodiments of the present disclosure will be described in detail based on the following figures, wherein:

FIG. 1 is a conceptual diagram showing an example of implement of a data processing system.

FIG. 2 is a conceptual diagram showing an example of the key functions of the data processing device and smart device of the first exemplary embodiment.

FIG. 3 is a conceptual diagram showing an example of implement of a data processing system for the second exemplary embodiment.

FIG. 4 is a conceptual diagram showing an example of the key functions of the data processing device and smart glasses of the second exemplary embodiment.

FIG. 5 is a conceptual diagram showing an example of implement of a data processing system for the third exemplary embodiment.

FIG. 6 is a conceptual diagram showing an example of the key functions of the data processing device and headset-type terminal for the third exemplary embodiment.

FIG. 7 is a conceptual diagram showing an example of implement of a data processing system for the fourth exemplary embodiment.

FIG. 8 is a conceptual diagram showing an example of the key functions of the data processing device and robot of the fourth exemplary embodiment.

FIG. 9 shows an emotion map where multiple emotions are mapped.

FIG. 10 shows an emotion map where multiple emotions are mapped.

FIG. 11 is a sequence diagram showing the flow of data processing system processing in Example 1 of implement example.

FIG. 12 is a sequence diagram showing the flow of data processing system processing in example of application of example of implement 1.

FIG. 13 is a sequence diagram showing the flow of data processing system processing in Example 2 of implement example.

FIG. 14 is a sequence diagram showing the flow of data processing system processing in example of application 2 of example of implement.

FIG. 15 is a sequence diagram showing the flow of data processing system processing in Example 3 of implement example.

FIG. 16 is a sequence diagram showing the flow of data processing system processing in example of application 3 of implement.

FIG. 17 is a sequence diagram showing the flow of data processing system processing in Example 1 of embodiment when the emotional engine is combined.

FIG. 18 is a sequence diagram showing the flow of data processing system processing in example of application 1 of example of implement when combined with an emotion engine.

FIG. 19 is a sequence diagram showing the flow of data processing system processing in Example 2 of exemplary embodiment when the emotional engine is combined.

FIG. 20 is a sequence diagram showing the flow of data processing system processing in example of application 2 of example of implement when combined with an emotion engine.

FIG. 21 is a sequence diagram showing the flow of processing of the data processing system in Example 3 of exemplary embodiment when the emotional engine is combined.

FIG. 22 is a sequence diagram showing the flow of data processing system processing in example of application 3 of example of implement when combined with an emotion engine.

### DETAILED DESCRIPTION

The following is an example of implementations of systems for the technology of the present disclosure according to the accompanying drawings.

First, let us explain the wording used in the following description.

In the following exemplary embodiments, a signed processor (hereinafter simply referred to as “processor”) may be one arithmetic device or a combination of multiple arithmetic devices. The processor may be one type of computing device or a combination of multiple types of computing devices. Examples of computing devices include CPUs (Central Processing Units), GPUs (Graphics Processing Units), GPGPUs (General-Purpose computing on Graphics Processing Units), APUs (Accelerated Processing Units), or Accelerated Processing Unit), or TPU (Tensor Processing Unit (registered trademark)).

In the following exemplary embodiment, signed RAM (Random Access Memory) is a memory in which information is temporarily stored and is used by the processor as work memory.

In the following exemplary embodiments, the signed storage is one or more non-volatile storage devices that store various programs and parameters. Examples of non-volatile storage devices include flash memory (SSD (Solid State Drive)), magnetic disks (e.g., hard disks), or magnetic tapes.

In the following exemplary embodiment, a signed communication I/F (Interface) is an interface that includes a communication processor and antenna, etc. The communication I/F is responsible for communication between multiple computers. Examples of communication standards applicable to the communication I/F include wireless communication standards including 5G (5th Generation Mobile Communication System), Wi-Fi (registered trademark), or Bluetooth (registered trademark).

In the following exemplary embodiments, “A and/or B” is synonymous with “at least one of A and B”. In other words, “A and/or B” means that it may be only A, only B, or a combination of A and B. The same concept as “A and/or B” also applies when three or more matters are expressed in this document by linking them together with “and/or”.

### First Exemplary Embodiment

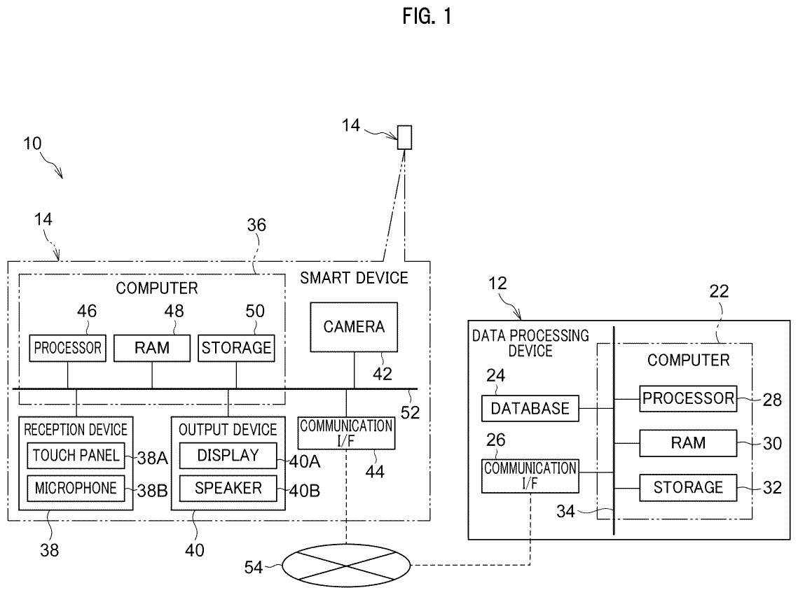

FIG. 1 shows an example of implement of a data processing system 10.

As shown in FIG. 1, data processing system 10 has data processing device 12 and smart device 14. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart device 14 has a computer 36, reception device 38, output device 40, camera 42, and communication I/F 44. The computer 36 has a processor 46, RAM 48, and storage 50. The processor 46, RAM 48, and storage 50 are connected to a bus 52. The reception device 38, output device 40, and camera 42 are also connected to the bus 52.

The reception device 38 is equipped with a touch panel 38A and a microphone 38B, etc., to accept user input. The touch panel 38A detects the touch of an indicating body (e.g., a pen or a finger, etc.), thereby accepting user input by the touch of the indicating body. The microphone 38B detects the user's voice, thereby accepting user input by voice. The control unit 46A transmits data indicating the user input accepted by the touch panel 38A and microphone 38B to the data processing device 12. In the data processing device 12, the specific processing unit 290 acquires the data indicating the user input.

The output device 40 is equipped with a display 40A and a speaker 40B, etc., and presents data to the user 20 by outputting the data in a form of representation (e.g., audio and/or text) that can be perceived by the user 20. Display 40A displays text, images, and other visible information in accordance with instructions from processor 46. Speaker 40B outputs audio in accordance with instructions from processor 46. Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. The camera is a compact digital camera.

The communication I/F 44 is connected to the network 54. The communication I/F 44 and 26 are responsible for transferring and receiving various types of information between the processor 46 and the processor 28 via the network 54.

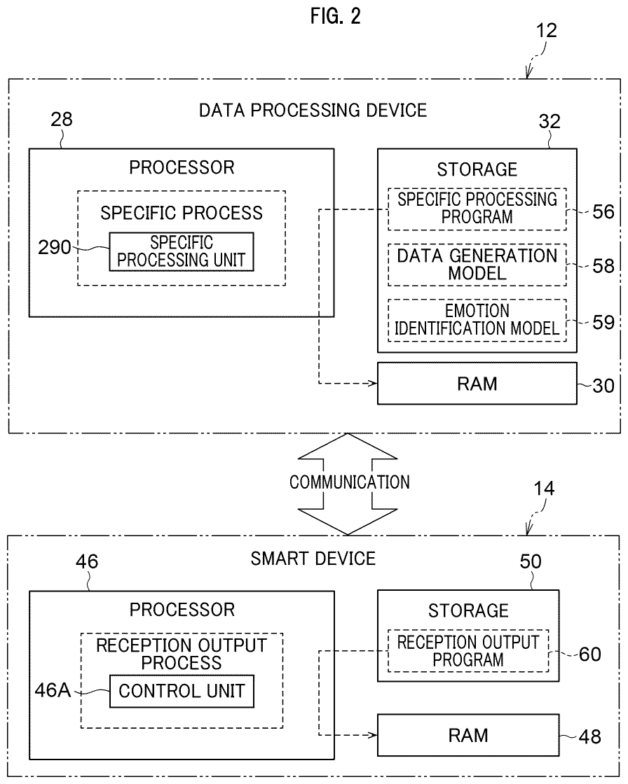

FIG. 2 shows an example of the key functions of data processing device 12 and smart device 14.

As shown in FIG. 2, specific processing is performed by processor 28 in data processing device 12. The specific processing program 56 is stored in the storage 32. The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executing on the RAM 30.

The data generation model 58 and emotion identification model 59 are stored in storage 32. The data generation model 58 and emotion identification model 59 are used by the specific processing unit 290.

In smart device 14, the reception output process is performed by processor 46. The reception output program 60 is stored in storage 50. The reception output program 60 is used by the data processing system 10 in conjunction with the specific processing program 56. Processor 46 reads reception output program 60 from storage 50 and executes the read reception output program 60 on RAM 48. The reception output process is realized by the processor 46 operating as the control unit 46A according to the reception output program 60 executing on RAM 48.

Next, the specific processing by the specific processing unit 290 of the data processing device 12 is described.

### Example of Implement 1

The brain streaming support system uses a generative AI to generate relevant ideas and questions based on the user's theme input. Specifically, if the user inputs “new business development” as a theme, the generative AI generates questions such as “What are the market needs for new business development?” and “What resources are needed for new business development?” and ideas such as “For new business development, utilize the existing customer base” and “For new business development, consider introducing new technology. Generate ideas such as.

### Example of Implement 2

For generated ideas, the system provides evaluation buttons such as “original,” “realistic,” “review from a manager's point of view,” etc., to support the expansion of ideas. Specifically, if a user presses the “original” evaluation button for the generated idea, “Consider introducing new technologies to develop new businesses,” the generative AI generates a new idea, such as “What kind of original business will be possible by introducing new technologies?

### Example of Implement 3

The system will utilize not only input from the WebUI, but also information from the minutes of the meeting in conjunction with the web conferencing tool. Specifically, the system takes the minutes of a meeting held with a web conferencing tool such as Zoom, and the generative AI generates new ideas based on the information contained in the minutes. For example, if the minutes include the information that “introduction of new technology is necessary for new business development,” the generative AI generates new ideas based on this information, such as “What kind of new business can be developed by introducing new technology?

The following is a description of the process flow for each example of implement.

### Example of Implement 1

Step 1: The user accesses the Brainstorming Support System WebUI and enters “New Business Development” as the theme.

Step 2: The system's generative AI receives thematic input from the user and generates relevant ideas and questions. Specifically, the system generates questions such as “What are the market needs for new business development?” and “What resources are needed for new business development?” as well as ideas such as “For new business development, utilize the existing customer base” and “For new business development, consider introducing new technologies”.

Step 3: Present the generated ideas and questions to the user. The user can add his/her own thoughts and evaluate the ideas presented.

### Example of Implement 2

Step 1: The user presses the “Originally” rating button for the generated idea “For new business development, consider introducing new technologies.

Step 2: The system's generative AI receives evaluation input from the user and generates new ideas based on the evaluation. Specifically, the system generates new ideas such as “What kind of creative business will be possible through the introduction of new technologies?

Step 3: Present the generated new ideas to the user. The user can add his/her own thoughts and evaluate the ideas presented.

### Example of Implement 3

Step 1: The user conducts a meeting using a web conferencing tool such as Zoom, and the minutes of the meeting are imported into the system.

Step 2: The system's generative AI analyzes information from the minutes and generates new ideas based on this information. For example, if the minutes include the information that “introduction of new technology is necessary for new business development,” the generative AI generates new ideas based on this information, such as “What kind of new business can be developed by introducing new technology?

Step 3: Present the generated new ideas to the user. The user can add his/her own thoughts and evaluate the ideas presented.

### Example 1

The following is an example of exemplary embodiment of implement. In the following description, data processing device 12 is referred to as the “server” and smart device 14 is referred to as the “terminal.

Conventional brain-streaming support systems lack the ability to automatically generate specific ideas and questions related to a theme when a user enters a theme. They also lack the means to evaluate and further expand on the generated ideas and questions. Furthermore, there is insufficient integration with web conferencing tools, making it difficult to effectively utilize the information obtained during meetings.

The specific processing by the specific processing unit 290 of the data processing device 12 in Example 1 is realized by the following means.

In this invention, the server includes means for inputting themes from the user, converting the themes into prompt sentences, sending the prompt sentences to the generative AI model, receiving output from the generative AI model, displaying the generated ideas and questions to the user, input from the WebUI means and means of interfacing with the web conferencing tool. This allows for the automatic generation of specific ideas and questions based on user input on a theme, which can then be evaluated and expanded upon. In addition, the linkage with the Web conferencing tool allows the user to effectively utilize the information obtained during the meeting.

The “means of inputting themes from users” is a means of providing an interface for users to input brainstorming themes.

The “means of converting the theme into a prompt sentence” refers to the means of converting the theme input by the user into a prompt sentence in a format suitable for the generated AI model.

The “means for transmitting the prompt text to the generating AI model” is a means for transmitting the generated prompt text to the generating AI model.

The “means of receiving output from the generative AI model” is the means of receiving ideas and questions returned from the generative AI model.

A “means of displaying generated ideas and questions to users” is a means of displaying ideas and questions received from the generated AI model to users.

The “means of input from the WebUI” is the means by which the user provides input through the Web interface.

The “means of linking with web conferencing tools” is a means of obtaining information in conjunction with web conferencing tools and utilizing it within the system.

### Exemplary Embodiment of the Invention

This invention is a brain-streaming support system that allows users to input a theme and then generate related ideas and questions using a generative AI model. An exemplary embodiment of this system is described below.

### System Configuration

The system consists of the following major components
1. means for users to input themes
2. means of converting such themes into prompt text
3. means of transmitting such prompt sentences to a generative AI model
4. means of receiving output from the generated AI model
5. a means of displaying the generated ideas and questions to the user
6. input method from WebUI
7. means of cooperation with web conferencing tools

### Hardware and Software Used

Hardware: servers, terminals (user's PC or smartphone)
Software: Generative AI model (e.g. GPT-4 (registered trademark)), Web browser, HTML, JavaScript (registered trademark), Python

### Program Processing

The user enters a theme through a web browser. For example, the user enters the theme “New Business Development”. The terminal sends this theme to the server. The server converts the received theme into a prompt text. Specifically, the server generates the prompt statement, “Please generate questions and ideas about ‘new business development’.” The prompt sentence “Please generate questions and ideas about ‘new business development” is generated.

The server sends this prompt sentence to the Generative AI model (GPT-4). The Generative AI model generates relevant questions and ideas based on the prompt sentence. For example, “What are the market needs for new business development?” or “For new business development, we will leverage our existing customer base” will be generated.

The generated questions and ideas are sent to the terminal via the server. The terminal displays this information on a web browser, and users can brainstorm based on this information.

### Concrete Example

The user enters the theme “New Business Development”. The terminal sends this theme to the server. The server generates the prompt “Please generate questions and ideas about ‘new business development” and sends it to the generative AI model (GPT-4), and sends it to the generative AI model (GPT-4). The generative AI model will ask questions such as “What are the market needs for new business development?” and “Use the existing customer base for new business development. The server receives these generated results and sends them to the terminal. The terminal displays the received questions and ideas on the browser, and the user brainstorms based on them.

In this way, users can gain a variety of perspectives and ideas related to the topic and receive assistance in brainstorming.

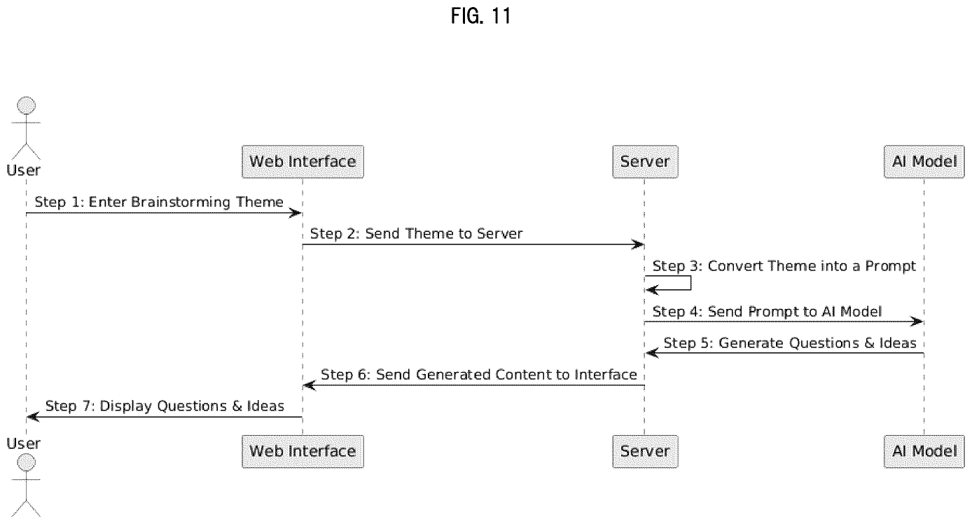

The flow of the identification process in Example 1 is described in FIG. 11.

### Step 1:

The user enters a theme.

The user accesses the interface on the web browser and enters the theme they wish to brainstorm in the theme entry field. For example, enter “new business development”. The entered theme is temporarily stored in the memory of the terminal.

### Step 2:

The terminal sends the theme to the server.

The terminal sends the theme entered by the user to the server as an HTTP request. This request is made using the JavaScript fetch function. The input data is the theme “New Business Development” and the output is a request sent to the server.

### Step 3:

The server converts the theme into a prompt statement.

The server generates prompt statements based on the theme received. For example, for the theme “New Business Development,” the server generates the prompt statement, “Please generate questions and ideas about ‘New Business Development’.” The input data is the theme “New Business Development” and the output is the theme “New Business Development”. The input data is the theme “New Business Development” and the output is the prompt sentence “Please generate questions and ideas for ‘New Business Development’. The output is “Please generate questions and ideas about ‘new business development”.

### Step 4:

The server sends prompt statements to the generating AI model.

The server sends the generated prompt statements to the generating AI model (GPT-4). This communication is done using API requests. The input data is the prompt sentence and the output is the request sent to the generation AI model.

### Step 5:

Generative AI models generate questions and ideas.

The generative AI model generates relevant questions and ideas based on the prompt sentences received. For example, “What is the market need for new business development?” or “For new business development, we will leverage our existing customer base” are generated. The input data are the prompt sentences and the output are the questions and ideas generated.

### Step 6:

The server receives the generated questions and ideas.

The server receives questions and ideas returned from the generative AI model. This data is received in JSON format. The input data is the output from the data generation model and the output is the data received by the server.

### Step 7:

The server sends questions and ideas to the terminal.

The server sends the received questions or ideas to the terminal as an HTTP response. This response is also in JSON format. The input data are the questions and ideas generated, and the output is the data sent to the terminal.

### Step 8:

The terminal displays questions and ideas to the user.

The terminal displays the questions and ideas received from the server on the browser. Users can brainstorm based on this information. The input data is the response from the server and the output is the display on the browser.

### Example of Application 1

Next, example of application 1 of example of implement 1 will be described. In the following description, data processing device 12 will be referred to as the “server” and smart device 14 will be referred to as the “terminal.

Conventional brain-streaming support systems have the ability to generate ideas and questions based on themes entered by the user, but lack support specific to a particular industry or application. In particular, they lack the ability to generate specific ideas and questions to improve production efficiency in a factory, making it difficult for factory managers and engineers to efficiently find ways to improve production lines.

The specific processing by the specific processing unit 290 of the data processing device 12 in example of application 1 is realized by the following means.

In this invention, the server includes theme input means from the user, generative AI means to generate ideas and questions related to the theme, evaluation means to support expansion on the generated ideas, input means from the WebUI and with web conferencing tools, and learning means to improve production efficiency in the factory. The system includes means to generate ideas and questions for improving production efficiency in the factory, and learning means to provide feedback on the generated ideas and questions and reflect them in the next and subsequent generations. This enables factory managers and engineers to efficiently generate specific ideas and questions to improve production efficiency and find improvement measures.

The “user input method” is an interface that allows users to enter a specific theme or issue.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link with web conferencing tools to share information and utilize data such as meeting minutes.

The “means of generating ideas and questions to improve production efficiency in a factory” is a function that generates ideas and questions specifically for improving the factory's production efficiency.

A “learning method that provides feedback on generated ideas and questions and reflects it in the next generation” is a function that collects feedback from users, which is then used by the generative AI to generate ideas and questions for the next and subsequent generations.

As an exemplary embodiment of this invention, a brain-streaming support system for improving production efficiency in a factory is described in detail.

### System Configuration

The system includes the following major hardware and software components

Server: hosts a generative AI model, receives thematic input from users, and generates relevant ideas and questions.

User Terminal: Device (e.g., PC, tablet) for plant managers and engineers to enter topics and review generated ideas and questions.

Web User Interface (WebUI): An interface for users to enter themes and view generated ideas and questions.

Web conferencing tools: Tools for capturing meeting minutes and interfacing with the system.

### Program Processing

The server performs data processing and data computation using the following means

1. theme input method: The user enters a theme through the WebUI. For example, the user enters the theme of “improving production line efficiency”.

2. generative AI means: Generate relevant ideas and questions based on the input theme using a generative AI model such as GPT-3 (registered trademark) of OpenAI (registered trademark). The generated ideas and questions are processed on the server and sent to the user terminal.

Means of evaluation: Users evaluate the ideas and questions generated. The evaluation results are sent to the server and will be reflected in the next and subsequent generations.

4. means of input from the WebUI: users provide feedback through the WebUI and rate the ideas and questions generated.

5. means of linking with web conferencing tools: Information is obtained from the minutes of the web conferencing tool and used as training data for the generative AI model.

6. learning means: update the generative AI model based on user feedback and reflect it in the generation of ideas and questions in the next and subsequent sessions.

### Concrete Example

For example, if a factory manager inputs the theme “improving production line efficiency,” the generative AI mo model will generate the following ideas and questions. Where are the bottlenecks in the production line?”

What processes can be automated?”

Would changing the layout of the production line increase efficiency?”

These ideas and questions are displayed in the WebUI on the user's terminal, and the user can provide ratings and feedback on them.

### Example of Prompt Text

Topic: Improving production line efficiency

Generate relevant ideas and questions.

In this way, specific ideas and questions can be efficiently generated to improve production efficiency in the plant, allowing managers and engineers to find ways to improve.

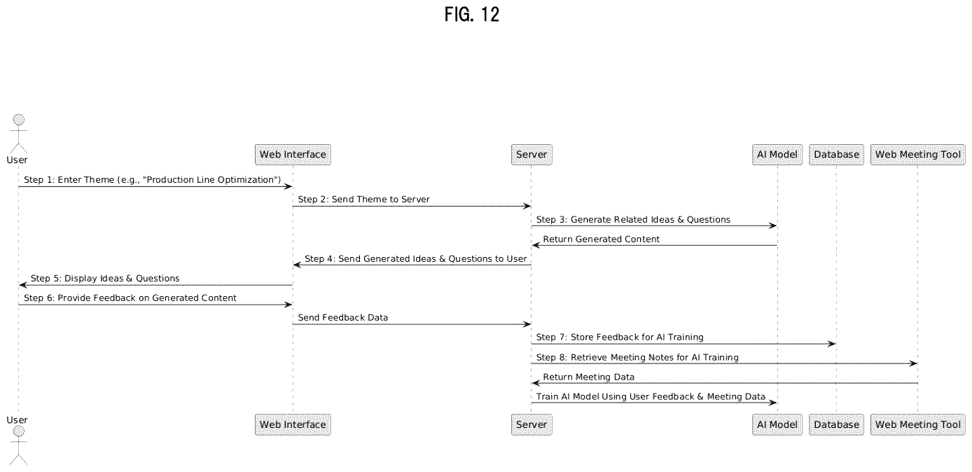

The flow of the identification process in Example of Application 1 is described in FIG. 12.

### Step 1:

The user enters the theme through the WebUI.

Input: The user enters a theme, such as “improving the efficiency of the production line”.

Output: The input theme is sent to the server.

Specific action: The user enters the theme in the input field of the WebUI and clicks on the “Submit” button.

### Step 2:

The server uses a generative AI model to generate relevant ideas and questions based on the input themes.

Input: The server receives the theme submitted by the user.

Output: list of ideas and questions generated by the generative AI model.

Specific behavior: The server sends themes as prompt sentences to OpenAI's GPT-3 and other generative AI models, and receives generated ideas and questions.

### Step 3:

The server sends the generated ideas and questions to the user terminal.

Input: a list of ideas and questions generated by the generative AI model.

Output: Ideas and questions displayed on the user's terminal.

Specific operation: The server sends the generated ideas and questions to the WebUI of the user terminal for display.

### Step 4:

Users evaluate the ideas and questions generated.

Input: User evaluates the ideas and questions displayed.

Output: The evaluation results are sent to the server.

Specific behavior: User clicks on evaluation buttons on the WebUI, such as “original,” “realistic,” “review from management's point of view,” etc.

### Step 5:

The server receives the evaluation results from the user and stores them as training data to be reflected in the next generation.

Input: Evaluation results sent by the user.

Output: The evaluation results are stored and used as training data for the generative AI model.

Specific operation: The server stores the evaluation results in a database and provides them as feedback to the learning algorithm of the generative AI model.

### Step 6:

The server retrieves information from the minutes of the web conferencing tool and uses it as training data for the generative AI model.

Input: Minutes data from web conferencing tools.

Output: the minutes data is used as training data for the generative AI model.

Specific operation: The server obtains the minutes data through the API of the web conferencing tool and provides it to the training algorithm of the generative AI model.

In this way, specific ideas and questions can be efficiently generated to improve production efficiency in the plant, allowing managers and engineers to find ways to improve.

### Example 2

Next, example 2 of exemplary embodiment of implement will be described. In the following description, data processing device 12 is referred to as the “server” and smart device 14 is referred to as the “terminal.

Conventional brainstorming support systems have a problem in that it is difficult to obtain appropriate feedback and expansion on the ideas entered by users. In addition, the evaluation perspective was limited, making it difficult to expand on ideas from multiple perspectives. Furthermore, there was a lack of concrete means to improve the quality and relevance of the ideas generated.

The specific processing unit 290 of the data processing device 12 in Example 2 is realized by the following means.

In this invention, the server includes theme input means from the user, generative AI means to generate ideas and questions related to the theme, evaluation means to support expansion on the generated ideas, means to generate prompt sentences based on the evaluation, means to send the generated prompt sentences to the generative AI model means, a means to return a response from the generated AI model to the user, and means for input from the WebUI and linkage with the web conferencing tool. This allows for evaluation and expansion from multiple perspectives on user input ideas, thereby enhancing the quality and relevance of the generated ideas.

The “user input method” is an interface for users to enter ideas and themes into the system.

Generative AI means” is an artificial intelligence function that generates relevant ideas and questions based on a theme entered by the user.

The “evaluation means” is an interface for users to evaluate the generated ideas, and includes evaluation buttons such as “original,” “realistic,” and “review from a manager's perspective.

The “means of generating prompt sentences” is the ability to create prompt sentences for transmission to the generative AI model based on the user's ratings.

The “means of transmitting to the generated AI model” is the communication means for transmitting the generated prompt sentences to the generated AI model.

The “means of returning responses from the generative AI model to the user” is the ability to return to the user new ideas and responses received from the generative AI model.

The “means of input from the WebUI” is the means by which users enter information into the system through the Web interface.

The “means of linking with web conferencing tools” is a function to link with web conferencing tools to utilize information such as meeting minutes.

This invention is a system that supports the evaluation and expansion of ideas by utilizing a generative AI model based on themes entered by the user. An exemplary embodiment of this system is described below.

First, the user uses a terminal (e.g., PC or smartphone) to enter a theme through the system's WebUI. For example, the user would enter, “For new business development, consider the introduction of new technologies.

The user then presses one of the rating buttons, such as “Originally,” “Realistically,” or “Review from Management's Perspective,” for the topic entered. For example, press the “Originally” button.

The server generates the appropriate prompt sentence based on the evaluation button pressed by the user. For example, if the button “Creatively” is pressed, the server will generate the prompt sentence “What creative business will be possible with the introduction of the new technology?

Next, the server sends the generated prompt sentences to the generating AI model (e.g., GPT-4 of OpenAI). Specifically, the prompt sentences are sent through the API.

The generative AI model generates new ideas based on the prompt sentences it receives. For example, in response to the prompt sentence “What kind of creative business will be possible through the introduction of new technology?”, the model generates ideas such as “A new logistics service that utilizes AI-based automated driving technology.

Finally, the server returns the new ideas received from the generative AI model to the user. Specifically, the new ideas are displayed on the terminal screen.

The system allows users to evaluate and expand on the ideas they enter from multiple perspectives, enhancing the quality and relevance of the ideas generated. In addition, the system can be integrated with web conferencing tools to utilize information from meeting minutes.

As a specific example, consider a case in which a user enters “Consider introducing new technology for new business development” and presses the “Review from Management's Perspective” evaluation button. In this case, the server generates the prompt sentence “What are the benefits and risks of introducing new technology from a manager's perspective? The generative AI model generates new ideas and reviews based on this prompt sentence, and the server returns the results to the user.

Examples of prompt statements include the following

What kind of creative projects will be possible through the introduction of new technologies?”

What are the benefits and risks of implementing new technologies from a management perspective?”

What are the practical implications of implementing new technologies?”

In this way, users can evaluate and further extend their ideas using the generative AI model.

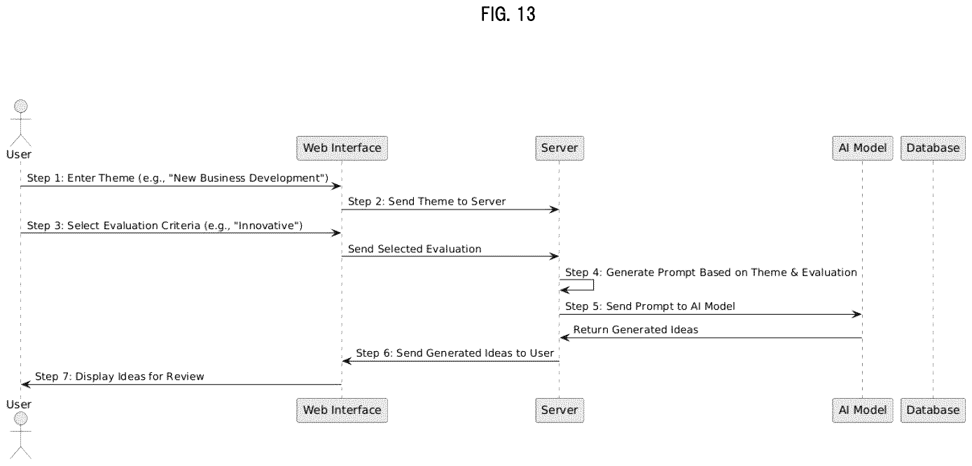

The flow of the identification process in Example 2 is described in FIG. 13.

### Step 1:

The user enters the theme in the input form on the terminal.

Input: Theme to be entered by user (e.g., “For new business development, consider introducing new technologies”)

Output: The input theme is sent to the server.

Specific operation: The user uses the WebUI on the terminal to enter the theme and press the submit button.

### Step 2:

The user presses the “Evaluate” button.

Input: User-selected rating button (e.g., “Creatively”)

Output: The selected evaluation is sent to the server.

Specific action: The user presses one of the evaluation buttons for the entered theme, such as “original,” “realistic,” or “review from a manager's point of view.

### Step 3:

The server generates a prompt statement.

Input: User entered theme and rating button selection information

Output: Generated prompt text (e.g., “What creative business will be possible with the new technology?”)

Specific behavior: The server generates the appropriate prompt sentence based on the evaluation button pressed by the user.

### Step 4:

The server sends prompt statements to the generated AI model.

Input: Generated prompt text

Output: Prompt statements sent to the generated AI model

Specific behavior: The server sends the generated prompt sentences to the generated AI model (e.g., OpenAI's GPT-4) via API.

### Step 5:

Generative AI models generate new ideas.

Input: Prompt sentences sent to the generated AI model

Output: New ideas generated (e.g., “New logistics services using AI-based automated driving technology”)

Specific behavior: The generative AI model generates new ideas based on the prompt sentences it receives.

### Step 6:

The server returns the generated ideas to the user.

Input: new ideas received from the generative AI model

Output: New ideas displayed on the user's terminal

Specific operation: The server sends new ideas received from the generated AI model to the user's terminal and displays them on the screen.

### Example of Application 2

Next, example of application 2 of example of implement 2 will be described. In the following description, data processing device 12 is referred to as the “server” and smart device 14 is referred to as the “terminal.

Conventional brainstorming support systems lacked concrete means to further expand on user-generated ideas. They also lacked a function to assist content creators in generating new content ideas and further extending them using a rating button. This made it difficult to improve creativity and efficient idea generation.

The specific processing by the specific processing unit 290 of the data processing device 12 in example of application 2 is realized by the following means.

In this invention, the server includes theme input means from the user, generative AI means to generate ideas and questions related to the theme, evaluation means to support expansion on the generated ideas, input means from the WebUI and with web conferencing tools, and means for content creators to create new content ideas, means to support further extensions to them using the evaluation buttons, and application means installed on a smartphone or head-mounted display. This enables users to further expand on the ideas they generate using the evaluation buttons, thereby improving creativity and efficient idea generation.

The “user input method” is an interface that allows users to enter specific themes or topics into the system.

Generative AI means” is an artificial intelligence function that automatically generates relevant ideas and questions based on input themes.

The “evaluation means” is an interface that allows users to evaluate the generated ideas “creatively,” “realistically,” or “reviewed from a manager's point of view.

The “means of input from the WebUI” is the means by which a user inputs information through the Web user interface.

The “means of linking with web conferencing tools” is a function to link with web conferencing tools to utilize information such as meeting minutes.

The “means to support content creators in generating new content ideas and further extending them using the evaluation buttons” is a support function for content creators to generate new ideas and further develop them using the evaluation buttons.

An “application to be installed on a smartphone or head-mounted display Means” is a means of using the system through an application to be installed on a smartphone or head-mounted display.

The system for implementing this invention includes theme input means from the user, generative AI means, evaluation means, input means from the WebUI, means for integration with web conferencing tools, means to help content creators generate new content ideas and further extend them with evaluation buttons means, including application means installed on smartphones and head-mounted displays.

### Description of the System's Program Processing

### Hardware and Software Use

Hardware: (1)
Smart phone
HMD
Server
Software: C
OpenAI API
Python Programs
WebUI
Web conferencing tools
Data processing and data computation

### User Operation:

The user uses a smart phone or head-mounted display to enter the theme. For example, the user would enter the theme, “For new business development, consider introducing new technologies.

### Generative AI Processing:

The server generates relevant ideas and questions using a generative AI (e.g., GPT-3) based on the input theme. The ideas generated are, for example, “What kind of creative business will be possible through the introduction of new technologies?

### Operation of Evaluation Instruments:

The user presses a rating button for the generated idea, such as “original,” “realistic,” or “review from a manager's point of view. For example, if the user presses the “Originally” evaluation button, the generative AI will generate a new idea such as “Provide an AI-based personalized content delivery service by introducing new technology.

Integration with WebUI and Web Conferencing Tools:

Users can enter information through the WebUI and utilize information from the minutes of the web conferencing tool for further detailed idea generation.

### Support for Content Creators:

Content creators can further expand on the generated ideas using the evaluation buttons to generate new content ideas. This allows for increased creativity and efficient idea generation.

### Specific Examples and Prompt Statements

### Specific Examples

Initial Idea: “For new business development, consider implementing new technologies.”

User rating: “Ingenious”

Idea generated: “Implement new technologies to provide personalized content delivery services using AI.”

Example of a prompt statement: “I am a member of the

“For new business development, think creatively about introducing new technologies.”

In this way, the generative AI generates new ideas based on user evaluations, and the system supports the creativity of content creators.

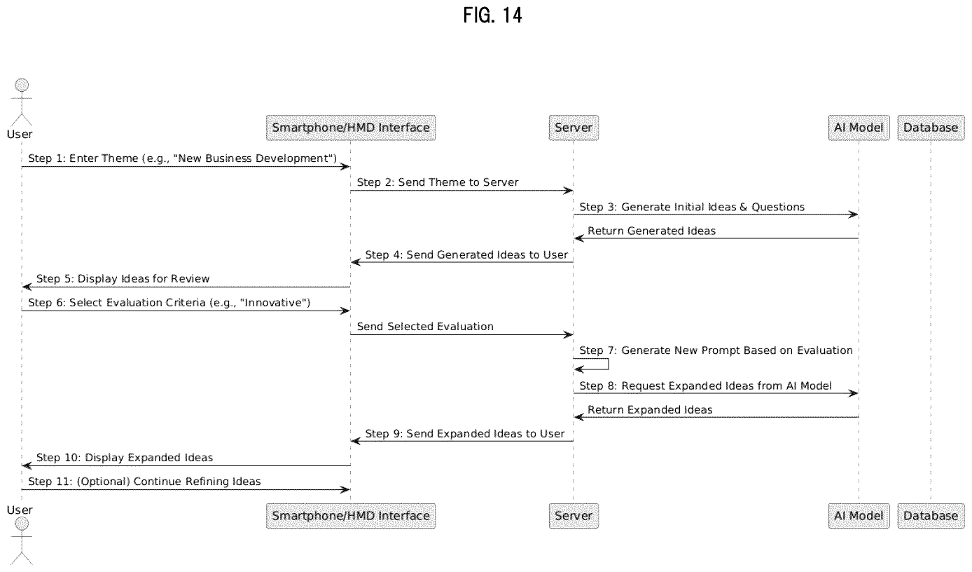

The flow of the identification process in example of application 2 is described in FIG. 14.

### Step 1:

The user uses a smartphone or head-mounted display to enter a theme. For example, the user enters the theme, “For new business development, consider introducing new technologies. The entered theme is sent to the server.

Input: User entered theme

Output: Themes sent to server

### Step 2:

The server sends the received themes to the generative AI model (e.g., GPT-3), which generates related ideas and questions. The generative AI model generates prompt sentences based on the theme and outputs corresponding ideas.

Input: Themes sent to the server

Output: Ideas and questions generated by generative AI models

### Step 3:

The server sends the generated ideas and questions to the user's device. The user reviews the generated ideas through a smartphone or head-mounted display.

Input: ideas and questions generated by generative AI models

Output: Ideas or questions sent to the user's terminal

### Step 4:

The user presses an evaluation button for the generated ideas, such as “original,” “realistic,” “review from a manager's perspective,” etc. The evaluation button selection information is transmitted to the server.

Input: Selection information for the evaluation button pressed by the user

Output: Rating button selection information sent to the server

### Step 5:

The server generates new prompt sentences based on the selection information of the evaluation button and sends them to the generative AI model again. The generative AI model generates further extended ideas based on the new prompt sentences.

Input: Selection information for the evaluation button sent to the server

Output: Extended ideas generated by the generative AI model

### Step 6:

The server sends the augmented idea to the user's device. The user sees the augmented idea through a smartphone or head-mounted display.

Input: extended ideas generated by generative AI models

Output: Extension ideas sent to the user's terminal

### Step 7:

The user may continue to expand on the idea, pressing further evaluation buttons as needed. This process is repeated until the user is satisfied.

Input: Selection information for the evaluation button pressed by the user

Output: Further extended ideas generated by the generative AI model

In this way, users can further expand on the generated ideas using the evaluation buttons, which improves creativity and efficient idea generation.

### Example 3

Next, example 3 of exemplary embodiment of implement will be described. In the following description, data processing device 12 is referred to as the “server” and smart device 14 is referred to as the “terminal.

Conventional brain-streaming support systems allow users to input themes and generate ideas using a generative AI, but they are not fully integrated with web conferencing tools, making it difficult to effectively use the information obtained from meeting minutes. In addition, evaluation and extension support for generated ideas was limited, making it difficult for users to obtain the specific and practical ideas they were looking for. This reduced the efficiency and effectiveness of brain streaming.

The specific processing unit 290 of the data processing device 12 in Example 3 is realized by the following means.

In this invention, the server has a means for inputting a theme from the user, a generative AI means for generating ideas and questions related to the theme, an evaluation means for supporting expansion on the generated ideas, a means for input from the WebUI and a means for interfacing with a web conferencing tool, a means for analyzing minutes from the web conferencing tool and The system includes means for extracting important information, means for creating and sending prompt sentences to the generated AI model based on the extracted information, and means for displaying the ideas generated from the generated AI model to the user. This enables the system to effectively utilize information obtained from the minutes of the web conferencing tool to generate specific and practical ideas that users seek.

A “user input method” is a means of providing an interface for a user to enter a specific theme or topic into the system.

Generative AI means” are means using artificial intelligence technology to generate relevant ideas and questions based on input themes.

The “evaluation means” is a means for users to evaluate and provide feedback on the ideas generated.

The “means of input from the WebUI” is the means by which users enter information into the system through a Web browser.

The “means of linking with a web conferencing tool” is a means of linking a web conferencing tool with the system to capture meeting minutes and other information into the system.

Means for analyzing the minutes of a web conference tool and extracting important information” means a means for analyzing the minutes obtained from a web conference tool and extracting important information from them.

The “means for creating and sending prompt sentences to the generated AI model” is a means for creating and sending appropriate prompt sentences to the generated AI model based on the extracted information.

The “means for displaying ideas generated from the generative AI model to the user” is a means for displaying ideas generated from the generative AI model to the user.

This invention is a brain streaming support system in which users, terminals, and servers work together. The following is an exemplary embodiment of this system.

### User Operation

Users access the system's WebUI using a web browser; the WebUI has input fields, such as text boxes and drop-down menus, where users enter information such as “I would like you to generate ideas about new business development.

### Terminal Operation

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by the user's operation. The minutes are saved in text file or PDF format.

### Server Processing

The server receives the uploaded minutes and analyzes them using natural language processing (NLP) technology. Specifically, tools such as Python's NLTK library and SpaCy are used to extract important information from the minutes, such as “New business development requires the introduction of new technologies.

Based on the extracted information, the server creates prompt sentences to be sent to the generative AI model. For example, the server creates a prompt sentence “What new business can be developed by introducing new technology? The created prompt sentence is sent to the generative AI model via the API.

The generative AI model (e.g., OpenAI's GPT-3) generates new ideas based on the prompt text received. The generated ideas are returned to the server in text format.

The server receives the ideas returned from the generated AI model and sends them to the terminal. Communication protocols such as HTTP requests and WebSockets are used for transmission.

### Terminal Display

The terminal displays the ideas received from the server to the user; the WebUI displays the generated ideas and the user can review them. The user can also provide feedback and request that the idea be generated again, if necessary.

### Concrete Example

1. a user enters through the WebUI, “I would like you to generate ideas for new business development.

2. the user conducts a meeting using a web conferencing tool and uploads the minutes of the meeting to the system.

3. the server analyzes the minutes and extracts information that “new business development requires the introduction of new technology.

4. the server creates a prompt statement for the generated AI model, “What new business can be developed by introducing new technology?

5. the generative AI model generates new ideas and displays them to the user through the terminal.

### Example of Prompt Text

Generate ideas about what new businesses could be developed through the introduction of new technologies.”

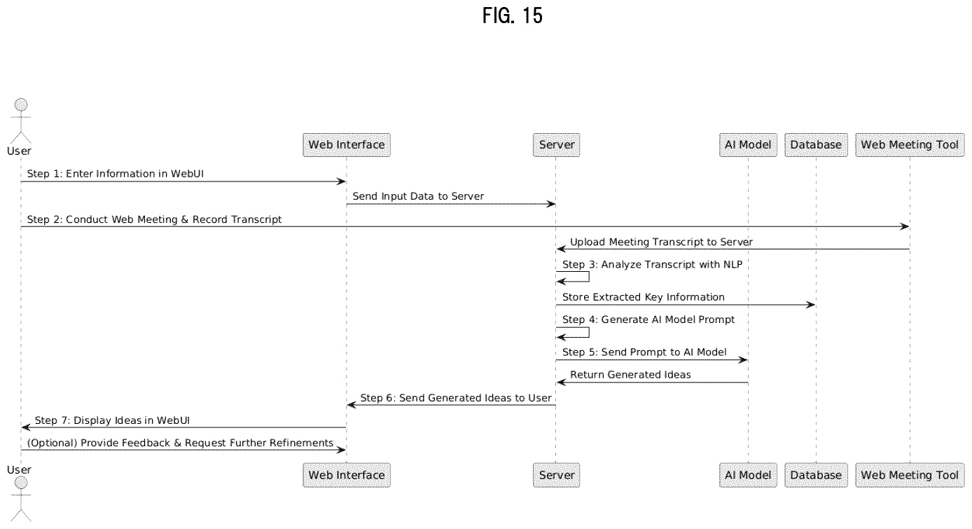

Thus, by linking the WebUI with a web conferencing tool, the system utilizes information obtained from the minutes and generates new ideas using a generative AI model. This allows users to obtain concrete and practical ideas. The flow of the specific process in Example 3 is described in FIG. 15.

### Step 1:

The user enters information through the WebUI.

The user opens a web browser and accesses the system's WebUI, which has input fields such as text boxes and drop-down menus where the user enters information such as “I would like you to generate ideas for new business development. The input information is sent to the server. The input data is in text format, which the server receives.

### Step 2:

The terminal uses a web conferencing tool to conduct the meeting.

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by user operation. The minutes are saved in text file or PDF format. The input data is the minutes file, which the server receives.

### Step 3:

The server analyzes the minutes and extracts important information.

The server receives the uploaded minutes and analyzes them using natural language processing (NLP) technology. Specifically, tools such as Python's NLTK library and SpaCy are used to extract important information from the minutes, such as “new technology is needed for new business development. The input data is the text of the minutes and the output data is the extracted critical information.

### Step 4:

The server creates and sends prompt statements to the generated AI model.

The server creates prompt sentences to be sent to the generative AI model based on the extracted information. For example, the server creates a prompt sentence “What new business can be developed by introducing new technology? The created prompt sentence is sent to the generative AI model via the API. The input data is the extracted information and the output data is the prompt sentence.

### Step 5:

Generative AI models generate new ideas.

The generative AI model (e.g., OpenAI's GPT-3) generates new ideas based on the prompt text received. The generated ideas are returned to the server in text format. The input data is the prompt sentence and the output data is the generated idea.

### Step 6:

The server sends the generated ideas to the terminal.

The server receives the ideas returned from the generated AI model and sends them to the terminal. Communication protocols such as HTTP requests and WebSockets are used for transmission. The input data are the generated ideas and the output data are the ideas sent to the terminal.

### Step 7:

The terminal displays the ideas generated to the user.

The terminal displays the ideas received from the server to the user; the WebUI displays the generated ideas and the user can review them. The user can also provide feedback and ask to generate ideas again, if necessary. The input data are the ideas sent from the server and the output data are the ideas displayed to the user.

### Example of Application 3

Next, example 3 of application of example of implement 3 will be described. In the following description, data processing device 12 is referred to as the “server” and smart device 14 is referred to as the “terminal.

Conventional brainstorming support systems have utilized minutes of meetings by inputting themes from users and linking with web conferencing tools, but they do not support the generation of ideas for specific manufacturing processes or efficiency improvements in the factory. Therefore, there is a need to generate ideas for new manufacturing processes and efficiency improvements based on the minutes of in-plant meetings.

The specific processing by specific processing unit 290 of data processing device 12 in example of application 3 is realized by the following means. In this invention, the server includes means for inputting themes from users, means for generating ideas and questions related to the themes, means for evaluating the generated ideas to support expansion, means for inputting information from the WebUI and linking with a web conferencing tool, and means for generating new manufacturing processes and efficiency ideas based on the information The system includes means to capture the minutes of meetings held in the factory and generate ideas for new manufacturing processes and efficiency improvements based on that information. This enables the generation of ideas for new manufacturing processes and efficiency improvements based on the minutes of meetings held in the factory.

The “user input method” is an interface that allows users to input discussion and idea generation themes to the system.

Generative AI means” is an artificial intelligence function that generates relevant ideas and questions based on input themes.

The “evaluation method” is a function that allows users to evaluate the ideas generated, and then uses the evaluation results to support the expansion and improvement of the ideas based on.

The “means of input from the WebUI” is the means by which users enter information into the system through the Web user interface.

The “means of linking with a web conferencing tool” is a means of linking a web conferencing tool with the system to capture meeting minutes and other information into the system.

The “means of capturing minutes of meetings held in the factory and generating ideas for new manufacturing processes and efficiency improvements based on that information” is a function for capturing the minutes of meetings held in the factory into the system and generating ideas for new manufacturing processes and efficiency improvements based on those minutes.

The system for implementing this invention includes means for inputting themes from users, generative AI, evaluation, input from the WebUI, integration with web conferencing tools, and means for capturing minutes of meetings held in the factory and generating ideas for new manufacturing processes and efficiency improvements based on that information.

The server provides an interface for the user to enter themes. Themes entered by the user are sent to the generative AI means to generate related ideas and questions. The generated ideas are evaluated by the user through the evaluation means, and the ideas are expanded or improved based on the evaluation results.

The input method from the WebUI is a means for users to enter information into the system through the web user interface. This allows users to easily input themes and evaluation results.

The means of linking with web conferencing tools is a means to link web conferencing tools with the system and to incorporate meeting minutes and other information into the system. For example, minutes are retrieved from a web conferencing tool such as Zoom, and a generative AI generates new ideas based on this information.

The means of capturing minutes of meetings held in a factory and generating ideas for new manufacturing processes and efficiency improvements based on that information is a function for capturing minutes of meetings held in a factory into the system and generating ideas for new manufacturing processes and efficiency improvements based on those minutes. This enables the generation of ideas for new manufacturing processes and efficiency improvements based on the minutes of meetings held in the factory.

As a concrete example, the following prompt sentences can be entered into a generative AI model

### Example of a Prompt Statement

Minutes: Need to improve efficiency of production lines. In particular, bottlenecks in the assembly process are a problem. Please propose ideas to solve this problem by introducing new technologies and methods.

Based on this prompt sentence, a generative AI might generate the following ideas

1. promote automation of the assembly process by introducing a robot arm.

2. introduce an AI-based quality inspection system for early detection of defective products.

3. redesign the layout of the production line to improve work efficiency.

In this way, ideas for new manufacturing processes and efficiencies can be generated based on the minutes of meetings in the plant.

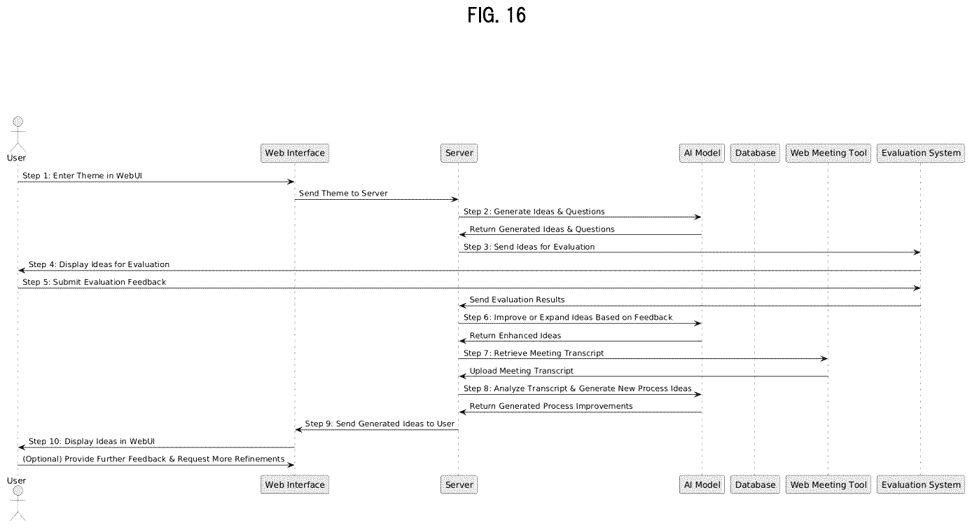

The flow of the identification process in example of application 3 is described in FIG. 16.

### Step 1:

The user enters a theme. Users enter discussion and idea generation themes through the web user interface. The entered themes are sent to the server. The input data is in text format, and the server receives it and passes it on to the next process.

### Step 2:

The server generates ideas and questions using generative AI methods. The server inputs the themes received in step 1 into the generative AI model and generates relevant ideas and questions. The generative AI model processes data based on the themes and outputs the relevant ideas and questions in text format.

### Step 3:

The server sends the generated ideas to the evaluation method. The server sends ideas and questions output from the generative AI model to the evaluation means. The evaluation means provides an interface for users to evaluate the ideas. Users evaluate ideas using evaluation buttons such as “original,” “realistic,” “review from a manager's point of view,” etc.

### Step 4:

The user evaluates the ideas. The user evaluates the generated ideas through the evaluation method. The evaluation results are sent to the server and used for the next process. The evaluation data is in numerical or text format, and the server receives it and passes it on to the next process.

### Step 5:

The server extends or improves the idea based on the evaluation results. The server extends or improves ideas based on evaluation results received from users, using the generative AI model again. The generative AI model uses the evaluation results as input data to extend or improve the idea.

### Step 6:

The server retrieves the meeting minutes using a means of interfacing with the web conferencing tool. The server retrieves the meeting minutes from the web conferencing tool (e.g., Zoom). The retrieved minutes are in text format, which the server passes on to the next process.

### Step 7:

The server inputs the minutes into the generative AI means and generates ideas for new manufacturing processes and efficiency improvements The server inputs the obtained minutes into the generative AI model and generates ideas for new manufacturing processes and efficiency improvements based on the minutes. The generative AI model analyzes the minutes and outputs related ideas in text format.

### Step 8:

The server provides the generated ideas to the user. The server provides the user with ideas for new manufacturing processes and efficiencies output from the generative AI model. The user reviews these ideas through a web user interface and provides evaluation and feedback as needed.

Furthermore, an emotion engine that estimates the user's emotion may be combined. In other words, the specific processing unit 290 estimates the user's emotion using the emotion identification model 59 and uses the user's emotion

The specific processing may be performed in a specific way.

### Example of Implement 1

One exemplary embodiment of this invention is a brain streaming support system that includes an emotion engine that recognizes the user's emotions. The system receives thematic input from the user and generates ideas and questions related to that theme. The generated ideas are evaluated based on the user's emotions, and new ideas are generated based on the results. Specifically, if the user is exhibiting feelings of joy, positive ideas that are consistent with those feelings are generated. Conversely, if the user is expressing sadness, ideas are generated that suggest solutions that correspond to that emotion.

### Example of Implement 2

Another exemplary embodiment of the invention is a brain streaming support system in which an emotional engine adjusts the evaluation criteria of the evaluation method. In this system, the evaluation criteria are adjusted based on the user's emotions. Specifically, if the user is in an excited state, the evaluation criteria are set higher to match that emotion, making it easier for more challenging ideas to be evaluated. Conversely, when the user is calm, the evaluation criteria are set lower to match the user's emotions, and more realistic ideas are more likely to be evaluated.

### Example of Implement 3

Yet another exemplary embodiment of the invention is a brain streaming support system that utilizes information from the minutes of a web conferencing tool. In this system, new ideas are generated based on information from the minutes of a web conferencing tool. Specifically, the emotional engine analyzes the users' emotional information recorded in the minutes, and idea generation and evaluation are adjusted based on the results. For example, if “expectations for new business development” is recorded in the minutes, positive ideas that match the expectations are generated based on this information.

The following is a description of the process flow for each example of implement.

### Example of Implement 1

Step 1: Receive theme input from user.
Step 2: Generate ideas and questions related to the theme.
Step 3: The user's emotions are recognized by the emotion engine.
Step 4: Evaluate the ideas generated based on the recognized emotions.
Step 5: Generate new ideas based on evaluation results.

### Example of Implement 2

Step 1: Recognize the user's emotions with the emotion engine.
Step 2: Adjust the evaluation criteria of the evaluation instrument based on the recognized emotions.
Step 3: Evaluate ideas based on adjusted evaluation criteria.
Step 4: Generate new ideas based on evaluation results.

### Example of Implement 3

Step 1: Retrieve information from the minutes of the web conferencing tool.
Step 2: Generate new ideas based on the information obtained.
Step 3: The emotional engine analyzes the user's emotional information recorded in the minutes.
Step 4: Adjust idea generation and evaluation based on analysis results.

### Example 1

The following is an example of exemplary embodiment of implement. In the following description, data processing device 12 is referred to as the “server” and smart device 14 is referred to as the “terminal.

Conventional brainstorming support systems generate ideas and questions without considering the user's emotions, making it difficult to provide appropriate ideas and questions according to the user's emotional state. In addition, user satisfaction may decrease because the evaluation of generated ideas and questions is not based on the user's emotions. Furthermore, there is a problem of inadequate integration with meeting tools and inability to utilize information from meeting minutes, which reduces the efficiency of brainstorming.

The specific processing by the specific processing unit 290 of the data processing device 12 in Example 1 is realized by the following means.

In this invention, the server includes theme input means from the user, generative AI means for generating ideas and questions related to the theme, evaluation means for supporting expansion on the generated ideas, emotion recognition means for recognizing the user's emotions, emotion recognition means for evaluating the ideas and questions based on the emotion information, and new means for generating ideas and questions, and means for interfacing with input means and meeting tools. This makes it possible to provide appropriate ideas and questions according to the user's emotional state and improve user satisfaction. In addition, the information from the minutes of the meeting tool can be used to improve the efficiency of brainstorming.

The “user input method” is an interface for users to input brainstorming themes.

A “generative AI means” is an artificial intelligence mechanism that generates relevant ideas and questions based on user input on a topic.

The “evaluation method” is a function that evaluates the ideas and questions generated and provides feedback to the user.

The “emotion recognition means” is a technology for recognizing the emotional state of a user by analyzing the user's facial expressions and tone of voice.

The “means for evaluating ideas and questions based on emotional information and generating new ideas and questions” is a function for evaluating generated ideas and questions based on recognized user emotional information and generating further new ideas and questions.

An “input means” is an interface that allows users to enter information into the system.

The “means of linking with conferencing tools” is a function to link with conferencing tools to utilize information such as meeting minutes.

This invention is a brain streaming support system that generates relevant ideas and questions based on thematic input from the user, and evaluates and extends them according to the user's emotional state. An exemplary embodiment of this system is described below.

First, the user enters a theme in the input field on the terminal. For example, the user enters “new business development. The terminal sends this theme to the server. The server uses a generative AI model (e.g., a general natural language processing model) to generate ideas and questions related to the entered theme. The generated ideas and questions are, for example

### Sample Questions:

What is the market need for new business development?”

What resources do you need for new business development?”

### Example Ideas:

We will leverage our existing customer base for new business development.”

“For new business development, consider the introduction of new technologies.”

The generated ideas and questions are sent from the server to the terminal. The terminal recognizes the user's emotions using emotion recognition means (e.g., common emotion recognition software). The user's facial expressions and tone of voice are analyzed to determine the emotional state of the user. For example, if the user is smiling, the emotion of joy is recognized.

The terminal sends the recognized emotion information to the server. Based on the emotion information, the server evaluates the generated ideas and questions and generates new ideas and questions. For example, if the user is indicating an emotion of joy, it generates positive ideas that are consistent with that emotion. Conversely, if the user is indicating an emotion of sadness, it will generate ideas that suggest solutions that correspond to that emotion.

Finally, the server sends the evaluated ideas and questions to the terminal, which displays them to the user. The user can use these ideas and questions as a reference for further brainstorming.

As a specific example, if a user enters the topic “new business development,” the generative AI model will generate the following questions and ideas

### Sample Questions:

What is the market need for new business development?”

What resources do you need for new business development?”

### Example Ideas:

We will leverage our existing customer base for new business development.”

“For new business development, consider the introduction of new technologies.”

Examples of prompt statements may include the following

Generate ideas for new business development.”

Generate questions about market needs in new business development.”

In this way, the server, terminal, and user work together to create a system that supports brainstorming.

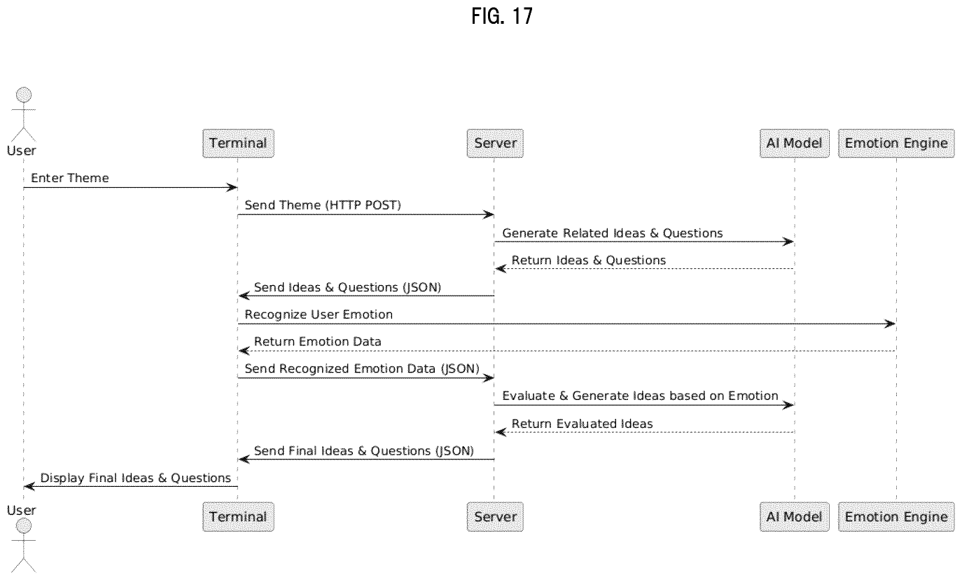

The flow of the identification process in Example 1 is described in FIG. 17.

### Step 1:

The user enters a theme.

The user enters the theme in the input field on the terminal and clicks on the submit button. For example, enter “New Business Development”. The input data is the theme text.

### Step 2:

The terminal sends the theme to the server.

The terminal sends the input theme “New Business Development” to the server using an HTTP POST request. The input data is the theme text and the output data is the request to the server.

### Step 3:

The server generates relevant ideas and questions using a generative AI model.

The server inputs the received themes into the generative AI model and generates related ideas and questions. For example, questions such as “What are the market needs for new business development?” and “What resources are needed for new business development?” are generated, as well as ideas such as “For new business development, leverage existing customer base” and “For new business development, consider introducing new technology. The input data is the theme text and the output data is a list of generated ideas and questions.

### Step 4:

Server-generated ideas and questions are sent to the terminal.

The server sends the generated ideas and questions to the terminal in JSON format. The input data is a list of generated ideas and questions, and the output data is the response to the terminal.

### Step 5:

The terminal recognizes the user's emotions using the emotion engine.

The terminal uses an emotion engine to analyze the user's facial expression and tone of voice to recognize the emotional state. For example, if the user is smiling, the emotion of joy is recognized. The input data is the user's facial expression and tone of voice, and the output data is the recognized emotion information.

### Step 6:

The terminal sends the recognized emotional information to the server.

The terminal sends the recognized emotion information to the server in JSON format.

The input data is the recognized emotion information and the output data is the request to the server.

### Step 7:

The server evaluates ideas and questions based on emotional information and generates new ideas and questions.

The server evaluates the ideas and questions generated based on the emotional information received. For example, if the user indicates a feeling of joy, it generates positive ideas that are consistent with that feeling. Conversely, if the user indicates an emotion of sadness, ideas are generated that suggest solutions that correspond to that emotion. The input data is the emotion information and the list of generated ideas or questions, and the output data is the list of evaluated ideas or questions.

### Step 8:

The server sends the final ideas and questions to the terminal.

The server finally sends the evaluated ideas and questions to the terminal in JSON format. The input data is a list of evaluated ideas and questions, and the output data is the response to the terminal.

### Step 9:

The terminal displays the final idea or question to the user.

The terminal displays the final ideas and questions received to the user. The user can use these ideas and questions as a reference for further brainstorming. The input data is the list of ideas and questions evaluated, and the output data is what is displayed to the user.

### Example of Application 1

Next, example of application 1 of example of implement 1 will be described. In the following description, data processing device 12 will be referred to as the “server” and smart device 14 will be referred to as the “terminal.

Conventional brain-streaming support systems can generate ideas and questions based on thematic input from the user, but they do not take into account the user's emotions in generating and evaluating ideas, making it difficult to provide appropriate ideas according to the user's emotions. In addition, the lack of concrete means to generate ideas for new production processes and efficiency improvements in the factory makes the system less practical in the field.

The specific processing by specific processing unit 290 of data processing device 12 in example of application 1 is realized by the following means. In this invention, the server has the following means: theme input means from the user, generative AI means to generate ideas and questions related to the theme, evaluation means to support expansion on the generated ideas, input means from the WebUI and means to link with a web conferencing tool, emotion recognition means to recognize the user's emotions means, means to evaluate ideas generated based on emotions and generate new ideas, and means installed in the robot to generate ideas for new production processes and efficiencies in the factory. This makes it possible to provide appropriate ideas based on the user's emotions, thereby increasing their utility within the factory.

The “user input method” is an interface that allows users to enter a specific theme or topic.

Generative AI means” is an artificial intelligence function that generates relevant ideas and questions based on a theme entered by the user.

The “evaluation means” is a function for extending and evaluating the ideas generated.

The “means of input from the WebUI” is the means by which the user provides input through the web user interface.

The “means of linking with web conferencing tools” is a means of linking with web conferencing tools to share information or to utilize information from the minutes.

The “emotion recognition means” is a function to recognize the user's emotions.

The “means for evaluating ideas generated based on emotions and generating new ideas” is a function for evaluating ideas generated based on user emotions and generating new ideas based on the results.

The “means that will be installed in robots to generate ideas for new production processes and efficiencies within a factory” are functions that will be installed in robots to generate ideas for new production processes and efficiencies within a factory.

The system for implementing this invention includes theme input means from the user, generative AI means, evaluation means, input means from the WebUI, means for integration with web conferencing tools, emotion recognition means, means for evaluating ideas generated based on emotions and generating new ideas, means installed in a robot to generate new production processes in a factory The system includes means installed in the robot to generate ideas for new production processes and efficiency improvements in the factory.

### Explanation of Program Processing

The server provides an interface for receiving theme input from users. When a user enters a theme, the server uses generative AI methods to generate ideas and questions related to that theme. The generative AI method uses a generative AI model, such as the OpenAI API, to generate relevant ideas and questions based on the input theme.

The generated ideas are extended and evaluated by the evaluation means. The evaluation means provides evaluation buttons, such as “original,” “realistic,” “review from a manager's point of view,” etc., allowing users to evaluate the generated ideas.

In addition, the emotion recognition means is used to recognize the user's emotions. The emotion recognition means uses the Emotion Recognition library and camera to analyze the user's emotions. Based on the recognized emotion, the means evaluates the generated ideas and generates new ideas. For example, if the user indicates an emotion of joy, a positive idea is added.

This includes means installed on robots to generate ideas for new production processes and efficiencies within the factory. The robot patrols the factory, receives thematic input from workers, and generates relevant ideas and questions using generative AI means. The generated ideas are evaluated based on the worker's emotions and new ideas are added as needed.

### Concrete Example

For example, if a user enters the topic “Improving the efficiency of a new production line,” the generative AI method will generate the following ideas and questions.
Example of a prompt statement: “I am a member of the
Topic: New production line efficiency
Generate relevant ideas and questions.
Generated ideas and questions:
Where are the bottlenecks in the production line?
What technologies are needed to promote automation?
How can we reduce the burden on workers?
Add positive ideas.
A new robot arm was introduced to improve work efficiency.
Motivate workers to take more breaks.

In this way, appropriate ideas can be provided according to the user's emotional state, thus increasing their practicality in the factory.

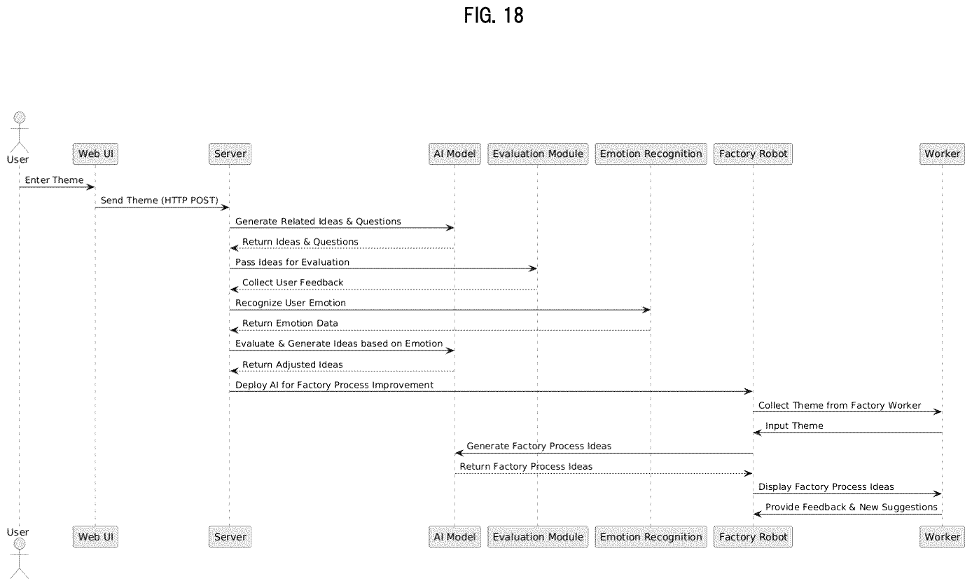

The flow of the identification process in Example of Application 1 is described in FIG. 18.

### Step 1:

The user enters a theme. The user enters the theme through the web user interface (WebUI). The entered theme is sent to the server. The input data is textual information about the theme.

### Step 2:

The server receives the input themes and passes them to the generative AI means. The generative AI means generates ideas and questions related to the theme using a generative AI model such as OpenAI API. The input data is textual information of the theme, and the output data is textual information of the generated ideas and questions.

### Step 3:

The server passes the generated ideas and questions to the evaluation means. The evaluation means provides evaluation buttons such as “original,” “realistic,” “review from a manager's point of view,” etc., to allow users to evaluate the generated ideas. The input data is the textual information of the generated ideas and questions, and the output data is the results of the user's evaluation.

### Step 4:

The server uses emotion recognition methods to recognize the user's emotions. The emotion recognition means uses the Emotion Recognition library and camera to analyze the user's emotions. The input data is the user's facial image and voice data, and the output data is information about the recognized emotion.

### Step 5:

The server evaluates the ideas generated based on the recognized emotions and uses the means to generate new ideas. For example, if a user indicates an emotion of joy, a positive idea is added. The input data is the information of the recognized emotion and the textual information of the generated ideas and questions, and the output data is the textual information of the new ideas evaluated based on the emotion.

### Step 6:

The server uses means installed on robots to generate ideas for new production processes and efficiencies within the factory. The robot patrols the factory, receives theme input from workers, and uses generative AI means to generate relevant ideas and questions. The input data is the textual information of the themes from the workers and the output data is the textual information of the generated ideas and questions.

### Step 7:

The server presents the generated ideas and questions to the workers. The workers can consider new production processes and ways to improve efficiency based on the ideas and questions presented. The input data is textual information of the generated ideas and questions, and the output data is feedback and new suggestions by the workers.

### Example 2

Next, example 2 of exemplary embodiment of implement will be described. In the following description, data processing device 12 is referred to as the “server” and smart device 14 is referred to as the “terminal.

In conventional brain-streaming support systems, it was difficult to provide appropriate feedback and expansion to user-generated ideas, and the quality and creativity of ideas were not sufficiently enhanced. In addition, because evaluation criteria were set without considering the user's emotional state, there was also the problem that ideas were not evaluated appropriately according to the user's state. Furthermore, there was insufficient linkage with web conferencing tools, making it difficult to effectively utilize the ideas and minutes generated during meetings.

The specific processing unit 290 of the data processing device 12 in Example 2 is realized by the following means.

In this invention, the server has a means for inputting a theme from the user, a generative AI means for generating ideas and questions related to the theme, an evaluation means for supporting expansion on the generated ideas, a means for generating prompt text based on the type of evaluation button, a means for sending the generated prompt text to the generative AI means, a means for displaying the new ideas returned from the generative AI means to the user, an emotion engine means for analyzing the user's emotional state, and a means for adjusting the evaluation criteria based on the analysis results of the emotion engine means. means, a means for displaying the new ideas returned by the generative AI means to the user, an emotion engine means for analyzing the user's emotional state, a means for adjusting the evaluation criteria based on the analysis results of the emotion engine means, and a means for input from the WebUI and for linking with a web conferencing tool. The system includes. This enables the setting of appropriate evaluation criteria according to the user's emotional state and the generation and expansion of high-quality ideas by the generative AI. In addition, the linkage with the Web conferencing tool enables effective use of ideas and minutes generated during the meeting.

The “means of theme input from users” is an interface for users to input themes, such as new business development, into the system.

Generative AI means” is an artificial intelligence function that generates relevant ideas and questions based on a theme entered by the user.

The “evaluation method” is a function that allows users to evaluate the ideas generated and helps them expand on those ideas based on their evaluation.

The “Evaluation Buttons” are buttons that allow for “creative,” “realistic,” and “management's point of view review.”

The “means of generating prompt sentences” is a function that generates prompt sentences to be sent to the generative AI means based on the type of evaluation button pressed by the user.

The “means of transmitting to the generative AI means” is a function for transmitting the generated prompt sentences to the generative AI means.

The “means for displaying new ideas returned by the generative AI means to the user” is a function that receives new ideas returned by the generative AI means and displays them on the user's terminal.

The “emotion engine means” is a function for analyzing the user's emotional state.

The “means to adjust evaluation criteria” is a function that adjusts the evaluation criteria based on the analysis results of the emotion engine means.

The “means of input from the WebUI” is the ability for users to provide input to the system through the Web interface.

The “means of linking with web conferencing tools” is a function to link with web conferencing tools and capture ideas and minutes from meetings in the system.

This invention is a system in which a user inputs a theme, such as new business development, and a generative AI method is used to generate ideas and questions related to that theme, and to support expansion on the generated ideas. An exemplary embodiment of this system is described below.

### Hardware and Software Used

Server: Performs the core processing of this system. It executes the AI generation model, stores data, and provides the user interface.

Terminal: A device operated by a user, such as a PC or a smart device.

Generative AI models: Use generative AI models such as OpenAI's GPT-4.

Emotion Engine: Software to analyze the user's emotional state. For example, it uses the emotion recognition API of Microsoft's (registered trademark) Azure (registered trademark) Cognitive Services.

### System Process Flow

1. the user enters an idea

The user uses a terminal to enter ideas for new business development into the system's input form. For example, the user would enter, “For new business development, consider introducing new technology.
2. the user presses the “Rate” button

The user presses one of the rating buttons, such as “original,” “realistic,” or “review from a manager's point of view,” for the ideas entered by the user.
3. the server generates prompt statements

Based on the type of evaluation button pressed by the user, the server will generate a prompt sentence to be sent to the generative AI model. For example, if the button “Originally” is pressed, the server generates the prompt sentence “What original business will be possible with the introduction of new technology?
4. the server sends prompt statements to the generated AI model

The server sends the generated prompt sentences to the generative AI model. The generative AI model is running in the cloud.
5. generation AI model generates new ideas

The generative AI model generates new ideas based on the prompt sentence. For example, it generates ideas such as “New technologies will enable personalized marketing using AI.
6. display server-generated ideas to users

The server receives the new ideas returned from the generative AI model and displays them on the user's terminal.
7. an emotional engine analyzes the user's emotions (another exemplary embodiment)

While the user is inputting ideas, the emotion engine analyzes the user's facial expressions and voice to determine whether the user is in an excited or calm state.
8. the server adjusts the evaluation criteria (another exemplary embodiment)

The server receives the results of the emotion engine analysis and sets the evaluation criteria higher when the user is in an excited state, making it easier to evaluate challenging ideas. Conversely, if the user is in a calm state, the evaluation criteria are set lower, making it easier to evaluate realistic ideas.

### Concrete Example

### Example 1: Expansion of Ideas

User's operation: User enters the idea “For new business development, consider introducing new technologies” and presses the “Originally” rating button.

Server processing: The server sends a prompt statement to the generative AI model, “What creative business will be possible with the introduction of new technology?

Generative AI Model Response: The Generative AI Model generates new ideas such as “New technologies will enable personalized marketing using AI.

Display of results: The server displays the generated ideas on the user's terminal.

### Example 2: Using the Emotion Engine

User manipulation: the user inputs the idea “For new business development, think about introducing new technologies” and the emotion engine detects the user's state of excitement.

Server processing: The server sets the evaluation criteria high based on the analysis results of the emotion engine and sends a prompt statement to the generative AI model: “What challenging projects would be possible through the introduction of new technologies?

Generative AI Model Response: The generative AI model generates challenging ideas such as “The introduction of new technologies will enable the construction of fully automated smart cities.

Display of results: The server displays the generated ideas on the user's terminal.

### Example of Prompt Text

What kind of creative projects will be possible through the introduction of new technologies?”

What realistic business opportunities will be made possible by the introduction of new technologies?”

What are the benefits, from a management perspective, of implementing new technologies?”

These are the exemplary embodiments of this system.

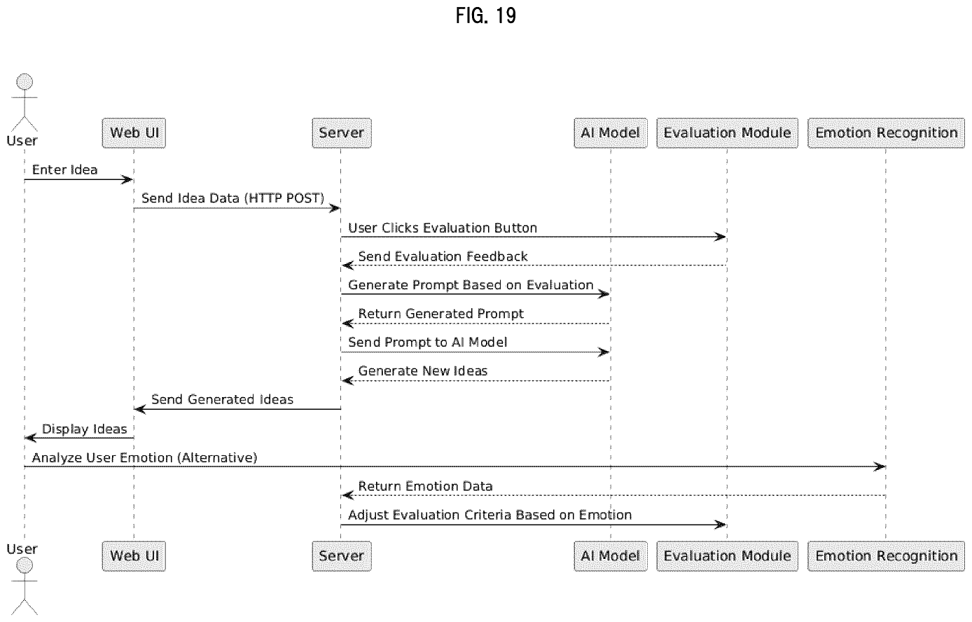

The flow of the identification process in Example 2 is described in FIG. 19.

### Step 1:

The user enters an idea.

The user opens a browser on his/her terminal and accesses the system's web page. In the input form, the user enters the following information: “For new business development, consider the introduction of new technologies. The entered data is sent from the terminal to the server.

Input: Idea entered by user

Output: Idea data sent to server

### Step 2:

The user presses the “Evaluate” button.

The user clicks one of the evaluation buttons, such as “original,” “realistic,” or “review from a manager's perspective. When the button is clicked, the information is sent from the terminal to the server.

Input: Information about the rating button pressed by the user

Output: Information on evaluation buttons sent to the server

### Step 3:

The server generates a prompt statement.

Based on the information of the evaluation buttons received by the server, it generates prompt statements to be sent to the generative AI model. For example, if the “Be creative” button is pressed, the prompt sentence “What creative business will be possible with the introduction of new technology?” is generated.

Input: Rating button information

Output: Generated prompt statements

### Step 4:

The server sends prompt statements to the generated AI model.

The server sends the generated prompt sentences to the generative AI model. The generative AI model is running in the cloud.

Input: Generated prompt text

Output: Prompt statements sent to the generated AI model

### Step 5:

Generative AI models generate new ideas.

The generative AI model analyzes the prompt sentence and generates new ideas. For example, it generates ideas such as “New technologies will enable personalized marketing using AI. The generated ideas are returned to the server.

Input: Prompt statement

Output: New ideas generated

### Step 6:

The server displays the generated ideas to the user.

The server receives the new ideas returned from the generative AI model and sends them to the user's terminal. The user's terminal displays the new idea on the screen.

Input: new ideas generated

Output: Idea displayed on user's terminal

### Step 7:

The emotion engine analyzes the user's emotions (another exemplary embodiment).

While the user is inputting ideas, the emotion engine analyzes the user's facial expressions and voice to determine whether the user is in an excited or calm state. The analysis results are sent to the server.

Input: user's facial expressions and voice data

Output: Results of analysis by the emotion engine

### Step 8:

The server adjusts the evaluation criteria (another exemplary embodiment).

When the server receives the results of the emotion engine analysis and the user is in an excited state, it sets the evaluation criteria higher, making it easier for challenging ideas to be evaluated. Conversely, if the user is in a calm state, the evaluation criteria are set lower, making it easier to evaluate realistic ideas.

Input: Emotion engine analysis results

Output: Adjusted evaluation criteria

### Example of Application 2

Next, example of application 2 of example of implement 2 will be described. In the following description, data processing device 12 is referred to as the “server” and smart device 14 is referred to as the “terminal.

Conventional brainstorming support systems evaluate ideas without considering the user's emotional state, making it difficult to generate appropriate ideas according to the user's emotions. In addition, since the system was not designed for use on portable devices such as smartphones, users could not easily generate ideas anywhere.

The specific processing by the specific processing unit 290 of the data processing device 12 in example of application 2 is realized by the following means.

In this invention, the server includes theme input means from the user, generative AI means to generate ideas and questions related to the theme, and evaluation means to support expansion on the generated ideas. This makes it possible to detect the user's emotional state and adjust the evaluation criteria accordingly. Also, by including application means that are installed on a smartphone, users can easily perform idea generation anywhere.

The “Theme Input Method” is an interface for users to input brainstorming themes or topics.

Generative AI means” is an artificial intelligence function that automatically generates ideas and questions related to the input theme.

The “evaluation method” is a function that allows users to evaluate the ideas generated and helps them expand on those ideas based on their evaluation.

The “means of input from the WebUI” is the means by which a user inputs information through the Web user interface.

The “means of linking with web conferencing tools” is a means of linking with web conferencing tools to share information and utilize data such as meeting minutes.

The “emotion engine means” is a function that detects the user's emotional state and adjusts the system's behavior based on that information.

The “means of adjusting evaluation criteria” is a function that dynamically changes the criteria for evaluating ideas based on the user's emotional state.

An “application means installed on a smartphone” is a function of an application that is installed on a smartphone and can be used by users anywhere.

As an exemplary embodiment of this invention, the following system can be constructed.

First, the user enters a brainstorming theme using an application installed on his/her smartphone. The theme input method receives the theme entered by the user and sends it to the server.

The server uses generative AI means to generate ideas and questions related to the input theme. This generative AI means can use a generative AI model, such as GPT-3, for example. The generated ideas are displayed on the user's smartphone.

The user then presses a rating button for the displayed idea, such as “original,” “realistic,” “review from a manager's perspective,” etc. The evaluation method receives the user's rating and assists in expanding the idea accordingly.

In addition, the emotion engine means detects the user's emotional state. The emotion engine means can use an emotion detection library such as Affectiva, for example. Based on the emotional state, the means for adjusting the evaluation criteria operates to set the appropriate evaluation criteria according to the user's emotion.

The system also includes a means of input from the WebUI and a means of interfacing with web conferencing tools, which can extract information from meeting minutes and use it for idea generation.

As a concrete example, if a user inputs the theme “For new business development, consider introducing new technologies,” the generative AI method can generate the following prompt sentence.

Example of a prompt statement: “I am a member of the

I'm thinking about introducing new technology for new business development. What technologies should we introduce as an original approach?”

Based on this prompt statement, the generative AI model generates new ideas and provides them to the user. When the user presses the “Originally” rating button, the generative AI means generates a new idea, such as “What creative business can be made possible by the introduction of new technology?

In this way, a system in which the generative AI provides new ideas based on the user's emotional state and evaluation criteria is realized.

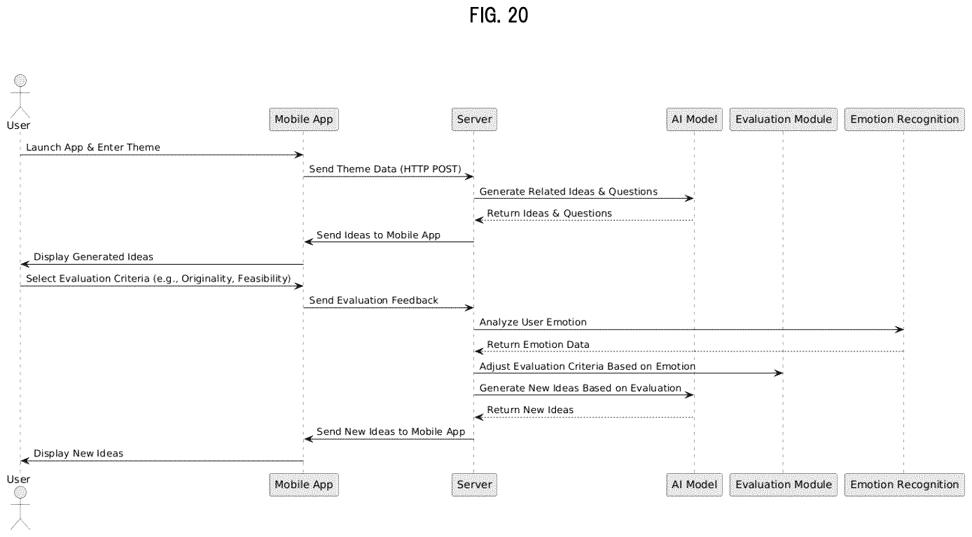

The flow of the identification process in example of application 2 is described in FIG. 20.

### Step 1:

Users launch the application installed on their smartphones and enter a brainstorming theme.

Input: Theme entered by user (e.g., “For new business development, consider introducing new technologies”)

Output: The input theme is sent to the server.

Specific action: The user enters a theme in the application's input field and presses the

“Submit” button.

### Step 2:

The server uses generative AI methods to generate ideas and questions related to the input theme.

Input: User entered theme

Outputs: generated ideas or questions (e.g., “What creative projects could be made possible by the introduction of new technologies?”)

Specific behavior: The server prompts a GPT-3 or other generative AI model for a theme and retrieves the generated ideas.

### Step 3:

The generated ideas are displayed on the user's smartphone.

Input: generated ideas and questions

Output: Ideas and questions displayed on the smart phone screen

Specific behavior: The server sends the generated idea to the smartphone and the application displays it.

### Step 4:

The user presses a rating button for the ideas displayed, such as “original,” “realistic,” or “review from a manager's point of view.

Input: User's rating (e.g., “creatively”)

Output: The evaluation results are sent to the server.

Specific action: The user selects the “Rate” button and presses the “Submit” button.

### Step 5:

The server uses the emotion engine means to detect the user's emotional state.

Input: emotional data of the user (e.g., input from camera or microphone)

Output: Detected emotional state (e.g., “excited”)

Specific behavior: The server analyzes the user's emotional state using an emotion detection library such as Affectiva.

### Step 6:

The means of adjusting the evaluation criteria based on the emotional state operates.

Input: Detected emotional state

Output: Adjusted evaluation criteria (e.g., “creatively”)

Specific behavior: The server re-sets the evaluation criteria according to the emotional state.

### Step 7:

The server generates new ideas based on evaluation criteria.

Input: adjusted evaluation criteria, initial ideas

Outputs: new ideas (e.g., “What creative projects could be made possible by the introduction of new technologies?”)

Specific behavior: The server again prompts the generative AI model to generate new ideas.

### Step 8:

New ideas are displayed on the user's smartphone.

Input: Newly generated ideas

Output: new ideas displayed on smartphone screens

Specific behavior: The server sends new ideas to the smartphone and the application displays them.

### Example 3

Next, example 3 of exemplary embodiment of implement will be described. In the following description, data processing device 12 is referred to as the “server” and smart device 14 is referred to as the “terminal.

Conventional brain-streaming support systems mainly generate ideas based on input information from the user, and could not utilize the minutes data from web conferencing tools. As a result, important information and ideas discussed during the meeting were not fully utilized, making efficient idea generation difficult. In addition, there was insufficient support for evaluation and expansion of generated ideas, making it difficult for users to effectively utilize the generated ideas.

The specific processing by the specific processing unit 290 of the data processing device 12 in Example 3 is realized by the following means. In this invention, the server has a means for inputting themes from users, a means for generating ideas and questions related to the themes, a means for evaluating the generated ideas to support expansion, a means for input from the WebUI and a means for linking with a web conferencing tool, a means for acquiring minutes data from the web conferencing tool means to acquire the minutes data from the web conferencing tool, means to analyze the acquired minutes data and extract important information, means to generate and send prompt sentences to the generative AI model based on the extracted information, and means to store the generated ideas. This makes it possible to efficiently generate new ideas using the minutes data from the web conferencing tool, and to support evaluation and expansion on the generated ideas.

The “user input method” is an interface that allows users to input information about a particular theme or topic.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link the system with web conferencing tools to obtain and utilize information during a meeting.

The “means to retrieve meeting minutes data from a web conferencing tool” is a function to automatically retrieve meeting minutes data from a web conferencing tool.

Means to analyze acquired minutes data and extract important information” is a function to analyze acquired minutes data and extract important information discussed during the meeting.

The “means for generating and sending prompt sentences to the generative AI model based on the extracted information” is a function for generating and sending prompt sentences to the generative AI model based on the extracted information.

The “means of storing generated ideas” is a function for storing ideas generated from the generative AI model in a database or other location.

This invention is a system including means for inputting themes from users, generative AI means, evaluation means, input means from the WebUI, means for linking with a web conferencing tool, means for acquiring minutes data from the web conferencing tool, means for analyzing the acquired minutes data and extracting important information, means for generating prompt statements based on the extracted information to a generative AI model The system includes a means to generate and send prompt sentences to a generative AI model based on the extracted information, and a means to store the generated ideas.

### Server Operation

The server first acquires the minutes data from the web conferencing tool (e.g., a common web conferencing tool) at. The API of the web conferencing tool is used for this acquisition. The acquired minutes data is analyzed using a natural language processing library (e.g., NLTK or SpaCy). As a result of the analysis, important keywords and phrases are extracted.

Next, the server generates prompt sentences to be sent to the generative AI model (e.g., OpenAI's GPT-3) based on the extracted information. For example, if the minutes contain the information “New business development requires the introduction of new technologies,” the server generates the prompt sentence “What new businesses can be developed through the introduction of new technologies?

The generated prompt sentences are sent to the generative AI model to generate new ideas. The generated ideas are stored in a database by the server. The stored ideas are later provided to users.

### Terminal Operation

The terminal sends information entered by the user through the WebUI to the server. For example, the user enters specific questions or requests regarding new business development. The terminal also receives the ideas generated by the server and displays them to the user. The user can provide further feedback based on the displayed ideas, which are also sent from the terminal to the server.

### User Behavior

Users enter information about new business development through the WebUI. For example, the user enters a specific question such as, “We are seeking ideas regarding the introduction of new technology. The user also uses a web conferencing tool to conduct a meeting, and the minutes of that meeting are captured by the system. The user reviews the ideas generated and provides feedback as needed.

### Concrete Example

1. minutes of the meeting: “New business development requires the introduction of new technologies.”

2. prompt statement for the generated AI model: “What new businesses can be developed by introducing new technologies?

A generative AI model might generate the following ideas based on this prompt sentence

Developing an AI-based customer support system.”

“Building a Supply Chain Management System Using Blockchain Technology.”

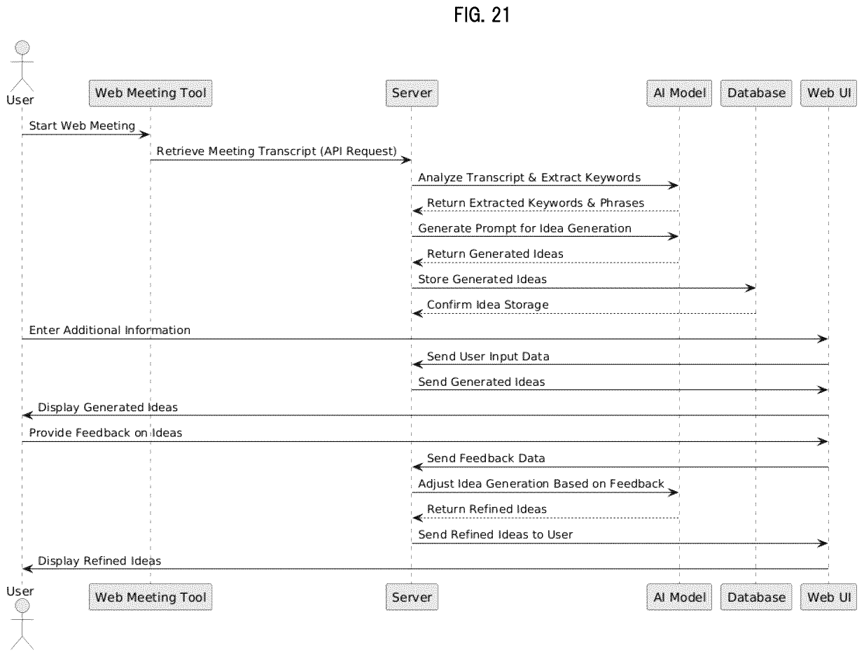

Thus, the system utilizes the minutes data of the web conferencing tool to generate new ideas using a generative AI model. This allows users to efficiently obtain new business ideas. The flow of the identification process in Example 3 is described in FIG. 21.

### Step 1:

The server obtains the meeting minutes data from the web conferencing tool. Specifically, it downloads the meeting minutes data using the API of the Web conferencing tool. The input is authentication information such as meeting ID and API key, and the output is the acquired minutes data.

### Step 2:

The server analyzes the acquired minutes data. Specifically, text analysis is performed using a natural language processing library (e.g., NLTK or SpaCy). The input is the minutes data, and the output is the extracted important keywords and phrases.

### Step 3:

The server generates prompt sentences to be sent to the generative AI model based on the analysis results. For example, if the information includes “New business development requires the introduction of new technology,” the server generates the prompt sentence “What new business can be developed by introducing new technology? The input is the extracted keywords or phrases and the output is the generated prompt sentence.

### Step 4:

The server sends the generated prompt text to the generative AI model. Specifically, it sends an API request to the generative AI model (e.g., OpenAI's GPT-3). The input is the prompt sentence and the output is the generated idea.

### Step 5:

The server stores the ideas returned from the generative AI model in a database. Specifically, it executes an INSERT query against the database. The input is the generated ideas and the output is the confirmation information of the stored ideas.

### Step 6:

The terminal sends the information entered by the user through the WebUI to the server. Specifically, the user enters information into the input form and presses the submit button. The input is the information entered by the user and the output is the information sent to the server.

### Step 7:

The terminal receives the ideas generated by the server and displays them to the user. Specifically, it receives the response from the server and displays it in the WebUI. The input is the ideas received from the server and the output is the ideas displayed to the user.

### Step 8:

The terminal sends the feedback provided by the user to the server. Specifically, the user enters information into the feedback form and presses the submit button. The input is the feedback entered by the user and the output is the feedback sent to the server.

### Step 9:

Users enter information about new business development through the WebUI. Specifically, the user enters information in the input form and presses the submit button. The input is the information entered by the user and the output is the information sent to the end.

### Step 10:

The user uses a web conferencing tool to conduct a meeting. Specifically, the meeting is initiated and the minutes are automatically recorded. The input is the audio and text of the meeting, and the output is the recorded minutes data.

### Step 11:

The user reviews the generated ideas displayed on the terminal and provides feedback. Specifically, the user evaluates the displayed ideas, enters information in the feedback form, and presses the submit button. The input is the displayed ideas and user feedback, and the output is the feedback sent to the terminal.

### Example of Application 3

Next, example 3 of application of example of implement 3 will be described. In the following description, data processing device 12 is referred to as the “server” and smart device 14 is referred to as the “terminal.

In conventional brain-streaming support systems, themes are input by the user and ideas are generated by a generative AI, but the quality and realism of the ideas generated are limited because the system does not fully utilize the content of the discussions at the meeting and the emotional information of the participants. In addition, the evaluation of generated ideas and suggestions tend to be subjective, making it difficult to efficiently select the most useful ideas.

The specific processing by specific processing unit 290 of data processing device 12 in example of application 3 is realized by the following means. In this invention, the server has a means of inputting themes from users, a means of generating ideas and questions related to the themes, a means of evaluating the generated ideas to support expansion, a means of input from the WebUI and a means of linking with web conferencing tools, a means of analyzing the content of the minutes and extracting keywords and emotional information, an idea generation means to generate new ideas based on the extracted information, and an evaluation and suggestion means to evaluate the generated ideas and suggest the most useful ideas. This enables the generation of high-quality, realistic ideas based on the content of the discussions in the meeting and the emotional information of the participants, as well as efficient evaluation and suggestion of ideas.

The “user input method” is an interface that allows users to input discussion and idea generation themes to the system.

Generative AI means” is an artificial intelligence function that generates relevant ideas and questions based on input themes.

The “evaluation means” is a function for extending and evaluating the ideas generated.

The “means of input from the WebUI” is the means by which input is received from the user through the web user interface.

The “means of interfacing with web conferencing tools” is the means of interfacing the system with web conferencing tools to capture meeting minutes and other information.

The “analysis method for analyzing the content of minutes” is a function for analyzing the content of minutes imported from a web conferencing tool and extracting important keywords and emotional information.

The “idea generation means” is a function to generate new ideas based on the information extracted by the analysis means.

The “evaluation and suggestion means” is a function to evaluate the generated ideas and suggest the most useful ideas.

The following system configuration is an exemplary embodiment of this invention.

### System Configuration

The system includes means for theme input from users, generative AI, evaluation, input from the WebUI, integration with web conferencing tools, analysis of the content of the proceedings, idea generation, and evaluation suggestions.

### Program Processing

The server will perform the following

1. means of user input on the theme: 1.

Provide an interface for users to enter discussion and idea generation topics for the system. For example, use a form that runs on a web browser.

2. generative AI measures: (1)

Generate relevant ideas and questions based on the input theme. Generative AI models such as OpenAI's GPT-3 are used here.

3. evaluation instruments:

Extensions and evaluations are performed on the generated ideas. Evaluation is done using evaluation buttons such as “original,” “realistic,” “review from a manager's perspective,” etc.

4. means of input from WebUI:

Receive input from the user through the web user interface. For example, a rating is entered by a user clicking on the rating button.

5. means of interfacing with web conferencing tools:

Integrate the system with a web conferencing tool (e.g., Zoom) to capture meeting minutes and other information; use the API to automatically retrieve meeting minutes.

6. analytical means for analyzing the content of the minutes:

Analyze the content of minutes imported from web conferencing tools to extract important keywords and emotional information. Here, natural language processing libraries such as TextBlob are used.

7. idea generation means

Generate new ideas based on the information extracted by the analysis method. Generate prompt sentences and generate ideas using a generative AI model.

8. proposed means of evaluation

Evaluate the generated ideas and suggest the most useful ideas. Based on the evaluation results, present the highest rated ideas to the user.

### Concrete Example

For example, if the minutes of a Zoom meeting state that “a new robot arm needs to be installed,” the analysis method extracts this information and sends the following prompt statement to the generative AI model.

Example of a prompt statement: “I am a member of the

Key words in the proceedings: new robot arm, introduction, production efficiency

Emotional information: Positive

Use this information to generate ideas for new manufacturing techniques and production line improvements.

The generative AI model generates ideas about “how the new robot arm will improve production efficiency” based on this prompt sentence. The generated ideas are evaluated by the evaluation method, and the most useful ideas are suggested to the user.

In this way, high-quality, realistic ideas can be generated based on the content of the meeting discussions and the emotional information of the participants, and ideas can be efficiently evaluated and proposed.

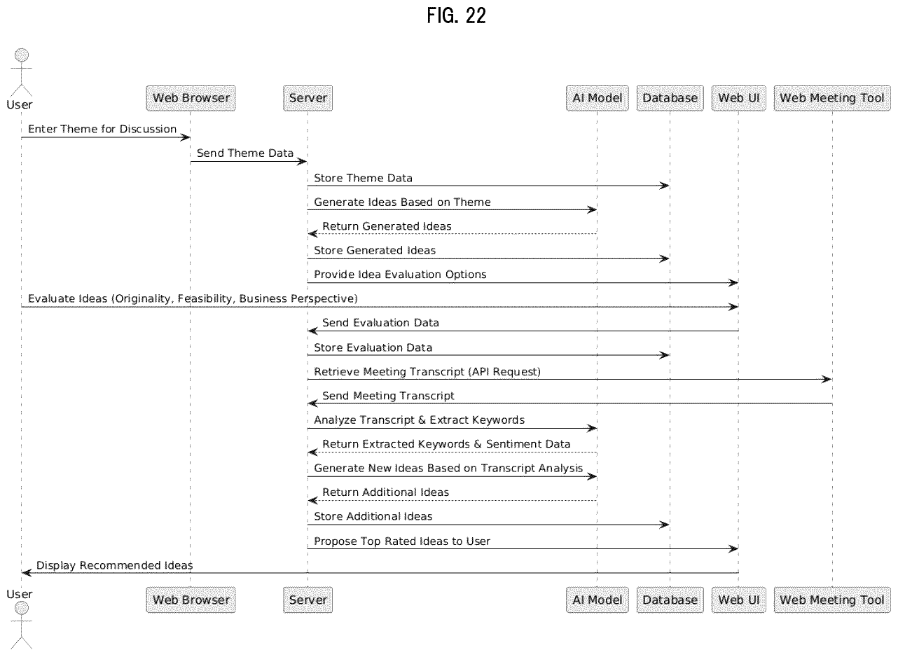

The flow of the identification process in example of application 3 is described in FIG. 22.

### Step 1:

The user enters a theme. The user uses a form on a web browser to enter a discussion or idea generation theme. The entered themes are sent to the server and stored in the database.

### Step 2:

The server generates ideas using generative AI methods. The server sends prompt statements to a generative AI model (e.g., OpenAI's GPT-3) based on the stored themes to generate related ideas and questions. The generated ideas are returned to the server and stored in a database.

### Step 3:

The server provides the evaluation method. Users review the ideas generated through the web UI and enter their ratings by clicking on the rating buttons such as “original,” “realistic,” “review from management's point of view,” etc. The evaluation results are sent to the server and stored in a database.

### Step 4:

The server uses a means of interfacing with the web conferencing tool to capture the minutes of the meeting. The server automatically retrieves the meeting minutes using the API of the web conferencing tool (e.g., Zoom). The retrieved minutes are stored on the server.

### Step 5:

The server analyzes the content of the minutes. The server analyzes the stored minutes and extracts important keywords and emotional information using a natural language processing library such as TextBlob. The extracted information is stored on the server.

### Step 6:

The server generates new ideas using idea generation methods. The server sends prompt sentences to the generative AI model based on the extracted keywords and emotional information to generate new ideas. The generated ideas are returned to the server and stored in the database.

### Step 7:

The server evaluates and suggests ideas using the evaluation and suggestion method. The server evaluates the generated ideas and suggests the most useful ideas to the user. Based on the evaluation results, the highest rated idea is presented to the user.

The specific processing unit 290 sends the results of the specific processing to the smart device 14. In smart device 14, control unit 46A causes output device 40 to output the results of the specific processing. Microphone 38B acquires audio indicating user input to the results of the specific processing. The control unit 46A transmits the voice data indicating the user input acquired by the microphone 38B to the data processing device 12. In data processing device 12, specific processing unit 290 acquires the voice data.

The data generation model 58 is a so-called Generative AI (Artificial Intelligence). An example of a data generation model 58 is a generative AI such as ChatGPT (registered trademark) (Internet search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (registered trademark) (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the smart device 14.

### Second Exemplary Embodiment

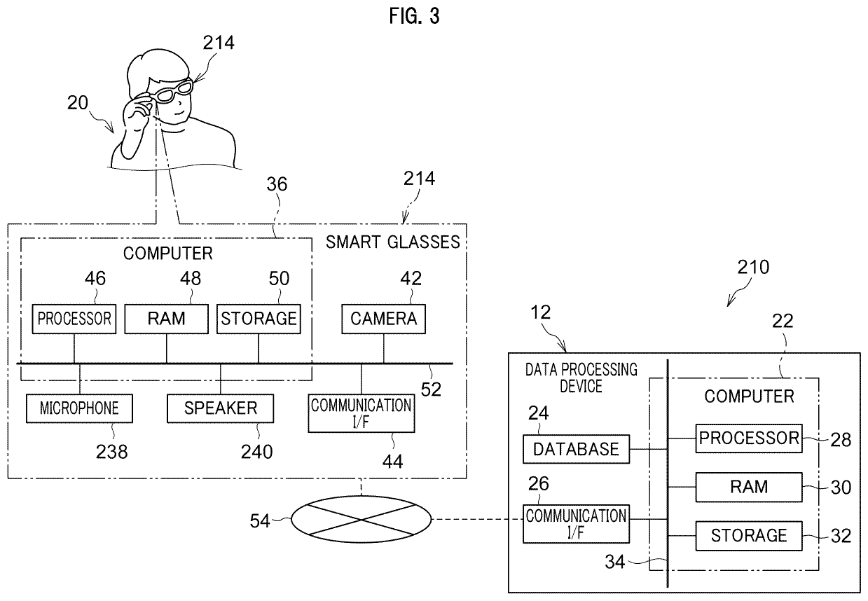

FIG. 3 shows an example of implement of a data processing system 210 for the second exemplary embodiment.

As shown in FIG. 3, data processing system 210 includes data processing device 12 and smart glasses 214. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart glasses 214 have a computer 36, microphone 238, speaker 240, camera 42, and communication I/F 44. The computer 36 has a processor 46, RAM 48, and storage 50. The processor 46, RAM 48, and storage 50 are connected to a bus 52. The microphone 238, speaker 240, and camera 42 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and captures images of the surroundings of the user 20 (for example, an image range defined by an angle of view equivalent to the field of view of a typical healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

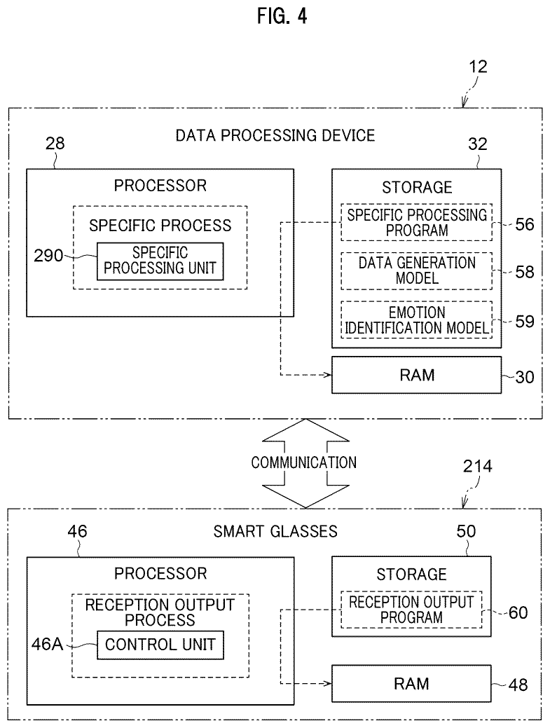

FIG. 4 shows an example of the key functions of data processing device 12 and smart glasses 214. As shown in FIG. 4, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290 at.

In smart glasses 214, the reception output process is performed by processor 46. The reception output program 60 is stored in storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48.

Next, the specific processing by the specific processing unit 290 of the data processing device 12 is described.

### Example of Implement 1

The brain streaming support system uses a generative AI to generate relevant ideas and questions based on the user's theme input. Specifically, if the user inputs “new business development” as a theme, the generative AI generates questions such as “What are the market needs for new business development?” and “What resources are needed for new business development?” and ideas such as “For new business development, utilize the existing customer base” and “For new business development, consider introducing new technology. Generate ideas such as.

### Example of Implement 2

For generated ideas, the system provides evaluation buttons such as “original,” “realistic,” “review from a manager's point of view,” etc., to support the expansion of ideas. Specifically, if a user presses the “original” evaluation button for the generated idea, “Consider introducing new technologies to develop new businesses,” the generative AI generates a new idea, such as “What kind of original business will be possible by introducing new technologies?

### Example of Implement 3

The system will utilize not only input from the WebUI, but also information from the minutes of the meeting in conjunction with the web conferencing tool. Specifically, the system takes the minutes of a meeting held with a web conferencing tool such as Zoom, and the generative AI generates new ideas based on the information contained in the minutes. For example, if the minutes include the information that “introduction of new technology is necessary for new business development,” the generative AI generates new ideas based on this information, such as “What kind of new business can be developed by introducing new technology?

The following is a description of the process flow for each example of implement.

### Example of Implement 1

Step 1: User accesses the Brainstorming Support System WebUI,

Enter “New Business Development” as the theme.

Step 2: The system's generative AI receives thematic input from the user and generates relevant ideas and questions. Specifically, the system generates questions such as “What are the market needs for new business development?” and “What resources are needed for new business development?” as well as ideas such as “For new business development, utilize the existing customer base” and “For new business development, consider introducing new technologies”

Step 3: Present the generated ideas and questions to the user. The user can add his/her own thoughts and evaluate the ideas presented.

### Example of Implement 2

Step 1: The user presses the “Originally” rating button for the generated idea “For new business development, consider introducing new technologies.

Step 2: The system's generative AI receives evaluation input from the user and generates new ideas based on the evaluation. Specifically, the system generates new ideas such as “What kind of creative business will be possible through the introduction of new technologies?

Step 3: Present the generated new ideas to the user. The user can add his/her own thoughts and evaluate the ideas presented.

### Example of Implement 3

Step 1: The user conducts a meeting using a web conferencing tool such as Zoom, and the minutes of the meeting are imported into the system.

Step 2: The system's generative AI analyzes information from the minutes and generates new ideas based on this information. For example, if the minutes include the information that “introduction of new technology is necessary for new business development,” the generative AI generates new ideas based on this information, such as “What kind of new business can be developed by introducing new technology?

Step 3: Present the generated new ideas to the user. The user can add his/her own thoughts and evaluate the ideas presented.

### Example 1

The following is an example of exemplary embodiment of implement. In the following description, the data processing device 12 will be referred to as the “server” and the smart glasses 214 will be referred to as the “terminal”.

Conventional brain-streaming support systems lack the ability to automatically generate specific ideas and questions related to a theme when a user enters a theme. They also lack the means to evaluate and further expand on the generated ideas and questions. Furthermore, there is insufficient integration with web conferencing tools, making it difficult to effectively utilize the information obtained during meetings.

The specific processing by the specific processing unit 290 of the data processing device 12 in Example 1 is realized by the following means.

In this invention, the server includes means for inputting themes from the user, converting the themes into prompt sentences, sending the prompt sentences to the generative AI model, receiving output from the generative AI model, displaying the generated ideas and questions to the user, input from the WebUI means and means of interfacing with the web conferencing tool. This allows for the automatic generation of specific ideas and questions based on user input on a theme, which can then be evaluated and expanded upon. In addition, the linkage with the Web conferencing tool allows the user to effectively utilize the information obtained during the meeting.

The “means of inputting themes from users” is a means of providing an interface for users to input brainstorming themes.

The “means of converting the theme into a prompt sentence” refers to the means of converting the theme input by the user into a prompt sentence in a format suitable for the generated AI model.

The “means for transmitting the prompt text to the generating AI model” is a means for transmitting the generated prompt text to the generating AI model.

The “means of receiving output from the generative AI model” is the means of receiving ideas and questions returned from the generative AI model.

A “means of displaying generated ideas and questions to users” is a means of displaying ideas and questions received from the generated AI model to users.

The “means of input from the WebUI” is the means by which the user provides input through the Web interface.

The “means of linking with web conferencing tools” is a means of obtaining information in conjunction with web conferencing tools and utilizing it within the system.

### Exemplary Embodiment of the Invention

This invention is a brain-streaming support system that allows users to input a theme, which is then used to generate relevant ideas and questions using a generative AI model. An exemplary embodiment of this system is described below.

### System Configuration

The system consists of the following major components
1. means for users to input themes
2. means of converting such themes into prompt text
3. means of transmitting such prompt sentences to a generative AI model
4. means of receiving output from the generated AI model
5. a means of displaying the generated ideas and questions to the user
6. input method from WebUI
7. means of cooperation with web conferencing tools

### Hardware and Software Used

Hardware: servers, terminals (user's PC or smartphone)
Software: Generative AI model (e.g. GPT-4), Web browser, HTML, JavaScript, Python

### Program Processing

The user enters a theme through a web browser. For example, the user enters the theme “New Business Development”. The terminal sends this theme to the server. The server converts the received theme into a prompt text. Specifically, the server generates the prompt statement, “Please generate questions and ideas about ‘new business development’.” The prompt sentence “Please generate questions and ideas about ‘new business development” is generated.

The server sends this prompt sentence to the Generative AI model (GPT-4). The Generative AI model generates relevant questions and ideas based on the prompt sentence. For example, “What are the market needs for new business development?” or “For new business development, we will leverage our existing customer base” will be generated.

The generated questions and ideas are sent to the terminal via the server. The terminal displays this information on a web browser, and users can brainstorm based on this information.

### Concrete Example

The user enters the theme “New Business Development”. The terminal sends this theme to the server. The server generates the prompt “Please generate questions and ideas about ‘new business development” and sends it to the generative AI model (GPT-4), and sends it to the generative AI model (GPT-4). The generative AI model will ask questions such as “What are the market needs for new business development?” and “Use the existing customer base for new business development. The server receives these generated results and sends them to the terminal. The terminal displays the received questions and ideas on the browser, and the user brainstorms based on them.

In this way, users can gain a variety of perspectives and ideas related to the topic and receive assistance in brainstorming.

The flow of the identification process in Example 1 is described in FIG. 11.

### Step 1:

The user enters a theme.

The user accesses the interface on the web browser and enters the theme they wish to brainstream in the theme entry field. For example, enter “new business development. The entered theme is temporarily stored in the memory of the terminal.

### Step 2:

The terminal sends the theme to the server.

The terminal sends the theme entered by the user to the server as an HTTP request. This request is made using the JavaScript fetch function. The input data is the theme “New Business Development” and the output is a request sent to the server.

### Step 3:

The server converts the theme into a prompt statement.

The server generates prompt statements based on the theme received. For example, for the theme “New Business Development,” the server generates the prompt statement, “Please generate questions and ideas about ‘New Business Development’.” The input data is the theme “New Business Development” and the output is the theme “New Business Development”. The input data is the theme “New Business Development” and the output is the prompt sentence “Please generate questions and ideas for ‘New Business Development’. The output is “Please generate questions and ideas about ‘new business development”.

### Step 4:

The server sends prompt statements to the generating AI model.

The server sends the generated prompt statements to the generating AI model (GPT-4). This communication is done using API requests. The input data is the prompt sentence and the output is the request sent to the generation AI model.

### Step 5:

Generative AI models generate questions and ideas.

The generative AI model generates relevant questions and ideas based on the prompt sentences received. For example, “What is the market need for new business development?” or “For new business development, we will leverage our existing customer base” are generated. The input data are the prompt sentences and the output are the questions and ideas generated.

### Step 6:

The server receives the generated questions and ideas.

The server receives questions and ideas returned from the generative AI model. This data is received in JSON format. The input data is the output from the data generation model and the output is the data received by the server.

### Step 7:

The server sends questions and ideas to the terminal.

The server sends the received questions or ideas to the terminal as an HTTP response. This response is also in JSON format. The input data are the questions and ideas generated, and the output is the data sent to the terminal.

### Step 8:

The terminal displays questions and ideas to the user.

The terminal displays the questions and ideas received from the server on the browser. Users can brainstorm based on this information. The input data is the response from the server and the output is the display on the browser.

### Example of Application 1

Next, example of application 1 of example of implement 1 will be described. In the following description, the data processing device 12 will be referred to as the “server” and the smart glasses 214 will be referred to as the “terminal.

Conventional brain-streaming support systems have the ability to generate ideas and questions based on themes entered by the user, but they lack support specific to particular industries or applications. In particular, they lack the ability to generate specific ideas and questions to improve production efficiency in a factory, making it difficult for factory managers and engineers to efficiently find ways to improve production lines.

The specific processing by the specific processing unit 290 of the data processing device 12 in example of application 1 is realized by the following means.

In this invention, the server includes theme input means from the user, generative AI means to generate ideas and questions related to the theme, evaluation means to support expansion on the generated ideas, input means from the WebUI and with web conferencing tools, and learning means to improve production efficiency in the factory. The system includes means to generate ideas and questions for improving production efficiency in the factory, and learning means to provide feedback on the generated ideas and questions and reflect them in the next and subsequent generations. This enables factory managers and engineers to efficiently generate specific ideas and questions to improve production efficiency and find improvement measures.

The “user input method” is an interface that allows users to enter a specific theme or issue.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link with web conferencing tools to share information and utilize data such as meeting minutes.

The “means of generating ideas and questions to improve production efficiency in a factory” is the ability to generate ideas and questions specifically designed to improve production efficiency in a factory.

A “learning method that provides feedback on generated ideas and questions and reflects it in the next generation” is a function that collects feedback from users, which is then used by the generative AI to generate ideas and questions for the next and subsequent generations.

As an exemplary embodiment of this invention, a brain-streaming support system for improving production efficiency in a factory is described in detail.

### System Configuration

The system includes the following major hardware and software components

Server: hosts a generative AI model, receives thematic input from users, and generates relevant ideas and questions.

User Terminal: Device (e.g., PC, tablet) for plant managers and engineers to enter topics and review generated ideas and questions.

Web User Interface (WebUI): An interface for users to enter themes and view generated ideas and questions.

Web conferencing tools: Tools for capturing meeting minutes and interfacing with the system.

### Program Processing

The server performs data processing and data computation using the following means

1. theme input method: The user enters a theme through the WebUI. For example, the user enters the theme of “improving production line efficiency”.

Generative AI means: Generate relevant ideas and questions based on input themes using a generative AI model such as OpenAI's GPT-3. The generated ideas and questions are processed on the server and sent to the user's terminal.

Means of evaluation: Users evaluate the ideas and questions generated. The evaluation results are sent to the server and will be reflected in the next and subsequent generations.

4. means of input from the WebUI: users provide feedback through the WebUI and rate the ideas and questions generated.

5. means of linking with web conferencing tools: Information is obtained from the minutes of the web conferencing tool and used as training data for the generative AI model.

6. learning means: update the generative AI model based on user feedback and reflect it in the generation of ideas and questions in the next and subsequent sessions.

### Concrete Example

For example, if a factory manager inputs the theme “improving production line efficiency,” the generative AI model will generate the following ideas and questions.

Where are the bottlenecks in the production line?”

What processes can be automated?”

Would changing the layout of the production line increase efficiency?”

These ideas and questions are displayed in the WebUI on the user's terminal, and the user can provide ratings and feedback on them.

### Example of Prompt Text

Topic: Improving production line efficiency

Generate relevant ideas and questions.

In this way, specific ideas and questions can be efficiently generated to improve production efficiency in the plant, allowing managers and engineers to find ways to improve.

The flow of the identification process in Example of Application 1 is described in FIG. 12.

### Step 1:

The user enters the theme through the WebUI.

Input: The user enters a theme, such as “improving the efficiency of the production line”.

Output: The input theme is sent to the server.

Specific action: The user enters the theme in the input field of the WebUI and clicks on the “Submit” button.

### Step 2:

The server uses a generative AI model to generate relevant ideas and questions based on the input themes.

Input: The server receives the theme submitted by the user.

Output: list of ideas and questions generated by the generative AI model.

Specific behavior: The server sends themes as prompt sentences to OpenAI's GPT-3 and other generative AI models, and receives generated ideas and questions.

### Step 3:

The server sends the generated ideas and questions to the user terminal.

Input: a list of ideas and questions generated by the generative AI model.

Output: Ideas and questions displayed on the user's terminal.

Specific operation: The server sends the generated ideas and questions to the WebUI of the user terminal for display.

### Step 4:

Users evaluate the ideas and questions generated.

Input: User evaluates the ideas and questions displayed.

Output: The evaluation results are sent to the server.

Specific behavior: User clicks on evaluation buttons on the WebUI, such as “original,” “realistic,” “review from management's point of view,” etc.

### Step 5:

The server receives the evaluation results from the user and stores them as training data to be reflected in the next generation.

Input: Evaluation results sent by the user.

Output: The evaluation results are stored and used as training data for the generative AI model.

Specific operation: The server stores the evaluation results in a database and provides them as feedback to the learning algorithm of the generative AI model.

### Step 6:

The server retrieves information from the minutes of the web conferencing tool and uses it as training data for the generative AI model.

Input: Minutes data from web conferencing tools.

Output: the minutes data is used as training data for the generative AI model.

Specific operation: The server obtains the minutes data through the API of the web conferencing tool and provides it to the training algorithm of the generative AI model.

In this way, specific ideas and questions can be efficiently generated to improve production efficiency in the plant, allowing managers and engineers to find ways to improve.

### Example 2

Next, example 2 of exemplary embodiment of implement will be described. In the following description, the data processing device 12 will be referred to as the “server” and the smart glasses 214 will be referred to as the “terminal”.

Conventional brainstorming support systems have a problem in that it is difficult to obtain appropriate feedback and expansion on ideas entered by users. In addition, the evaluation perspective was limited, making it difficult to expand on ideas from multiple perspectives. Furthermore, there was a lack of concrete means to improve the quality and relevance of the ideas generated.

The specific processing unit 290 of the data processing device 12 in Example 2 is realized by the following means.

In this invention, the server includes theme input means from the user, generative AI means to generate ideas and questions related to the theme, evaluation means to support expansion on the generated ideas, means to generate prompt sentences based on the evaluation, means to send the generated prompt sentences to the generative AI model means, a means to return a response from the generated AI model to the user, and means for input from the WebUI and linkage with the web conferencing tool. This allows for evaluation and expansion from multiple perspectives on user input ideas, thereby enhancing the quality and relevance of the generated ideas.

The “user input method” is an interface for users to enter ideas and themes into the system.

Generative AI means” is an artificial intelligence function that generates relevant ideas and questions based on a theme entered by the user.

The “evaluation means” is an interface for users to evaluate the generated ideas, and includes evaluation buttons such as “original,” “realistic,” and “review from a manager's perspective.

The “means of generating prompt sentences” is the ability to create prompt sentences for transmission to the generative AI model based on the user's ratings.

The “means of transmitting to the generative AI model” is a communication means for transmitting the generated prompt sentences to the generative AI model.

The “means of returning responses from the generative AI model to the user” is the ability to return to the user new ideas and responses received from the generative AI model.

The “means of input from the WebUI” is the means by which users enter information into the system through the Web interface.

The “means of linking with web conferencing tools” is a function to link with web conferencing tools to utilize information such as meeting minutes.

This invention is a system that supports the evaluation and expansion of ideas by utilizing a generative AI model based on themes entered by the user. An exemplary embodiment of this system is described below.

First, the user uses a terminal (e.g., PC or smartphone) to enter a theme through the system's WebUI. For example, the user would enter, “For new business development, consider the introduction of new technologies.

Next, the user presses one of the rating buttons for the theme entered, such as “Originally,” “Realistically,” or “Review from Management's Perspective.” For example, the user presses the “Originally” button.

The server generates the appropriate prompt sentence based on the evaluation button pressed by the user. For example, if the button “Creatively” is pressed, the server will generate the prompt sentence “What creative business will be possible with the introduction of the new technology?

Next, the server sends the generated prompt sentences to the generating AI model (e.g., GPT-4 of OpenAI). Specifically, the prompt sentences are sent through the API.

The generative AI model generates new ideas based on the prompt sentences it receives. For example, in response to the prompt sentence “What kind of creative business will be possible through the introduction of new technology?”, the model generates ideas such as “A new logistics service that utilizes AI-based automated driving technology.

Finally, the server returns the new ideas received from the generative AI model to the user. Specifically, the new ideas are displayed on the terminal screen.

The system allows users to evaluate and expand on the ideas they enter from multiple perspectives, enhancing the quality and relevance of the ideas generated. In addition, the system can be integrated with web conferencing tools to utilize information from meeting minutes.

As a specific example, consider a case in which a user enters “Consider introducing new technology for new business development” and presses the “Review from Management's

Perspective” evaluation button. In this case, the server generates the prompt sentence “What are the benefits and risks of introducing new technology from a manager's perspective? The generative AI model generates new ideas and reviews based on this prompt sentence, and the server returns the results to the user.

Examples of prompt statements include the following

What kind of creative projects will be possible through the introduction of new technologies?”

What are the benefits and risks of implementing new technologies from a management perspective?”

What is the practical impact of introducing new technologies?”

In this way, users can evaluate and further extend their ideas using the generative AI model.

The flow of the identification process in Example 2 is described in FIG. 13.

### Step 1:

The user enters the theme in the input form on the terminal.

Input: Theme to be entered by user (e.g., “For new business development, consider introducing new technologies”)

Output: The input theme is sent to the server.

Specific operation: The user uses the WebUI on the terminal to enter the theme and press the submit button.

### Step 2:

The user presses the “Evaluate” button.

Input: User-selected rating button (e.g., “Creatively”)

Output: The selected evaluation is sent to the server.

Specific action: The user presses one of the evaluation buttons for the entered theme, such as “original,” “realistic,” or “review from a manager's point of view.

### Step 3:

The server generates a prompt statement.

Input: User entered theme and rating button selection information

Output: Generated prompt text (e.g., “What creative business will be possible with the new technology?”)

Specific behavior: The server generates the appropriate prompt sentence based on the evaluation button pressed by the user.

### Step 4:

The server sends prompt statements to the generated AI model.

Input: Generated prompt text

Output: Prompt statements sent to the generated AI model

Specific behavior: The server sends the generated prompt sentences to the generated AI model (e.g., OpenAI's GPT-4) via API.

### Step 5:

Generative AI models generate new ideas.

Input: Prompt sentences sent to the generated AI model

Output: New ideas generated (e.g., “New logistics services using AI-based automated driving technology”)

Specific behavior: The generative AI model generates new ideas based on the prompt sentences it receives.

### Step 6:

The server returns the generated ideas to the user.

Input: new ideas received from the generative AI model

Output: New ideas displayed on the user's terminal

Specific operation: The server sends new ideas received from the generated AI model to the user's terminal and displays them on the screen.

### Example of Application 2

Next, example of application 2 of example of implement 2 will be described. In the following description, the data processing device 12 will be referred to as the “server” and the smart glasses 214 will be referred to as the “terminal.

Conventional brainstorming support systems lacked concrete means to further expand on user-generated ideas. They also lacked a function to assist content creators in generating new content ideas and further extending them using a rating button. This made it difficult to improve creativity and efficient idea generation.

The specific processing by the specific processing unit 290 of the data processing device 12 in example of application 2 is realized by the following means.

In this invention, the server includes theme input means from the user, generative AI means to generate ideas and questions related to the theme, evaluation means to support expansion on the generated ideas, input means from the WebUI and with web conferencing tools, and means for content creators to create new content ideas, means to support further extensions to them using the evaluation buttons, and application means installed on a smartphone or head-mounted display. This enables users to further expand on the ideas they generate using the evaluation buttons, thereby improving creativity and efficient idea generation.

The “user input method” is an interface that allows users to enter specific themes or topics into the system.

Generative AI means” is an artificial intelligence function that automatically generates relevant ideas and questions based on input themes.

The “evaluation means” is an interface that allows users to evaluate the generated ideas “creatively,” “realistically,” or “reviewed from a manager's point of view.

The “means of input from the WebUI” is the means by which a user inputs information through the Web user interface.

The “means of linking with web conferencing tools” is a function to link with web conferencing tools to utilize information such as meeting minutes.

The “means to support content creators in generating new content ideas and further extending them using the evaluation buttons” is a support function for content creators to generate new ideas and further develop them using the evaluation buttons.

An “application means installed on a smartphone or head-mounted display” is a means for using the system through an application installed on a smartphone or head-mounted display.

The system for implementing this invention includes theme input means from the user, generative AI means, evaluation means, input means from the WebUI, means for integration with web conferencing tools, means to help content creators generate new content ideas and further extend them with evaluation buttons means, including application means installed on smartphones and head-mounted displays.

### Description of the System's Program Processing

Hardware and Software Use
Hardware: (1)
Smart phone
HMD
Server
Software: C
OpenAI API
Python Programs
WebUI
Web conferencing tools
Data processing and data computation

### User Operation:

The user uses a smart phone or head-mounted display to enter the theme. For example, the user would enter the theme, “For new business development, consider introducing new technologies.

### Generative AI Processing:

The server generates relevant ideas and questions using a generative AI (e.g., GPT-3) based on the input theme. The ideas generated are, for example, “What kind of creative business will be possible through the introduction of new technologies?

### Operation of Evaluation Instruments:

The user presses a rating button for the generated idea, such as “original,” “realistic,” or “review from a manager's point of view. For example, if the user presses the “Originally” evaluation button, the generative AI will generate a new idea such as “Provide an AI-based personalized content delivery service by introducing new technology.

Integration with WebUI and Web Conferencing Tools:

Users can enter information through the WebUI and utilize information from the minutes of the web conferencing tool for further detailed idea generation.

### Support for Content Creators:

Content creators can use the evaluation buttons to further expand on generated ideas and generate new content ideas. This allows for increased creativity and efficient idea generation.

### Specific Examples and Prompt Statements

### Specific Examples

Initial Idea: “For new business development, consider implementing new technologies.”

User rating: “Ingenious”

Idea generated: “Implement new technologies to provide personalized content delivery services using AI.”

Example of a prompt statement: “I am a member of the

“For new business development, think creatively about introducing new technologies.”

In this way, the generative AI generates new ideas based on user evaluations, and the system supports the creativity of content creators.

The flow of the identification process in example of application 2 is described in FIG. 14.

### Step 1:

The user uses a smartphone or head-mounted display to enter a theme. For example, the user enters the theme, “For new business development, consider introducing new technologies. The entered theme is sent to the server.

Input: User entered theme

Output: Themes sent to server

### Step 2:

The server sends the received themes to the generative AI model (e.g., GPT-3), which generates related ideas and questions. The generative AI model generates prompt sentences based on the theme and outputs corresponding ideas.

Input: Themes sent to the server

Output: Ideas and questions generated by generative AI models

### Step 3:

The server sends the generated ideas and questions to the user's device. The user reviews the generated ideas through a smartphone or head-mounted display.

Input: ideas and questions generated by generative AI models

Output: Ideas or questions sent to the user's terminal

### Step 4:

The user presses an evaluation button for the generated ideas, such as “original,” “realistic,” “review from a manager's perspective,” etc. The evaluation button selection information is transmitted to the server.

Input: Selection information for the evaluation button pressed by the user

Output: Rating button selection information sent to the server

### Step 5:

The server generates new prompt sentences based on the selection information of the evaluation button and sends them to the generative AI model again. The generative AI model generates further extended ideas based on the new prompt sentences.

Input: Selection information for the evaluation button sent to the server

Output: Extended ideas generated by the generative AI model

### Step 6:

The server sends the augmented idea to the user's device. The user sees the augmented idea through a smartphone or head-mounted display.

Input: extended ideas generated by generative AI models

Output: Extension ideas sent to the user's terminal

### Step 7:

The user may continue to expand on the idea, pressing further evaluation buttons as needed. This process is repeated until the user is satisfied.

Input: Selection information for the evaluation button pressed by the user

Output: Further extended ideas generated by the generative AI model

In this way, users can further expand on the generated ideas using the evaluation buttons, which improves creativity and efficient idea generation.

### Example 3

Next, example 3 of exemplary embodiment of implement will be described. In the following description, the data processing device 12 will be referred to as the “server” and the smart glasses 214 will be referred to as the “terminal”.

Conventional brain-streaming support systems allow users to input themes and generate ideas using a generative AI, but they are not fully integrated with web conferencing tools, making it difficult to effectively utilize information obtained from meeting minutes. In addition, evaluation and extension support for generated ideas was limited, making it difficult for users to obtain the specific and practical ideas they were looking for. This reduced the efficiency and effectiveness of brain streaming.

The specific processing unit 290 of the data processing device 12 in Example 3 is realized by the following means.

In this invention, the server has a means for inputting a theme from the user, a generative AI means for generating ideas and questions related to the theme, an evaluation means for supporting expansion on the generated ideas, a means for input from the WebUI and a means for interfacing with a web conferencing tool, a means for analyzing minutes from the web conferencing tool and The system includes means for extracting important information, means for creating and sending prompt sentences to the generated AI model based on the extracted information, and means for displaying the ideas generated from the generated AI model to the user. This enables the system to effectively utilize information obtained from the minutes of the web conferencing tool to generate specific and practical ideas that users seek.

A “user input method” is a means of providing an interface for a user to enter a specific theme or topic into the system.

Generative AI means” are means using artificial intelligence technology to generate relevant ideas and questions based on input themes.

The “evaluation means” is a means for users to evaluate and provide feedback on the ideas generated.

The “means of input from the WebUI” is the means by which users enter information into the system through a Web browser.

The “means of linking with a web conferencing tool” is a means of linking a web conferencing tool with the system to capture meeting minutes and other information into the system.

Means for analyzing the minutes of a web conference tool and extracting important information” means a means for analyzing the minutes obtained from a web conference tool and extracting important information from them.

The “means for creating and sending prompt sentences to the generated AI model” is a means for creating and sending appropriate prompt sentences to the generated AI model based on the extracted information.

The “means for displaying ideas generated from the generative AI model to the user” is a means for displaying ideas generated from the generative AI model to the user.

This invention is a brain streaming support system in which the user, terminal, and server work together. Specific exemplary embodiments of this system are described below.

### User Operation

Users access the system's WebUI using a web browser; the WebUI has input fields, such as text boxes and drop-down menus, where users enter information such as “I would like you to generate ideas about new business development.

### Terminal Operation

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or through user interaction. The minutes are saved in text file or PDF format.

### Server Processing

The server receives the uploaded minutes and analyzes them using natural language processing (NLP) technology. Specifically, tools such as Python's NLTK library and SpaCy are used to extract important information from the minutes, such as “New business development requires the introduction of new technologies.

Based on the extracted information, the server creates prompt sentences to be sent to the generative AI model. For example, the server creates a prompt sentence “What new business can be developed by introducing new technology? The created prompt sentence is sent to the generative AI model via the API.

The generative AI model (e.g., OpenAI's GPT-3) generates new ideas based on the prompt text received. The generated ideas are returned to the server in text format.

The server receives the ideas returned from the generated AI model and sends them to the terminal. Communication protocols such as HTTP requests and WebSockets are used for transmission.

### Terminal Display

The terminal displays the ideas received from the server to the user; the WebUI displays the generated ideas and the user can review them. The user can also provide feedback and request that the idea be generated again, if necessary.

### Concrete Example

1. a user enters through the WebUI, “I would like you to generate ideas for new business development.

2. the user conducts a meeting using a web conferencing tool and uploads the minutes of the meeting to the system.

3. the server analyzes the minutes and extracts information that “new business development requires the introduction of new technology.

4. the server creates a prompt statement for the generated AI model, “What new business can be developed by introducing new technology?

5. the generative AI model generates new ideas and displays them to the user through the terminal.

### Example of Prompt Text

“Generate ideas about what new businesses could be developed through the introduction of new technologies.”

Thus, by linking the WebUI with a web conferencing tool, the system utilizes information obtained from the minutes and generates new ideas using a generative AI model. This allows users to obtain concrete and practical ideas. The flow of the specific process in Example 3 is described in FIG. 15.

### Step 1:

The user enters information through the WebUI.

The user opens a web browser and accesses the system's WebUI, which has input fields such as text boxes and drop-down menus where the user enters information such as “I would like you to generate ideas for new business development. The input information is sent to the server. The input data is in text format, which the server receives.

### Step 2:

The terminal uses a web conferencing tool to conduct the meeting.

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by user operation. The minutes are saved in text file or PDF format. The input data is the minutes file, which the server receives.

### Step 3:

The server analyzes the minutes and extracts important information.

The server receives the uploaded minutes and analyzes them using natural language processing (NLP) technology. Specifically, tools such as Python's NLTK library and SpaCy are used to extract important information from the minutes, such as “new technology is needed for new business development. The input data is the text of the minutes and the output data is the extracted critical information.

### Step 4:

The server creates and sends prompt statements to the generated AI model.

The server creates prompt sentences to be sent to the generative AI model based on the extracted information. For example, the server creates a prompt sentence “What new business can be developed by introducing new technology? The created prompt sentence is sent to the generative AI model via the API. The input data is the extracted information and the output data is the prompt sentence.

### Step 5:

Generative AI models generate new ideas.

The generative AI model (e.g., OpenAI's GPT-3) generates new ideas based on the prompt text received. The generated ideas are returned to the server in text format. The input data is the prompt sentence and the output data is the generated idea.

### Step 6:

The server sends the generated ideas to the terminal.

The server receives the ideas returned from the generated AI model and sends them to the terminal. Communication protocols such as HTTP requests and WebSockets are used for sending. The input data are the generated ideas and the output data are the ideas sent to the terminal.

### Step 7:

The terminal displays the ideas generated to the user.

The terminal displays the ideas received from the server to the user; the WebUI displays the generated ideas and the user can review them. The user can also provide feedback and ask to generate ideas again, if necessary. The input data are the ideas sent from the server and the output data are the ideas displayed to the user.

### Example of Application 3

Next, example 3 of application of example of implement 3 will be described. In the following description, the data processing device 12 will be referred to as the “server” and the smart glasses 214 will be referred to as the “terminal”.

Conventional brainstorming support systems have utilized minutes of meetings by inputting themes from users and linking with web conferencing tools, but they do not support the generation of ideas for specific manufacturing processes or efficiency improvements in the factory. Therefore, there is a need to generate ideas for new manufacturing processes and efficiency improvements based on the minutes of in-plant meetings.

The specific processing by specific processing unit 290 of data processing device 12 in example of application 3 is realized by the following means. In this invention, the server includes means for inputting themes from users, means for generating ideas and questions related to the themes, means for evaluating the generated ideas to support expansion, means for inputting information from the WebUI and linking with a web conferencing tool, and means for generating new manufacturing processes and efficiency ideas based on the information The system includes means to capture the minutes of meetings held in the factory and generate ideas for new manufacturing processes and efficiency improvements based on that information. This enables the generation of ideas for new manufacturing processes and efficiency improvements based on the minutes of meetings held in the factory.

The “user input method” is an interface that allows users to input discussion and idea generation themes to the system.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which users enter information into the system through the Web user interface.

The “means of linking with a web conferencing tool” is a means of linking a web conferencing tool with the system to capture meeting minutes and other information into the system.

The “means of capturing minutes of meetings held in the factory and generating ideas for new manufacturing processes and efficiency improvements based on that information” is a function for capturing the minutes of meetings held in the factory into the system and generating ideas for new manufacturing processes and efficiency improvements based on those minutes.

The system for implementing this invention includes means for inputting themes from users, generative AI, evaluation, input from the WebUI, integration with web conferencing tools, and means for capturing minutes of meetings held in the factory and generating ideas for new manufacturing processes and efficiency improvements based on that information.

The server provides an interface for the user to enter themes. Themes entered by the user are sent to the generative AI means to generate related ideas and questions. The generated ideas are evaluated by the user through the evaluation means, and the ideas are expanded or improved based on the evaluation results.

The input method from the WebUI is a means for users to enter information into the system through the web user interface. This allows users to easily input themes and evaluation results.

The means of linking with web conferencing tools is a means to link web conferencing tools with the system and to incorporate meeting minutes and other information into the system. For example, minutes are retrieved from a web conferencing tool such as Zoom, and a generative AI generates new ideas based on this information.

The means of capturing minutes of meetings held in a factory and generating ideas for new manufacturing processes and efficiency improvements based on that information is a function for capturing minutes of meetings held in a factory into the system and generating ideas for new manufacturing processes and efficiency improvements based on those minutes. This enables the generation of ideas for new manufacturing processes and efficiency improvements based on the minutes of meetings held in the factory.

As a concrete example, the following prompt sentences can be entered into a generative AI model

### Example of a Prompt Statement:

Minutes: Need to improve efficiency of production lines. In particular, bottlenecks in the assembly process are a problem. Please propose ideas to solve this problem by introducing new technologies and methods.

Based on this prompt sentence, a generative AI might generate the following ideas

1. promote automation of the assembly process by introducing a robot arm.

2. introduce an AI-based quality inspection system for early detection of defective products.

3. redesign the layout of the production line to improve work efficiency.

In this way, ideas for new manufacturing processes and efficiencies can be generated based on the minutes of meetings in the plant.

The flow of the identification process in example of application 3 is described in FIG. 16.

### Step 1:

The user enters a theme. Users enter discussion and idea generation themes through the web user interface. The entered themes are sent to the server. The input data is in text format, and the server receives it and passes it on to the next process.

### Step 2:

The server generates ideas and questions using generative AI methods. The server inputs the themes received in step 1 into the generative AI model and generates relevant ideas and questions. The generative AI model processes data based on the themes and outputs the relevant ideas and questions in text format.

### Step 3:

The server sends the generated ideas to the evaluation method. The server sends ideas and questions output from the generative AI model to the evaluation means. The evaluation means provides an interface for users to evaluate the ideas. Users evaluate ideas using evaluation buttons such as “original,” “realistic,” “review from a manager's point of view,” etc.

### Step 4:

The user evaluates the ideas. The user evaluates the generated ideas through the evaluation method. The evaluation results are sent to the server and used for the next process. The server receives the evaluation data in numerical or text format and passes it to the next process.

### Step 5:

The server extends or improves the idea based on the evaluation results. The server extends or improves ideas based on evaluation results received from users, using the generative

AI model again. The generative AI model uses the evaluation results as input data to extend or improve the idea.

### Step 6:

The server retrieves the meeting minutes using a means of interfacing with the web conferencing tool. The server retrieves the meeting minutes from the web conferencing tool (e.g., Zoom). The retrieved minutes are in text format, which the server passes on to the next process.

### Step 7:

The server inputs the minutes into the generative AI method to generate ideas for new manufacturing processes and efficiency improvements. The server inputs the acquired minutes into the generative AI model and generates ideas for new manufacturing processes and efficiency improvements based on the minutes. The generative AI model analyzes the contents of the minutes and outputs related ideas in text format.

### Step 8:

The server provides the generated ideas to the user. The server provides the user with ideas for new manufacturing processes and efficiencies output from the generative AI model.

The user reviews these ideas through a web user interface and provides evaluation and feedback as needed.

Further, an emotion engine that estimates the user's emotion may be combined. In other words, the specific processing unit 290 may use the emotion identification model 59 to estimate the user's emotion and perform specific processing using the user's emotion.

### Example of Implement 1

One exemplary embodiment of this invention is a brain streaming support system that includes an emotion engine that recognizes the user's emotions. The system receives thematic input from the user and generates ideas and questions related to that theme. The generated ideas are evaluated based on the user's emotions, and new ideas are generated based on the results. Specifically, if the user is exhibiting feelings of joy, positive ideas that are consistent with those feelings are generated. Conversely, if the user is expressing sadness, ideas are generated that suggest solutions that correspond to that emotion.

### Example of Implement 2

Another exemplary embodiment of the invention is a brain streaming support system in which an emotional engine adjusts the evaluation criteria of the evaluation method. In this system, the evaluation criteria are adjusted based on the user's emotions. Specifically, if the user is in an excited state, the evaluation criteria are set higher to match that emotion, making it easier for more challenging ideas to be evaluated. Conversely, when the user is calm, the evaluation criteria are set lower to match the user's emotions, and more realistic ideas are more likely to be evaluated.

### Example of Implement 3

Yet another exemplary embodiment of the invention is a brain streaming support system that utilizes information from the minutes of a web conferencing tool. In this system, new ideas are generated based on information from the minutes of a web conferencing tool. Specifically, the emotional engine analyzes the users' emotional information recorded in the minutes, and idea generation and evaluation are adjusted based on the results. For example, if “expectations for new business development” is recorded in the minutes, positive ideas that match the expectations are generated based on this information.

The following is a description of the process flow for each example of implement.

### Example of Implement 1

Step 1: Receive theme input from user.

Step 2: Generate ideas and questions related to the theme.

Step 3: The user's emotions are recognized by the emotion engine.

Step 4: Evaluate the ideas generated based on the recognized emotions.

Step 5: Generate new ideas based on evaluation results.

### Example of Implement 2

Step 1: Recognize the user's emotions with the emotion engine.

Step 2: Adjust the evaluation criteria of the evaluation instrument based on the recognized emotions.

Step 3: Evaluate ideas based on adjusted evaluation criteria.

Step 4: Generate new ideas based on evaluation results.

### Example of Implement 3

Step 1: Retrieve information from the minutes of the web conferencing tool.

Step 2: Generate new ideas based on the information obtained.

Step 3: The emotional engine analyzes the user's emotional information recorded in the minutes.

Step 4: Adjust idea generation and evaluation based on analysis results.

### Example 1

The following is an example of exemplary embodiment of implement. In the following description, the data processing device 12 will be referred to as the “server” and the smart glasses 214 will be referred to as the “terminal”.

Conventional brainstorming support systems generate ideas and questions without considering the user's emotions, making it difficult to provide appropriate ideas and questions according to the user's emotional state. In addition, user satisfaction may decrease because the evaluation of generated ideas and questions is not based on the user's emotions. Furthermore, there is a problem of inadequate integration with meeting tools and inability to utilize information from meeting minutes, which reduces the efficiency of brainstorming.

The specific processing by the specific processing unit 290 of the data processing device 12 in Example 1 is realized by the following means.

In this invention, the server includes theme input means from the user, generative AI means for generating ideas and questions related to the theme, evaluation means for supporting expansion on the generated ideas, emotion recognition means for recognizing the user's emotions, emotion recognition means for evaluating the ideas and questions based on the emotion information, and new means for generating ideas and questions, and means for interfacing with input means and meeting tools. This makes it possible to provide appropriate ideas and questions according to the user's emotional state and improve user satisfaction. In addition, the information from the minutes of the meeting tool can be used to improve the efficiency of brainstorming.

The “user input method” is an interface for users to input brainstorming themes.

A “generative AI means” is an artificial intelligence mechanism that generates relevant ideas and questions based on user input on a topic.

The “evaluation method” is a function that evaluates the ideas and questions generated and provides feedback to the user.

The “emotion recognition means” is a technology for recognizing the emotional state of a user by analyzing the user's facial expressions and tone of voice.

Means for evaluating ideas and questions based on emotional information and generating new ideas and questions” is a function for evaluating generated ideas and questions based on recognized user emotional information and generating further new ideas and questions.

An “input means” is an interface that allows users to enter information into the system.

The “means of linking with conferencing tools” is a function to link with conferencing tools to utilize information such as meeting minutes.

This invention is a brain streaming support system that generates relevant ideas and questions based on thematic input from the user, and evaluates and extends them according to the user's emotional state. An exemplary embodiment of this system is described below.

First, the user enters a theme in the input field on the terminal. For example, the user enters “new business development. The terminal sends this theme to the server. The server uses a generative AI model (e.g., a general natural language processing model) to generate ideas and questions related to the entered theme. The generated ideas and questions are, for example

### Sample Questions:

What is the market need for new business development?”

What resources do you need for new business development?”

### Example Ideas:

We will leverage our existing customer base for new business development.”

“For new business development, consider the introduction of new technologies.”

The generated ideas and questions are sent from the server to the terminal. The terminal recognizes the user's emotions using emotion recognition means (e.g., common emotion recognition software). The user's facial expressions and tone of voice are analyzed to determine the emotional state of the user. For example, if the user is smiling, the emotion of joy is recognized.

The terminal sends the recognized emotion information to the server. The server evaluates the generated ideas and questions based on the emotion information and generates new ideas and questions. For example, if the user is indicating an emotion of joy, it generates positive ideas that are consistent with that emotion. Conversely, if the user is indicating an emotion of sadness, it generates ideas that suggest solutions that correspond to that emotion.

Finally, the server sends the evaluated ideas and questions to the terminal, which displays them to the user. The user can use these ideas and questions as a reference for further brainstorming.

As a specific example, if a user enters the topic “new business development,” the generative AI model will generate the following questions and ideas

### Sample Questions:

What is the market need for new business development?”

What resources do you need for new business development?”

### Example Ideas:

We will leverage our existing customer base for new business development.”

“For new business development, consider the introduction of new technologies.”

Examples of prompt statements may include the following

Generate ideas for new business development.”

Generate questions about market needs in new business development.”

In this way, the server, terminal, and user work together to create a system that supports brainstorming.

The flow of the identification process in Example 1 is described in FIG. 17.

### Step 1:

The user enters a theme.

The user enters the theme in the input field on the terminal and clicks on the submit button. For example, enter “New Business Development”. The input data is the theme text.

### Step 2:

The terminal sends the theme to the server.

The terminal sends the input theme “New Business Development” to the server using an HTTP POST request. The input data is the theme text and the output data is the request to the server.

### Step 3:

The server generates relevant ideas and questions using a generative AI model.

The server inputs the received themes into the generative AI model and generates related ideas and questions. For example, questions such as “What are the market needs for new business development?” and “What resources are needed for new business development?” are generated, as well as ideas such as “For new business development, leverage existing customer base” and “For new business development, consider introducing new technology.

The input data is the theme text and the output data is a list of generated ideas and questions.

### Step 4:

Server-generated ideas and questions are sent to the terminal.

The server sends the generated ideas and questions to the terminal in JSON format. The input data is a list of generated ideas and questions, and the output data is the response to the terminal.

### Step 5:

The terminal recognizes the user's emotions using the emotion engine.

The terminal uses an emotion engine to analyze the user's facial expression and tone of voice to recognize the emotional state. For example, if the user is smiling, the emotion of joy is recognized. The input data is the user's facial expression and tone of voice, and the output data is the recognized emotion information.

### Step 6:

The terminal sends the recognized emotional information to the server.

The terminal sends the recognized emotion information to the server in JSON format. The input data is the recognized emotion information and the output data is the request to the server.

### Step 7:

The server evaluates ideas and questions based on emotional information and generates new ideas and questions.

The server evaluates the ideas and questions generated based on the emotional information received. For example, if the user indicates a feeling of joy, it generates positive ideas that are consistent with that feeling. Conversely, if the user indicates an emotion of sadness, ideas are generated that suggest solutions that correspond to that emotion. The input data is the emotion information and the list of generated ideas or questions, and the output data is the list of evaluated ideas or questions.

### Step 8:

The server sends the final ideas and questions to the terminal.

The server finally sends the evaluated ideas and questions to the terminal in JSON format. The input data is a list of evaluated ideas and questions, and the output data is the response to the terminal.

### Step 9:

The terminal displays the final idea or question to the user.

The terminal displays the final ideas and questions received to the user. The user can use these ideas and questions as a reference for further brainstorming. The input data is the list of ideas and questions evaluated, and the output data is what is displayed to the user.

### Example of Application 1

Next, example of application 1 of example of implement 1 will be described. In the following description, the data processing device 12 will be referred to as the “server” and the smart glasses 214 will be referred to as the “terminal.

Conventional brain-streaming support systems can generate a idea or question based on the user's thematic input, but they do not take into account the user's emotions in generating or evaluating ideas, making it difficult to provide appropriate ideas according to the user's emotions. In addition, the lack of concrete means to generate ideas for new production processes and efficiency improvements in the factory makes the system less practical in the field.

The specific processing by specific processing unit 290 of data processing device 12 in example of application 1 is realized by the following means. In this invention, the server has the following means: theme input means from the user, generative AI means to generate ideas and questions related to the theme, evaluation means to support expansion on the generated ideas, input means from the WebUI and means to link with a web conferencing tool, emotion recognition means to recognize the user's emotions means, means to evaluate ideas generated based on emotions and generate new ideas, and means installed in the robot to generate ideas for new production processes and efficiencies in the factory. This makes it possible to provide appropriate ideas based on the user's emotions, thereby increasing their utility within the factory.

The “user input method” is an interface that allows users to enter a specific theme or topic.

Generative AI means” is an artificial intelligence function that generates relevant ideas and questions based on a theme entered by the user.

The “evaluation means” is a function for extending and evaluating the ideas generated.

The “means of input from the WebUI” is the means by which the user provides input through the web user interface.

The “means of linking with web conferencing tools” is a means of linking with web conferencing tools to share information or to use information from the minutes.

The “emotion recognition means” is a function to recognize the user's emotions.

The “means for evaluating ideas generated based on emotions and generating new ideas” is a function for evaluating ideas generated based on user emotions and generating new ideas based on the results.

The “means installed in a robot to generate ideas for new production processes and efficiencies in a factory” is a function installed in a robot to generate ideas for new production processes and efficiencies in a factory.

The system for implementing this invention includes theme input means from the user, generative AI means, evaluation means, input means from the WebUI, means for integration with web conferencing tools, emotion recognition means, means for evaluating ideas generated based on emotions and generating new ideas, means installed in a robot to generate new production processes in a factory and efficiency improvement ideas in the factory.

### Explanation of Program Processing

The server provides an interface for receiving theme input from users. When a user enters a theme, the server uses generative AI methods to generate ideas and questions related to that theme. The generative AI method uses a generative AI model such as the OpenAI API to generate relevant ideas and questions based on the input theme.

The generated ideas are extended and evaluated by the evaluation means. The evaluation means provides evaluation buttons, such as “original,” “realistic,” “review from a manager's point of view,” etc., allowing users to evaluate the generated ideas.

In addition, the emotion recognition means is used to recognize the user's emotions. The emotion recognition means uses the Emotion Recognition library and camera to analyze the user's emotions. Based on the recognized emotion, the means evaluates the generated ideas and generates new ideas. For example, if the user indicates an emotion of joy, a positive idea is added.

This includes means installed on robots to generate ideas for new production processes and efficiencies within the factory. The robot patrols the factory, receives thematic input from workers, and generates relevant ideas and questions using generative AI means. The generated ideas are evaluated based on the worker's emotions and new ideas are added as needed.

### Concrete Example

For example, if a user enters the topic “Improving the efficiency of a new production line,” the generative AI method will generate the following ideas and questions.

Example of a prompt statement: “I am a member of the

Topic: New production line efficiency

Generate relevant ideas and questions.

Generated ideas and questions:

Where are the bottlenecks in the production line?

What technologies are needed to promote automation?

How can we reduce the burden on workers?

Add positive ideas.

A new robot arm was introduced to improve work efficiency.

Motivate workers to take more breaks.

In this way, appropriate ideas can be provided according to the user's emotional state, thus increasing their practicality in the factory.

The flow of the identification process in Example of Application 1 is described in FIG. 18.

### Step 1:

The user enters a theme. The user enters the theme through the web user interface (WebUI). The entered theme is sent to the server. The input data is the textual information of the theme.

### Step 2:

The server receives the input themes and passes them to the generative AI means. The generative AI means generates ideas and questions related to the theme using a generative AI model such as OpenAI API. The input data is textual information of the theme and the output data is textual information of the generated ideas and questions.

### Step 3:

The server passes the generated ideas and questions to the evaluation means. The evaluation means provides evaluation buttons such as “original,” “realistic,” “review from a manager's point of view,” etc., to allow users to evaluate the generated ideas. The input data is the textual information of the generated ideas and questions, and the output data is the results of the user's evaluation.

### Step 4:

The server uses emotion recognition methods to recognize the user's emotions. The emotion recognition means uses the Emotion Recognition library and camera to analyze the user's emotions. The input data is the user's facial image and voice data, and the output data is information about the recognized emotion.

### Step 5:

The server evaluates the ideas generated based on the recognized emotions and uses the means to generate new ideas. For example, if the user indicates an emotion of joy, positive ideas are added. The input data is the information of the recognized emotion and the textual information of the generated ideas and questions, and the output data is the textual information of the new ideas evaluated based on the emotion.

### Step 6:

The server uses means installed on robots to generate ideas for new production processes and efficiencies within the factory. The robot patrols the factory, receives theme input from workers, and uses generative AI means to generate related ideas and questions. The input data is the textual information of the themes from the workers and the output data is the textual information of the generated ideas and questions.

### Step 7:

The server presents the generated ideas and questions to the workers. The workers can consider new production processes and ways to improve efficiency based on the ideas and questions presented. The input data is textual information of the generated ideas and questions, and the output data is feedback and new suggestions by the workers.

### Example 2

Next, example 2 of exemplary embodiment of implement will be described. In the following description, data processing device 12 will be referred to as the “server” and smart glasses 214 will be referred to as the “terminal.

In conventional brain-streaming support systems, it was difficult to provide appropriate feedback and expansion to user-generated ideas, and the quality and creativity of ideas were not sufficiently enhanced. In addition, because evaluation criteria were set without considering the user's emotional state, there was also the problem that ideas were not evaluated appropriately according to the user's state. Furthermore, there was insufficient linkage with web conferencing tools, making it difficult to effectively utilize the ideas and minutes generated during meetings.

The specific processing unit 290 of the data processing device 12 in Example 2 is realized by the following means.

In this invention, the server has a means for inputting a theme from the user, a generative AI means for generating ideas and questions related to the theme, an evaluation means for supporting expansion on the generated ideas, a means for generating prompt text based on the type of evaluation button, a means for sending the generated prompt text to the generative AI means, a means for displaying the new ideas returned from the generative AI means to the user, an emotion engine means for analyzing the user's emotional state, and a means for adjusting the evaluation criteria based on the analysis results of the emotion engine means. means, a means for displaying the new ideas returned by the generative AI means to the user, an emotion engine means for analyzing the user's emotional state, a means for adjusting the evaluation criteria based on the analysis results of the emotion engine means, and a means for input from the WebUI and for linking with a web conferencing tool. The system includes. This enables the setting of appropriate evaluation criteria according to the user's emotional state and the generation and expansion of high-quality ideas by the generative AI. In addition, the linkage with the Web conferencing tool enables effective use of ideas and minutes generated during the meeting.

The “means of theme input from users” is an interface for users to input themes, such as new business development, into the system.

Generative AI means” is an artificial intelligence function that generates relevant ideas and questions based on a theme entered by the user.

The “evaluation method” is a function that allows users to evaluate the ideas generated and helps them expand on those ideas based on their evaluation.

The “Evaluation Buttons” are buttons that allow for “creative,” “realistic,” and “management's point of view review.”

The “means of generating prompt sentences” is a function that generates prompt sentences to be sent to the generative AI means based on the type of evaluation button pressed by the user.

The “means of transmitting to the generative AI means” is a function for transmitting the generated prompt sentences to the generative AI means.

The “means for displaying new ideas returned by the generative AI means to the user” is a function that receives new ideas returned by the generative AI means and displays them on the user's terminal.

The “emotion engine means” is a function for analyzing the user's emotional state.

The “means to adjust evaluation criteria” is a function that adjusts the evaluation criteria based on the analysis results of the emotion engine means.

The “means of input from the WebUI” is the ability for users to enter the system through the Web interface.

The “means of linking with web conferencing tools” is a function to link with web conferencing tools to capture ideas and minutes from meetings in the system.

This invention is a system in which a user inputs a theme, such as new business development, and a generative AI method is used to generate ideas and questions related to that theme, and to support expansion on the generated ideas. An exemplary embodiment of this system is described below.

### Hardware and Software Used

Server: Performs the core processing of this system. It executes the AI generation model, stores data, and provides the user interface.

Terminal: A device operated by a user, such as a PC or a smart device.

Generative AI models: Use generative AI models such as OpenAI's GPT-4.

Emotion Engine: Software to analyze the user's emotional state. For example, using Microsoft's Azure Cognitive Services emotion recognition API.

### System Process Flow

1. the user enters an idea

The user uses a terminal to enter ideas for new business development into the system's input form. For example, the user would enter, “For new business development, consider introducing new technology.

2. the user presses the “Rate” button

The user presses one of the rating buttons, such as “original,” “realistic,” or “review from a manager's point of view,” for the ideas entered by the user.

3. the server generates prompt statements

The server generates prompt sentences to be sent to the generative AI model based on the type of evaluation button pressed by the user. For example, if the button “Originally” is pressed, the server will generate the prompt sentence “What creative business will be possible with the introduction of new technology?”.

4. the server sends prompt statements to the generated AI model

The server sends the generated prompt sentences to the generative AI model. The generative AI model is running in the cloud.

5. generation AI model generates new ideas

The generative AI model generates new ideas based on the prompt sentence. For example, it generates ideas such as “New technologies will enable personalized marketing using AI.

6. display server-generated ideas to users

The server receives the new ideas returned from the generative AI model and displays them on the user's terminal.

7. an emotional engine analyzes the user's emotions (another exemplary embodiment)

While the user is inputting ideas, the emotion engine analyzes the user's facial expressions and voice to determine whether the user is in an excited or calm state.

8. the server adjusts the evaluation criteria (another exemplary embodiment)

The server receives the results of the emotion engine analysis and sets the evaluation criteria higher when the user is in an excited state, making it easier to evaluate challenging ideas. Conversely, if the user is in a calm state, the evaluation criteria are set lower, making it easier to evaluate realistic ideas.

### Concrete Example

### Example 1: Expansion of Ideas

User's operation: User enters the idea “For new business development, consider introducing new technologies” and presses the “Originally” rating button.

Server processing: The server sends a prompt statement to the generative AI model, “What creative business will be possible with the introduction of new technology?

Generative AI Model Response: The Generative AI Model generates new ideas such as “New technologies will enable personalized marketing using AI.

Display of results: The server displays the generated ideas on the user's terminal.

### Example 2: Using the Emotion Engine

User manipulation: the user inputs the idea “For new business development, consider introducing new technologies” and the emotion engine detects the user's state of excitement.

Server processing: The server sets the evaluation criteria high based on the analysis results of the emotion engine and sends a prompt statement to the generative AI model: “What challenging projects would be possible through the introduction of new technologies?

Generative AI Model Response: The generative AI model generates challenging ideas such as “The introduction of new technologies will allow us to build a fully automated smart city.

Display of results: The server displays the generated ideas on the user's terminal.

### Example of Prompt Text

What kind of creative projects will be possible through the introduction of new technologies?”

What realistic business opportunities will be made possible by the introduction of new technologies?”

What are the benefits, from a management perspective, of implementing new technologies?”

These are the exemplary embodiments of this system.

The flow of the identification process in Example 2 is described in FIG. 19.

### Step 1:

The user enters an idea.

The user opens a browser on his/her terminal and accesses the system's web page. In the input form, the user enters the following information: “For new business development, consider the introduction of new technologies. The entered data is sent from the terminal to the server.

Input: Idea entered by user

Output: Idea data sent to server

### Step 2:

The user presses the “Evaluate” button.

The user clicks one of the evaluation buttons, such as “original,” “realistic,” or “review from a manager's perspective. When the button is clicked, the information is sent from the terminal to the server.

Input: Information about the rating button pressed by the user

Output: Information on evaluation buttons sent to the server

### Step 3:

The server generates a prompt statement.

Based on the information of the evaluation buttons received by the server, it generates prompt sentences to be sent to the generative AI model. For example, if the button “Originally” is pressed, the prompt sentence “What kind of original business will be possible through the introduction of new technology?

Input: Rating button information

Output: Generated prompt statements

### Step 4:

The server sends prompt statements to the generated AI model.

The server sends the generated prompt sentences to the generative AI model. The generative AI model is running in the cloud.

Input: Generated prompt text

Output: Prompt statements sent to the generated AI model

### Step 5:

Generative AI models generate new ideas.

The generative AI model analyzes the prompt sentence and generates new ideas. For example, it generates ideas such as “New technologies will enable personalized marketing using AI. The generated ideas are returned to the server.

Input: Prompt statement

Output: New ideas generated

### Step 6:

The server displays the generated ideas to the user.

The server receives the new ideas returned from the generative AI model and sends them to the user's terminal. The user's terminal displays the new idea on the screen.

Input: new ideas generated

Output: Idea displayed on user's terminal

### Step 7:

The emotion engine analyzes the user's emotions (another exemplary embodiment).

While the user is inputting ideas, the emotion engine analyzes the user's facial expressions and voice to determine whether the user is in an excited or calm state. The analysis results are sent to the server.

Input: user's facial expressions and voice data

Output: Results of analysis by the emotion engine

### Step 8:

The server adjusts the evaluation criteria (another exemplary embodiment).

When the server receives the results of the emotion engine analysis and the user is in an excited state, it sets the evaluation criteria higher, making it easier for challenging ideas to be evaluated. Conversely, if the user is in a calm state, the evaluation criteria are set lower, making it easier to evaluate realistic ideas.

Input: Emotion engine analysis results

Output: Adjusted evaluation criteria

### Example of Application 2

Next, example of application 2 of example of implement 2 will be described. In the following description, the data processing device 12 will be referred to as the “server” and the smart glasses 214 will be referred to as the “terminal.

Conventional brainstorming support systems evaluate ideas without considering the user's emotional state, making it difficult to generate appropriate ideas according to the user's emotions. In addition, since the system was not designed for use on portable devices such as smartphones, users could not easily generate ideas anywhere.

The specific processing by the specific processing unit 290 of the data processing device 12 in example of application 2 is realized by the following means.

In this invention, the server includes theme input means from the user, generative AI means to generate ideas and questions related to the theme, and evaluation means to support expansion on the generated ideas. This makes it possible to detect the user's emotional state and adjust the evaluation criteria accordingly. Also, by including application means that are installed on a smartphone, users can easily perform idea generation anywhere.

The “Theme Input Method” is an interface for users to input brainstorming themes or topics.

Generative AI means” is an artificial intelligence function that automatically generates ideas and questions related to the input theme.

The “evaluation method” is a function that allows users to evaluate the ideas generated and helps them expand on those ideas based on their evaluation.

The “means of input from the WebUI” is the means by which a user inputs information through the Web user interface.

The “means of linking with web conferencing tools” is a means of linking with web conferencing tools to share information and utilize data such as meeting minutes.

The “emotion engine means” is a function that detects the user's emotional state and adjusts the system's behavior based on that information.

The “means of adjusting evaluation criteria” is a function that dynamically changes the criteria for evaluating ideas based on the user's emotional state.

An “application means installed on a smartphone” is a function of an application that is installed on a smartphone and can be used by users anywhere.

As an exemplary embodiment of this invention, the following system can be constructed.

First, the user enters a brainstorming theme using an application installed on his/her smartphone. The theme input method receives the theme entered by the user and sends it to the server.

The server uses generative AI means to generate ideas and questions related to the input theme. This generative AI method can use a generative AI model such as GPT-3, for example. The generated ideas are displayed on the user's smartphone.

The user then presses a rating button for the displayed idea, such as “original,” “realistic,” “review from a manager's perspective,” etc. The evaluation method receives the user's rating and assists in expanding the idea accordingly.

In addition, the emotion engine means detects the user's emotional state. The emotion engine means can use an emotion detection library such as Affectiva, for example. Based on the emotional state, the means for adjusting the evaluation criteria operates to set the appropriate evaluation criteria according to the user's emotion.

The system also includes a means of input from the WebUI and a means of interfacing with web conferencing tools, which can extract information from meeting minutes and use it for idea generation.

As a concrete example, if a user inputs the theme “For new business development, consider introducing new technologies,” the generative AI method can generate the following prompt sentence.

Example of a prompt statement: “I am a member of the

I'm thinking about introducing new technology for new business development. What technologies should we introduce as an original approach?”

Based on this prompt statement, the generative AI model generates new ideas and provides them to the user. When the user presses the “Originally” rating button, the generative

AI means generates a new idea, such as “What creative business can be made possible by the introduction of new technology?

In this way, a system in which the generative AI provides new ideas based on the user's emotional state and evaluation criteria is realized.

The flow of the identification process in example of application 2 is described in FIG. 20.

### Step 1:

Users launch the application installed on their smartphones and enter a brainstorming theme.

Input: Theme entered by user (e.g., “For new business development, consider introducing new technologies”)

Output: The input theme is sent to the server.

Specific action: The user enters a theme in the application's input field and presses the “Submit” button.

### Step 2:

The server uses generative AI methods to generate ideas and questions related to the input theme.

Input: User entered theme

Outputs: generated ideas or questions (e.g., “What creative projects could be made possible by the introduction of new technologies?”)

Specific behavior: The server prompts a GPT-3 or other generative AI model for a theme and retrieves the generated ideas.

### Step 3:

The generated ideas are displayed on the user's smartphone.

Input: generated ideas and questions

Output: Ideas and questions displayed on the smart phone screen

Specific behavior: The server sends the generated idea to the smartphone and the application displays it.

### Step 4:

The user presses a rating button for the ideas displayed, such as “original,” “realistic,” or “review from a manager's point of view.

Input: User's rating (e.g., “creatively”)

Output: The evaluation results are sent to the server.

Specific action: The user selects the “Rate” button and presses the “Submit” button.

### Step 5:

The server uses the emotion engine means to detect the user's emotional state.

Input: emotional data of the user (e.g., input from camera or microphone)

Output: Detected emotional state (e.g., “excited”)

Specific behavior: The server analyzes the user's emotional state using an emotion detection library such as Affectiva.

### Step 6:

The means of adjusting the evaluation criteria based on the emotional state operates.

Input: Detected emotional state

Output: Adjusted evaluation criteria (e.g., “creatively”)

Specific behavior: The server reconfigures the evaluation criteria according to the emotional state.

### Step 7:

The server generates new ideas based on evaluation criteria.

Input: adjusted evaluation criteria, initial ideas

Outputs: new ideas (e.g., “What creative projects could be made possible by the introduction of new technologies?”)

Specific behavior: The server again prompts the generative AI model to generate new ideas.

### Step 8:

New ideas are displayed on the user's smartphone.

Input: Newly generated ideas

Output: new ideas displayed on smartphone screens

Specific behavior: The server sends new ideas to the smartphone and the application displays them.

### Example 3

Next, example 3 of exemplary embodiment of implement will be described. In the following description, the data processing device 12 will be referred to as the “server” and the smart glasses 214 will be referred to as the “terminal”.

Conventional brain-streaming support systems mainly generate ideas based on input information from the user, and could not utilize the minutes data from web conferencing tools. As a result, important information and ideas discussed during meetings were not fully utilized, making efficient idea generation difficult. In addition, there was insufficient support for evaluation and expansion of generated ideas, making it difficult for users to effectively utilize the generated ideas.

The specific processing by the specific processing unit 290 of the data processing device 12 in Example 3 is realized by the following means. In this invention, the server has a means for inputting themes from users, a means for generating ideas and questions related to the themes, a means for evaluating the generated ideas to support expansion, a means for input from the WebUI and a means for linking with a web conferencing tool, a means for acquiring minutes data from the web conferencing tool means to acquire the minutes data from the web conferencing tool, means to analyze the acquired minutes data and extract important information, means to generate and send prompt sentences to the generative AI model based on the extracted information, and means to store the generated ideas. This makes it possible to efficiently generate new ideas using the minutes data from the web conferencing tool, and to support evaluation and expansion on the generated ideas.

The “user's means of subject input” is an interface that allows users to enter information about a particular subject or topic.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link the system with web conferencing tools to obtain and utilize information during a meeting.

The “means to retrieve meeting minutes data from a web conferencing tool” is a function to automatically retrieve meeting minutes data from a web conferencing tool.

Means to analyze acquired minutes data and extract important information” is a function to analyze acquired minutes data and extract important information discussed during the meeting.

The “means for generating and sending prompt sentences to the generative AI model based on the extracted information” is a function for generating and sending prompt sentences to the generative AI model based on the extracted information.

The “means of storing generated ideas” is a function for storing ideas generated from the generative AI model in a database or other location.

This invention is a system including means for inputting themes from users, generative AI means, evaluation means, input means from the WebUI, means for linking with a web conferencing tool, means for acquiring minutes data from the web conferencing tool, means for analyzing the acquired minutes data and extracting important information, means for generating prompt statements based on the extracted information to a generative AI model The system includes a means to generate and send prompt sentences to a generative AI model based on the extracted information, and a means to store the generated ideas.

### Server Operation

The server first acquires the minutes data from the web conferencing tool (e.g., a common web conferencing tool). The API of the web conferencing tool is used for this acquisition. The acquired minutes data are analyzed using a natural language processing library (e.g., NLTK or SpaCy). As a result of the analysis, important keywords and phrases are extracted.

Next, the server generates prompt sentences to be sent to the generative AI model (e.g., OpenAI's GPT-3) based on the extracted information. For example, if the minutes contain the information “New business development requires the introduction of new technologies,” the server generates the prompt sentence “What new businesses can be developed through the introduction of new technologies?

The generated prompt sentences are sent to the generative AI model to generate new ideas. The generated ideas are stored in a database by the server. The stored ideas are later provided to users.

### Terminal Operation

The terminal sends information entered by the user through the WebUI to the server. For example, the user enters specific questions or requests regarding new business development. The terminal also receives the ideas generated by the server and displays them to the user. The user can provide further feedback based on the displayed ideas, which are also sent from the terminal to the server.

### User Behavior

Users enter information about new business development through the WebUI. For example, the user enters a specific question such as, “We are seeking ideas regarding the introduction of new technology. The user also uses a web conferencing tool to conduct a meeting, and the minutes of that meeting are captured by the system. The user reviews the ideas generated and provides feedback as needed.

### Concrete Example

1. minutes of the meeting: “New business development requires the introduction of new technologies.”

2. prompt statement for the generated AI model: “What new businesses can be developed by introducing new technologies?

A generative AI model might generate the following ideas based on this prompt sentence.

Developing an AI-based customer support system.” “Building a Supply Chain Management System Using Blockchain Technology.”

Thus, the system utilizes the minutes data of the web conferencing tool to generate new ideas using a generative AI model. This allows users to efficiently obtain new business ideas. The flow of the identification process in Example 3 is described in FIG. 21.

### Step 1:

The server obtains the meeting minutes data from the web conferencing tool. Specifically, it downloads the meeting minutes data using the API of the Web conferencing tool. The input is authentication information such as meeting ID and API key, and the output is the acquired minutes data.

### Step 2:

The server analyzes the acquired minutes data. Specifically, text analysis is performed using a natural language processing library (e.g., NLTK or SpaCy). The input is the minutes data, and the output is the extracted important keywords and phrases.

### Step 3:

The server generates prompt sentences to be sent to the generative AI model based on the analysis results. For example, if the information includes “New business development requires the introduction of new technology,” the server generates the prompt sentence “What kind of new business can be developed by introducing new technology? The input is the extracted keywords or phrases and the output is the generated prompt sentence.

### Step 4:

The server sends the generated prompt text to the generative AI model. Specifically, it sends an API request to the generative AI model (e.g., OpenAI's GPT-3). The input is the prompt sentence and the output is the generated idea.

### Step 5:

The server stores the ideas returned from the generative AI model in a database. Specifically, it executes an INSERT query against the database. The input is the generated ideas and the output is the confirmation information of the stored ideas.

### Step 6:

The terminal sends the information entered by the user through the WebUI to the server. Specifically, the user enters information into the input form and presses the submit button. The input is the information entered by the user and the output is the information sent to the server.

### Step 7:

The terminal receives the ideas generated by the server and displays them to the user. Specifically, it receives the response from the server and displays it in the WebUI. The input is the ideas received from the server and the output is the ideas displayed to the user.

### Step 8:

The terminal sends the feedback provided by the user to the server. Specifically, the user enters information into the feedback form and presses the submit button. The input is the feedback entered by the user and the output is the feedback sent to the server.

### Step 9:

Users enter information about new business development through the WebUI. Specifically, the user enters information in the input form and presses the submit button. The input is the information entered by the user and the output is the information sent to the terminal.

### Step 10:

The user uses a web conferencing tool to conduct a meeting. Specifically, the meeting is initiated and the minutes are automatically recorded. The input is the audio and text of the meeting, and the output is the recorded minutes data.

### Step 11:

The user reviews the generated ideas displayed on the terminal and provides feedback. Specifically, the user evaluates the displayed ideas, enters information in the feedback form, and presses the submit button. The input is the displayed ideas and user feedback, and the output is the feedback sent to the terminal.

### Example of Application 3

Next, example 3 of application of example of implement 3 will be described. In the following description, the data processing device 12 will be referred to as the “server” and the smart glasses 214 will be referred to as the “terminal”.

In conventional brain-streaming support systems, themes are input by the user and ideas are generated by a generative AI, but the quality and realism of the ideas generated are limited because the system does not fully utilize the content of the discussions at the meeting and the emotional information of the participants. In addition, the evaluation of generated ideas and suggestions tend to be subjective, making it difficult to efficiently select the most useful ideas.

The specific processing by specific processing unit 290 of data processing device 12 in example of application 3 is realized by the following means. In this invention, the server has a means of inputting themes from users, a means of generating ideas and questions related to the themes, a means of evaluating the generated ideas to support expansion, a means of input from the WebUI and a means of linking with web conferencing tools, a means of analyzing the content of the minutes and extracting keywords and emotional information, an idea generation means to generate new ideas based on the extracted information, and an evaluation and suggestion means to evaluate the generated ideas and suggest the most useful ideas. This enables the generation of high-quality, realistic ideas based on the content of the discussions in the meeting and the emotional information of the participants, as well as efficient evaluation and suggestion of ideas.

The “user input method” is an interface that allows users to input discussion and idea generation themes to the system.

Generative AI means” is an artificial intelligence function that generates relevant ideas and questions based on input themes.

The “evaluation means” is a function for extending and evaluating the ideas generated.

The “means of input from the WebUI” is the means by which input is received from the user through the web user interface.

The “means of interfacing with web conferencing tools” is the means of interfacing the system with web conferencing tools to capture meeting minutes and other information.

The “analysis method for analyzing the content of minutes” is a function for analyzing the content of minutes imported from a web conferencing tool and extracting important keywords and emotional information.

The “idea generation means” is a function to generate new ideas based on the information extracted by the analysis means.

The “evaluation and suggestion means” is a function to evaluate the generated ideas and suggest the most useful ideas.

The following system configuration is an exemplary embodiment of this invention.

### System Configuration

The system includes means for inputting themes from users, generative AI means, evaluation means, input from WebUI means, means for linking with web conferencing tools, analysis means for analyzing the content of the proceedings, idea generation means, and evaluation suggestions means.

### Program Processing

The server will perform the following

1. means of user input on the theme: 1.

Provide an interface for users to enter discussion and idea generation topics for the system. For example, use a form that runs on a web browser.

2. generative AI measures: (1)

Generate relevant ideas and questions based on the input theme. Generative AI models such as OpenAI's GPT-3 are used here.

3. evaluation instruments:

Extensions and evaluations are performed on the generated ideas. Evaluation is done using evaluation buttons such as “original,” “realistic,” “review from a manager's perspective,” etc.

4. means of input from WebUI:

Receive input from the user through the web user interface. For example, a rating is entered by a user clicking on the rating button.

5. means of interfacing with web conferencing tools:

Integrate the system with a web conferencing tool (e.g., Zoom) to capture meeting minutes and other information; use the API to automatically retrieve meeting minutes.

6. analytical means for analyzing the content of the minutes:

Analyze the content of minutes imported from web conferencing tools to extract important keywords and emotional information. Here, natural language processing libraries such as TextBlob are used.

7. idea generation tools

Generate new ideas based on the information extracted by the analysis method. Generate prompt sentences and generate ideas using a generative AI model.

8. proposed means of evaluation

Evaluate the generated ideas and suggest the most useful ideas. Based on the evaluation results, present the highest rated ideas to the user.

### Concrete Example

For example, if the minutes of a Zoom meeting state that “a new robot arm needs to be installed”, the analysis method will extract this information and send the following prompt statement to the generative AI model.

Example of a prompt statement: “I am a member of the

Key words in the proceedings: new robot arm, introduction, production efficiency

Emotional information: Positive

Use this information to generate ideas for new manufacturing techniques and production line improvements.

The generative AI model generates ideas about “how the new robot arm will improve production efficiency” based on this prompt sentence. The generated ideas are evaluated by the evaluation method, and the most useful ideas are suggested to the user.

In this way, high-quality, realistic ideas can be generated based on the content of the meeting discussions and the emotional information of the participants, and ideas can be efficiently evaluated and proposed.

The flow of the identification process in example of application 3 is described in FIG. 22.

### Step 1:

The user enters a theme. The user uses a form on a web browser to enter a discussion or idea generation theme. The entered themes are sent to the server and stored in the database.

### Step 2:

The server generates ideas using generative AI methods. The server sends prompt statements to a generative AI model (e.g., OpenAI's GPT-3) based on the stored themes to generate related ideas and questions. The generated ideas are returned to the server and stored in a database.

### Step 3:

The server provides the means of evaluation. Users review the generated ideas through the web UI and enter their evaluation by clicking on the evaluation buttons such as “original,” “realistic,” “review from management's point of view,” etc. The evaluation results are sent to the server and stored in a database.

### Step 4:

The server uses a means of interfacing with the web conferencing tool to capture the minutes of the meeting. The server automatically retrieves the meeting minutes using the API of the web conferencing tool (e.g., Zoom). The retrieved minutes are stored on the server.

### Step 5:

The server analyzes the content of the minutes. The server analyzes the stored minutes and extracts important keywords and emotional information using a natural language processing library such as TextBlob. The extracted information is stored on the server.

### Step 6:

The server generates new ideas using idea generation methods. The server sends prompt sentences to the generative AI model based on the extracted keywords and emotional information to generate new ideas. The generated ideas are returned to the server and stored in the database.

### Step 7:

The server evaluates and suggests ideas using the evaluation and suggestion method. The server evaluates the generated ideas and suggests the most useful ideas to the user. Based on the evaluation results, the highest rated idea is presented to the user.

The specific processing unit 290 sends the results of the specific processing to the smart glasses 214. In smart glasses 214, control unit 46A causes speaker 240 to output the results of the specific processing. Microphone 238 acquires audio indicating user input to the results of the specific processing. The control unit 46A transmits the voice data indicating the user input acquired by the microphone 238 to the data processing device 12. In the data processing device 12, the specific processing unit 290 acquires the voice data.

The data generation model 58 is a so-called Generative AI (Artificial Intelligence). An example of a data generation model 58 is a generative AI such as ChatGPT (Internet Search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the smart glasses 214.

### Third Exemplary Embodiment

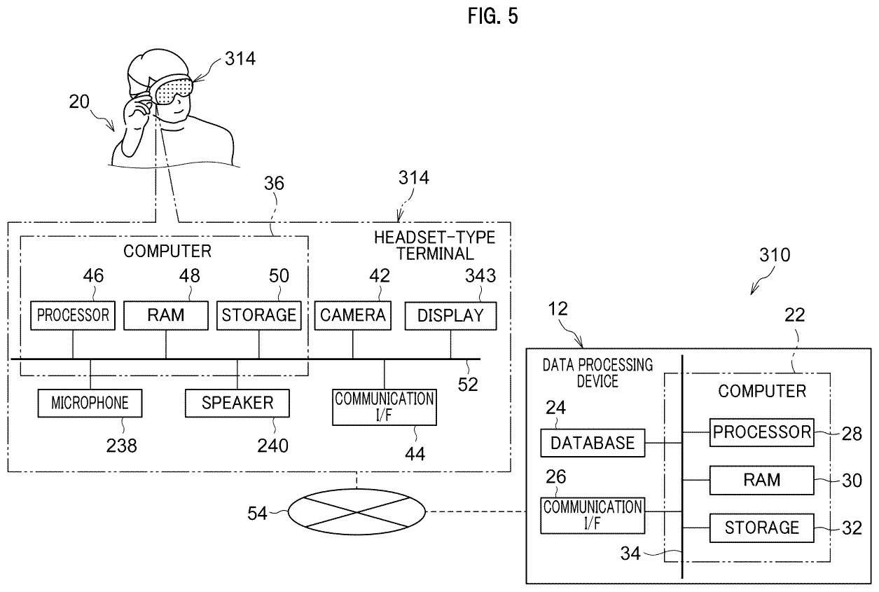

FIG. 5 shows an example of implement of a data processing system 310 for the third exemplary embodiment.

As shown in FIG. 5, data processing system 310 has data processing device 12 and headset-type terminal 314. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to the network 54. An example of a network 54 is a Wide Area Network (WAN) and/or a Local Area Network (LAN).

The headset-type terminal 314 has a computer 36, microphone 238, speaker 240, camera 42, communication I/F 44, and display 343. The computer 36 has a processor 46, RAM 48, and storage 50. Processor 46, RAM 48, and storage 50 are connected to bus 52. The microphone 238, speaker 240, camera 42, and display 343 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and images the surroundings of the user 20 (for example, the imaging range defined by an angle of view equivalent to the field of view of an average healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

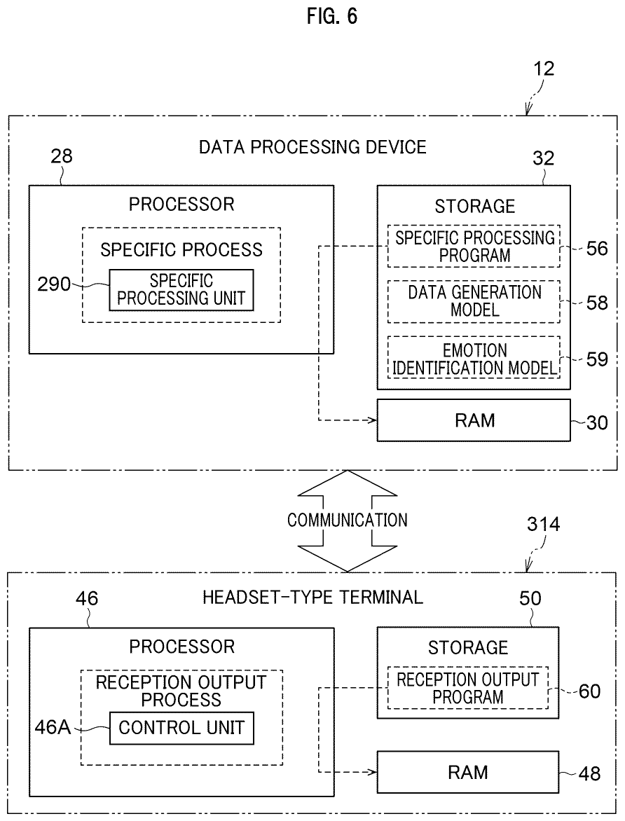

FIG. 6 shows an example of the key functions of data processing device 12 and headset-type terminal 314. As shown in FIG. 6, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

At the headset-type terminal 314, the reception output process is performed by processor 46. The reception output program 60 is stored in the storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48.

Next, the specific processing by the specific processing unit 290 of the data processing device 12 is described.

### Example of Implement 1

The brain streaming support system uses a generative AI to generate relevant ideas and questions based on the user's theme input. Specifically, if the user inputs “new business development” as a theme, the generative AI generates questions such as “What are the market needs for new business development?” and “What resources are needed for new business development?” and ideas such as “For new business development, utilize the existing customer base” and “For new business development, consider introducing new technology. Generate ideas such as.

### Example of Implement 2

For generated ideas, the system provides evaluation buttons such as “original,” “realistic,” “review from a manager's point of view,” etc., to support the expansion of ideas. Specifically, if a user presses the “original” evaluation button for the generated idea, “Consider introducing new technologies to develop new businesses,” the generative AI generates a new idea such as “What kind of original business will be possible by introducing new technologies?

### Example of Implement 3

The system will utilize not only input from the WebUI, but also information from the minutes of the meeting in conjunction with the web conferencing tool. Specifically, the system takes the minutes of a meeting held with a web conferencing tool such as Zoom, and the generative AI generates new ideas based on the information contained in the minutes. For example, if the minutes include the information that “introduction of new technology is necessary for new business development,” the generative AI generates new ideas based on this information, such as “What kind of new business can be developed by introducing new technology?

The following is a description of the process flow for each example of implement.

### Example of Implement 1

Step 1: The user accesses the Brainstorming Support System WebUI and enters “New Business Development” as the theme.

Step 2: The system's generative AI receives thematic input from the user and generates relevant ideas and questions. Specifically, the system generates questions such as “What are the market needs for new business development?” and “What resources are needed for new business development?” as well as ideas such as “For new business development, utilize the existing customer base” and “For new business development, consider introducing new technologies”.

Step 3: Present the generated ideas and questions to the user. The user can add his/her own thoughts and evaluate the ideas presented.

### Example of Implement 2

Step 1: The user presses the “Originally” rating button for the generated idea “For new business development, consider introducing new technologies.

Step 2: The system's generative AI receives evaluation input from the user and generates new ideas based on the evaluation. Specifically, the system generates new ideas such as “What kind of creative business will be possible through the introduction of new technologies?

Step 3: Present the generated new ideas to the user. The user can add his/her own thoughts and evaluate the ideas presented.

### Example of Implement 3

Step 1: The user conducts a meeting using a web conferencing tool such as Zoom, and the minutes of the meeting are imported into the system.

Step 2: The system's generative AI analyzes information from the minutes and generates new ideas based on this information. For example, if the minutes include the information that “introduction of new technology is necessary for new business development,” the generative AI generates new ideas based on this information, such as “What kind of new business can be developed by introducing new technology?

Step 3: Present the generated new ideas to the user. The user can add his/her own thoughts and evaluate the ideas presented.

### Example 1

Next, example 1 of exemplary embodiment of implement will be described. In the following description, data processing device 12 is referred to as the “server” and headset-type terminal 314 is referred to as the “terminal.

Conventional brain-streaming support systems lack the ability to automatically generate specific ideas and questions related to a theme when a user enters a theme. They also lack the means to evaluate and further expand on the generated ideas and questions. Furthermore, there is insufficient integration with web conferencing tools, making it difficult to effectively utilize the information obtained during meetings.

The specific processing by the specific processing unit 290 of the data processing device 12 in Example 1 is realized by the following means.

In this invention, the server includes means for inputting themes from the user, converting the themes into prompt sentences, sending the prompt sentences to the generative AI model, receiving output from the generative AI model, displaying the generated ideas and questions to the user, input from the WebUI means and means of interfacing with the web conferencing tool. This allows for the automatic generation of specific ideas and questions based on user input on a theme, which can then be evaluated and expanded upon. In addition, the linkage with the Web conferencing tool allows the user to effectively utilize the information obtained during the meeting.

The “means of inputting themes from users” is a means of providing an interface for users to input brainstorming themes.

The “means of converting the theme into a prompt sentence” refers to the means of converting the theme input by the user into a prompt sentence in a format suitable for the generated AI model.

The “means for transmitting the prompt text to the generating AI model” is a means for transmitting the generated prompt text to the generating AI model.

A “means of receiving output from the generative AI model” is a means of receiving ideas or questions returned by the generative AI model.

A “means of displaying generated ideas and questions to users” is a means of displaying ideas and questions received from the generated AI model to users.

The “means of input from the WebUI” is the means by which the user provides input through the Web interface.

The “means of linking with web conferencing tools” is a means of obtaining information in conjunction with web conferencing tools and utilizing it within the system.

### Exemplary Embodiment of the Invention

This invention is a brain-streaming support system that allows users to input a theme, which is then used to generate relevant ideas and questions using a generative AI model. An exemplary embodiment of this system is described below.

### System Configuration

The system consists of the following major components
1. means for users to input themes
2. means of converting such themes into prompt text
3. means of transmitting such prompt sentences to a generative AI model
4. means of receiving output from the generated AI model
5. a means of displaying the generated ideas and questions to the user
6. input method from WebUI
7. means of cooperation with web conferencing tools

### Hardware and Software Used

Hardware: servers, terminals (user's PC or smartphone)
Software: Generative AI model (e.g. GPT-4), Web browser, HTML, JavaScript, Python

### Program Processing

The user enters a theme through a web browser. For example, the user enters the theme “New Business Development”. The terminal sends this theme to the server. The server converts the received theme into a prompt text. Specifically, the server generates the prompt statement, “Please generate questions and ideas about ‘new business development’.” The prompt sentence “Please generate questions and ideas about ‘new business development” is generated.

The server sends this prompt sentence to the Generative AI model (GPT-4). The Generative AI model generates relevant questions and ideas based on the prompt sentence. For example, “What are the market needs for new business development?” or “For new business development, we will leverage our existing customer base” will be generated.

The generated questions and ideas are sent to the terminal via the server. The terminal displays this information on a web browser, and users can brainstorm based on this information.

### Concrete Example

The user enters the theme “New Business Development”. The terminal sends this theme to the server. The server generates the prompt “Please generate questions and ideas about ‘new business development” and sends it to the generative AI model (GPT-4), and sends it to the generative AI model (GPT-4). The generative AI model will ask questions such as “What are the market needs for new business development?” and “Use the existing customer base for new business development. The server receives these generated results and sends them to the terminal. The terminal displays the received questions and ideas on the browser, and the user brainstorms based on them.

In this way, users can gain a variety of perspectives and ideas related to the topic and receive assistance in brainstorming.

The flow of the identification process in Example 1 is described in FIG. 11.

### Step 1:

The user enters a theme.

The user accesses the interface on the web browser and enters the theme they wish to brainstream in the theme entry field. For example, enter “new business development. The entered theme is temporarily stored in the memory of the terminal.

### Step 2:

The terminal sends the theme to the server.

The terminal sends the theme entered by the user to the server as an HTTP request. This request is made using the JavaScript fetch function. The input data is the theme “New Business Development” and the output is a request sent to the server.

### Step 3:

The server converts the theme into a prompt statement.

The server generates prompt statements based on the theme received. For example, for the theme “New Business Development,” the server generates the prompt statement, “Please generate questions and ideas about ‘New Business Development’.” The input data is the theme “New Business Development” and the output is the theme “New Business Development”. The input data is the theme “New Business Development” and the output is the prompt sentence “Please generate questions and ideas for ‘New Business Development’. The output is “Please generate questions and ideas about ‘new business development”.

### Step 4:

The server sends prompt statements to the generating AI model.

The server sends the generated prompt statements to the generating AI model (GPT-4). This communication is done using API requests. The input data is the prompt sentence and the output is the request sent to the generation AI model.

### Step 5:

Generative AI models generate questions and ideas.

The generative AI model generates relevant questions and ideas based on the prompt sentences received. For example, “What is the market need for new business development?” or “For new business development, we will leverage our existing customer base” are generated. The input data are the prompt sentences and the output are the questions and ideas generated.

### Step 6:

The server receives the generated questions and ideas.

The server receives questions and ideas returned from the generative AI model. This data is received in JSON format. The input data is the output from the data generation model and the output is the data received by the server.

### Step 7:

The server sends questions and ideas to the terminal.

The server sends the received questions or ideas to the terminal as an HTTP response. This response is also in JSON format. The input data are the questions and ideas generated, and the output is the data sent to the terminal.

### Step 8:

The terminal displays questions and ideas to the user.

The terminal displays the questions and ideas received from the server on the browser. Users can brainstorm based on this information. The input data is the response from the server and the output is the display on the browser.

### Example of Application 1

Next, example of application 1 of example of implement 1 will be described. In the following description, data processing device 12 is referred to as the “server” and headset-type terminal 314 is referred to as the “terminal.

Conventional brain-streaming support systems have the ability to generate ideas and questions based on themes entered by the user, but they lack support specific to particular industries or applications. In particular, they lack the ability to generate specific ideas and questions to improve production efficiency in a factory, making it difficult for factory managers and engineers to efficiently find ways to improve production lines.

The specific processing by the specific processing unit 290 of the data processing device 12 in example of application 1 is realized by the following means.

In this invention, the server includes theme input means from the user, generative AI means to generate ideas and questions related to the theme, evaluation means to support expansion on the generated ideas, input means from the WebUI and with web conferencing tools, and learning means to improve production efficiency in the factory. The system includes means to generate ideas and questions for improving production efficiency in the factory, and learning means to provide feedback on the generated ideas and questions and reflect them in the next and subsequent generations. This enables factory managers and engineers to efficiently generate specific ideas and questions to improve production efficiency and find improvement measures.

The “user input method” is an interface that allows users to enter a specific theme or issue.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link with web conferencing tools to share information and utilize data such as meeting minutes.

The “means of generating ideas and questions to improve production efficiency in a factory” is the ability to generate ideas and questions specifically designed to improve production efficiency in a factory.

A “learning method that provides feedback on generated ideas and questions and reflects it in the next generation” is a function that collects feedback from users, which is then used by the generative AI to generate ideas and questions for the next and subsequent generations.

As an exemplary embodiment of this invention, a brain-streaming support system for improving production efficiency in a factory is described in detail.

### System Configuration

The system includes the following major hardware and software components

Server: hosts a generative AI model, receives thematic input from users, and generates relevant ideas and questions.

User Terminal: Device (e.g., PC, tablet) for plant managers and engineers to enter topics and review generated ideas and questions.

Web User Interface (WebUI): An interface for users to enter themes and view generated ideas and questions.

Web conferencing tools: Tools for capturing meeting minutes and interfacing with the system.

### Program Processing

The server performs data processing and data computation using the following means

1. theme input method: The user enters a theme through the WebUI. For example, the user enters the theme of “improving production line efficiency”.

Generative AI means: Generate relevant ideas and questions based on input themes using a generative AI model such as OpenAI's GPT-3. The generated ideas and questions are processed on the server and sent to the user's terminal.

Means of evaluation: Users evaluate the ideas and questions generated. The evaluation results are sent to the server and will be reflected in the next and subsequent generations.

4. means of input from the WebUI: users provide feedback through the WebUI and rate the ideas and questions generated.

5. means of linking with web conferencing tools: Information is obtained from the minutes of the web conferencing tool and used as training data for the generative AI model.

6. learning means: update the generative AI model based on user feedback and reflect it in the generation of ideas and questions in the next and subsequent sessions.

### Concrete Example

For example, if a factory manager inputs the theme “improving production line efficiency,” the generative AI model will generate the following ideas and questions.

Where are the bottlenecks in the production line?”

What processes can be automated?”

Would changing the layout of the production line increase efficiency?”

These ideas and questions are displayed in the WebUI on the user's terminal, and the user can provide ratings and feedback on them.

### Example of Prompt Text

Topic: Improving production line efficiency

Generate relevant ideas and questions.

In this way, specific ideas and questions can be efficiently generated to improve production efficiency in the plant, allowing managers and engineers to find ways to improve.

The flow of the identification process in Example of Application 1 is described in FIG. 12.

### Step 1:

The user enters the theme through the WebUI.

Input: The user enters a theme, such as “improving the efficiency of the production line”.

Output: The input theme is sent to the server.

Specific action: The user enters the theme in the input field of the WebUI and clicks on the “Submit” button.

### Step 2:

The server uses a generative AI model to generate relevant ideas and questions based on the input themes.

Input: The server receives the theme submitted by the user.

Output: list of ideas and questions generated by the generative AI model.

Specific behavior: The server sends themes as prompt sentences to OpenAI's GPT-3 and other generative AI models, and receives generated ideas and questions.

### Step 3:

The server sends the generated ideas and questions to the user terminal.

Input: a list of ideas and questions generated by the generative AI model.

Output: Ideas and questions displayed on the user's terminal.

Specific operation: The server sends the generated ideas and questions to the WebUI of the user terminal for display.

### Step 4:

Users evaluate the ideas and questions generated.

Input: User evaluates the ideas and questions displayed.

Output: The evaluation results are sent to the server.

Specific behavior: User clicks on evaluation buttons on the WebUI, such as “original,” “realistic,” “review from management's point of view,” etc.

### Step 5:

The server receives the evaluation results from the user and stores them as training data to be reflected in the next generation.

Input: Evaluation results sent by the user.

Output: The evaluation results are stored and used as training data for the generative AI model.

Specific operation: The server stores the evaluation results in a database and provides them as feedback to the learning algorithm of the generative AI model.

### Step 6:

The server retrieves information from the minutes of the web conferencing tool and uses it as training data for the generative AI model.

Input: Minutes data from web conferencing tools.

Output: the minutes data is used as training data for the generative AI model.

Specific operation: The server obtains the minutes data through the API of the web conferencing tool and provides it to the training algorithm of the generative AI model.

In this way, specific ideas and questions can be efficiently generated to improve production efficiency in the plant, allowing managers and engineers to find ways to improve.

### Example 2

Next, example 2 of exemplary embodiment of implement will be described. In the following description, data processing device 12 is referred to as the “server” and headset-type terminal 314 is referred to as the “terminal.

Conventional brainstorming support systems have a problem in that it is difficult to obtain appropriate feedback and expansion on ideas entered by users. In addition, the evaluation perspective was limited, making it difficult to expand on ideas from multiple perspectives. Furthermore, there was a lack of concrete means to improve the quality and relevance of the ideas generated.

The specific processing unit 290 of the data processing device 12 in Example 2 is realized by the following means.

In this invention, the server includes theme input means from the user, generative AI means to generate ideas and questions related to the theme, evaluation means to support expansion on the generated ideas, means to generate prompt sentences based on the evaluation, means to send the generated prompt sentences to the generative AI model means, a means to return a response from the generated AI model to the user, and means for input from the WebUI and linkage with the web conferencing tool. This allows for evaluation and expansion from multiple perspectives on user input ideas, thereby enhancing the quality and relevance of the generated ideas.

The “user input method” is an interface for users to enter ideas and themes into the system. Generative AI means” is an artificial intelligence function that generates relevant ideas and questions based on a theme entered by the user.

The “evaluation means” is an interface for users to evaluate the generated ideas, and includes evaluation buttons such as “original,” “realistic,” and “review from a manager's perspective.

The “means of generating prompt sentences” is the ability to create prompt sentences for transmission to the generative AI model based on the user's ratings.

The “means of transmitting to the generated AI model” is the communication means for transmitting the generated prompt sentences to the generated AI model.

The “means of returning responses from the generative AI model to the user” is the ability to return to the user new ideas and responses received from the generative AI model.

The “means of input from the WebUI” is the means by which users enter information into the system through the Web interface.

The “means of linking with web conferencing tools” is a function to link with web conferencing tools to utilize information such as meeting minutes.

This invention is a system that supports the evaluation and expansion of ideas by utilizing a generative AI model based on themes entered by the user. An exemplary embodiment of this system is described below.

First, the user uses a terminal (e.g., PC or smartphone) to enter a theme through the system's WebUI. For example, the user would enter, “For new business development, consider the introduction of new technologies.

Next, the user presses one of the rating buttons for the theme entered, such as “Originally,” “Realistically,” or “Review from Management's Perspective.” For example, the user presses the “Originally” button.

The server generates the appropriate prompt sentence based on the evaluation button pressed by the user. For example, if the button “Creatively” is pressed, the server will generate the prompt sentence “What creative business will be possible with the introduction of the new technology?

Next, the server sends the generated prompt sentences to the generating AI model (e.g., GPT-4 of OpenAI). Specifically, the prompt sentences are sent through the API.

The generative AI model generates new ideas based on the prompt sentences it receives. For example, in response to the prompt sentence “What kind of creative business will be possible through the introduction of new technology?”, the model generates ideas such as “A new logistics service that utilizes AI-based automated driving technology.

Finally, the server returns the new ideas received from the generative AI model to the user. Specifically, the new ideas are displayed on the terminal screen.

The system allows users to evaluate and expand on the ideas they enter from multiple perspectives, enhancing the quality and relevance of the ideas generated. In addition, the system can be integrated with web conferencing tools to utilize information from meeting minutes.

As a specific example, consider a case in which a user enters “Consider introducing new technology for new business development” and presses the “Review from Management's Perspective” evaluation button. In this case, the server generates the prompt sentence “What are the benefits and risks of introducing new technology from a manager's perspective? The generative AI model generates new ideas and re views based on this prompt sentence, and the server returns the results to the user.

Examples of prompt statements include the following

What kind of creative projects will be possible through the introduction of new technologies?”

What are the benefits and risks of implementing new technologies from a management perspective?”

What is the practical impact of introducing new technologies?”

In this way, users can evaluate and further extend their ideas using the generative AI model.

The flow of the identification process in Example 2 is described in FIG. 13.

### Step 1:

The user enters the theme in the input form on the terminal.

Input: Theme to be entered by user (e.g., “For new business development, consider introducing new technologies”)

Output: The input theme is sent to the server.

Specific operation: The user uses the WebUI on the terminal to enter the theme and press the submit button.

### Step 2:

The user presses the “Evaluate” button.

Input: User-selected rating button (e.g., “Creatively”)

Output: The selected evaluation is sent to the server.

Specific action: The user presses one of the evaluation buttons for the entered theme, such as “original,” “realistic,” or “review from a manager's point of view.

### Step 3:

The server generates a prompt statement.

Input: User entered theme and rating button selection information

Output: Generated prompt text (e.g., “What creative business will be possible with the new technology?”)

Specific behavior: The server generates the appropriate prompt sentence based on the evaluation button pressed by the user.

### Step 4:

The server sends prompt statements to the generated AI model.

Input: Generated prompt text

Output: Prompt statements sent to the generated AI model

Specific behavior: The server sends the generated prompt sentences to the generated AI model (e.g., OpenAI's GPT-4) via API.

### Step 5:

Generative AI models generate new ideas.

Input: Prompt sentences sent to the generated AI model

Output: New ideas generated (e.g., “New logistics services using AI-based automated driving technology”)

Specific behavior: The generative AI model generates new ideas based on the prompt sentences it receives.

### Step 6:

The server returns the generated ideas to the user.

Input: new ideas received from the generative AI model

Output: New ideas displayed on the user's terminal

Specific operation: The server sends new ideas received from the generated AI model to the user's terminal and displays them on the screen.

### Example of Application 2

Next, example of application 2 of example of implement 2 will be described. In the following description, data processing device 12 is referred to as the “server” and headset-type terminal 314 is referred to as the “terminal.

Conventional brainstorming support systems lacked concrete means to further expand on user-generated ideas. They also lacked a function to assist content creators in generating new content ideas and further extending them using a rating button. This made it difficult to improve creativity and efficient idea generation.

The specific processing by the specific processing unit 290 of the data processing device 12 in example of application 2 is realized by the following means.

In this invention, the server includes theme input means from the user, generative AI means to generate ideas and questions related to the theme, evaluation means to support extensions to the generated ideas, input means from the WebUI and with web conferencing tools, and means for content creators to create new content ideas and supporting further extensions to them using the evaluation buttons, and application means to be installed on a smartphone or head-mounted display. This allows users to further expand on the ideas they generate using the evaluation buttons, thereby improving creativity and efficient idea generation.

The “user input method” is an interface that allows users to enter specific themes or topics into the system.

Generative AI means” is an artificial intelligence function that automatically generates relevant ideas and questions based on input themes.

The “evaluation means” is an interface that allows users to evaluate the generated ideas “creatively,” “realistically,” or “reviewed from a manager's point of view.

The “means of input from the WebUI” is the means by which a user inputs information through the Web user interface.

The “means of linking with web conferencing tools” is a function to link with web conferencing tools to utilize information such as meeting minutes.

The “means to support content creators in generating new content ideas and further extending them using the evaluation buttons” is a support function for content creators to generate new ideas and further develop them using the evaluation buttons.

An “application means installed on a smartphone or head-mounted display” is a means for using the system through an application installed on a smartphone or head-mounted display.

The system for implementing this invention includes theme input means from the user, generative AI means, evaluation means, input means from the WebUI, means for integration with web conferencing tools, means to help content creators generate new content ideas and further extend them with evaluation buttons means, including application means installed on smartphones and head-mounted displays.

### Description of the System's Program Processing

Hardware and Software Use
Hardware: (1)
Smart phone
HMD
Server
Software: C
OpenAI API
Python Programs
WebUI
Web conferencing tools
Data processing and data computation

### User Operation:

The user uses a smartphone or head-mounted display to enter a theme. For example, the user would enter the theme, “For new business development, consider introducing new technologies.

### Generative AI Processing:

The server generates relevant ideas and questions using a generative AI (e.g., GPT-3) based on the input theme. The ideas generated are, for example, “What kind of creative business will be possible through the introduction of new technologies?

### Operation of Evaluation Instruments:

The user presses a rating button for the generated idea, such as “original,” “realistic,” or “review from a manager's point of view. For example, if the user presses the “Originally” evaluation button, the generative AI will generate a new idea such as “Provide an AI-based personalized content delivery service by introducing new technology.

Integration with WebUI and Web Conferencing Tools:

Users can enter information through the WebUI and utilize information from the minutes of the web conferencing tool for further detailed idea generation.

### Support for Content Creators:

Content creators can use the evaluation buttons to further expand on generated ideas and generate new content ideas. This allows for increased creativity and efficient idea generation.

### Specific Examples and Prompt Statements

### Specific Examples

Initial Idea: “For new business development, consider implementing new technologies.”

User rating: “Ingenious”

Idea generated: “Implement new technologies to provide personalized content delivery services using AI.”

Example of a prompt statement: “I am a member of the

“For new business development, think creatively about introducing new technologies.”

In this way, the generative AI generates new ideas based on user evaluations, and the system supports the creativity of content creators.

The flow of the identification process in example of application 2 is described in FIG. 14.

### Step 1:

The user uses a smartphone or head-mounted display to enter a theme. For example, the user enters the theme, “For new business development, consider introducing new technologies. The entered theme is sent to the server.

Input: User entered theme

Output: Themes sent to server

### Step 2:

The server sends the received themes to the generative AI model (e.g., GPT-3), which generates related ideas and questions. The generative AI model generates prompt sentences based on the theme and outputs corresponding ideas.

Input: Themes sent to the server

Output: Ideas and questions generated by generative AI models

### Step 3:

The server sends the generated ideas and questions to the user's device. The user reviews the generated ideas through a smartphone or head-mounted display.

Input: ideas and questions generated by generative AI models

Output: Ideas or questions sent to the user's terminal

### Step 4:

The user presses an evaluation button for the generated ideas, such as “original,” “realistic,” “review from a manager's perspective,” etc. The evaluation button selection information is transmitted to the server.

Input: Selection information for the evaluation button pressed by the user

Output: Rating button selection information sent to the server

### Step 5:

The server generates new prompt sentences based on the selection information of the evaluation button and sends them to the generative AI model again. The generative AI model generates further extended ideas based on the new prompt sentences.

Input: Selection information for the evaluation button sent to the server

Output: Extended ideas generated by the generative AI model

### Step 6:

The server sends the augmented idea to the user's device. The user sees the augmented idea through a smartphone or head-mounted display.

Input: extended ideas generated by generative AI models

Output: Extension ideas sent to the user's terminal

### Step 7:

The user may continue to expand on the idea, pressing further evaluation buttons as needed. This process is repeated until the user is satisfied.

Input: Selection information for the evaluation button pressed by the user

Output: Further extended ideas generated by the generative AI model

In this way, users can further expand on the generated ideas using the evaluation buttons, which improves creativity and efficient idea generation.

### Example 3

Next, example 3 of exemplary embodiment of implement will be described. In the following description, data processing device 12 is referred to as the “server” and headset-type terminal 314 is referred to as the “terminal.

Conventional brain-streaming support systems allow users to input themes and generate ideas using a generative AI, but they are not fully integrated with web conferencing tools, making it difficult to effectively utilize information obtained from meeting minutes. In addition, evaluation and extension support for generated ideas was limited, making it difficult for users to obtain the specific and practical ideas they were looking for. This reduced the efficiency and effectiveness of brain streaming.

The specific processing unit 290 of the data processing device 12 in Example 3 is realized by the following means.

In this invention, the server has a means for inputting a theme from the user, a generative AI means for generating ideas and questions related to the theme, an evaluation means for supporting expansion on the generated ideas, a means for input from the WebUI and a means for interfacing with a web conferencing tool, a means for analyzing minutes from the web conferencing tool and The system includes means for extracting important information, means for creating and sending prompt sentences to the generated AI model based on the extracted information, and means for displaying the ideas generated from the generated AI model to the user. This enables the system to effectively utilize information obtained from the minutes of the web conferencing tool to generate specific and practical ideas that users seek.

A “user input method” is a means of providing an interface for a user to enter a specific theme or topic into the system.

Generative AI means” are means using artificial intelligence technology to generate relevant ideas and questions based on input themes.

The “evaluation means” is a means for users to evaluate and provide feedback on the ideas generated.

The “means of input from the WebUI” is the means by which users enter information into the system through a Web browser.

The “means of linking with a web conferencing tool” is a means of linking a web conferencing tool with the system to capture meeting minutes and other information into the system.

Means for analyzing the minutes of a web conference tool and extracting important information” means a means for analyzing the minutes obtained from a web conference tool and extracting important information from them.

The “means for creating and sending prompt sentences to the generated AI model” is a means for creating and sending appropriate prompt sentences to the generated AI model based on the extracted information.

The “means for displaying ideas generated from the generative AI model to the user” is a means for displaying ideas generated from the generative AI model to the user.

This invention is a brain streaming support system in which the user, terminal, and server work together. The following is an exemplary embodiment of this system.

### User Operation

Users access the system's WebUI using a web browser; the WebUI has input fields, such as text boxes and drop-down menus, where users enter information such as “I would like you to generate ideas about new business development.

### Terminal Operation

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by the user's operation. The minutes are saved in text file or PDF format.

### Server Processing

The server receives the uploaded minutes and analyzes them using natural language processing (NLP) technology. Specifically, tools such as Python's NLTK library and SpaCy are used to extract important information from the minutes, such as “New business development requires the introduction of new technologies.

Based on the extracted information, the server creates prompt sentences to be sent to the generative AI model. For example, the server creates a prompt sentence “What new business can be developed by introducing new technology? The created prompt sentence is sent to the generative AI model via the API.

The generative AI model (e.g., OpenAI's GPT-3) generates new ideas based on the prompt text received. The generated ideas are returned to the server in text format.

The server receives the ideas returned from the generated AI model and sends them to the terminal. Communication protocols such as HTTP requests and WebSockets are used for transmission.

### Terminal Display

The terminal displays the ideas received from the server to the user; the WebUI displays the generated ideas and the user can review them. The user can also provide feedback and request that the idea be generated again, if necessary.

### Concrete Example

1. a user enters through the WebUI, “I would like you to generate ideas for new business development.

2. the user conducts a meeting using a web conferencing tool and uploads the minutes of the meeting to the system.

3. the server analyzes the minutes and extracts information that “new business development requires the introduction of new technology.

4. the server creates a prompt sentence for the generated AI model, “What new business can be developed by introducing new technology?

5. the generative AI model generates new ideas and displays them to the user through the terminal.

### Example of Prompt Text

“Generate ideas about what new businesses could be developed through the introduction of new technologies.”

Thus, by linking the WebUI with a web conferencing tool, the system utilizes information obtained from the minutes and generates new ideas using a generative AI model. This allows users to obtain concrete and practical ideas. The flow of the specific process in Example 3 is described in FIG. 15.

### Step 1:

The user enters information through the WebUI.

The user opens a web browser and accesses the system's WebUI, which has input fields such as text boxes and drop-down menus where the user enters information such as “I would like you to generate ideas for new business development. The input information is sent to the server. The input data is in text format, which the server receives.

### Step 2:

The terminal uses a web conferencing tool to conduct the meeting.

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by user operation. The minutes are saved in text file or PDF format. The input data is the minutes file, which the server receives.

### Step 3:

The server analyzes the minutes and extracts important information.

The server receives the uploaded minutes and analyzes them using natural language processing (NLP) technology. Specifically, tools such as Python's NLTK library and SpaCy are used to extract important information from the minutes, such as “new technology is needed for new business development. The input data is the text of the minutes and the output data is the extracted critical information.

### Step 4:

The server creates and sends prompt statements to the generated AI model.

The server creates prompt sentences to be sent to the generative AI model based on the extracted information. For example, the server creates a prompt sentence “What new business can be developed by introducing new technology? The created prompt sentence is sent to the generative AI model via the API. The input data is the extracted information and the output data is the prompt sentence.

### Step 5:

Generative AI models generate new ideas.

The generative AI model (e.g., OpenAI's GPT-3) generates new ideas based on the prompt text received. The generated ideas are returned to the server in text format. The input data is the prompt sentence and the output data is the generated idea.

### Step 6:

The server sends the generated ideas to the terminal.

The server receives the ideas returned from the generated AI model and sends them to the terminal. Communication protocols such as HTTP requests and WebSockets are used for transmission. The input data are the generated ideas and the output data are the ideas sent to the terminal.

### Step 7:

The terminal displays the ideas generated to the user.

The terminal displays the ideas received from the server to the user; the WebUI displays the generated ideas and the user can review them. The user can also provide feedback and ask to generate ideas again, if necessary. The input data are the ideas sent from the server and the output data are the ideas displayed to the user.

### Example of Application 3

Next, example 3 of application of example of implement 3 will be described. In the following description, data processing device 12 is referred to as the “server” and headset-type terminal 314 is referred to as the “terminal.

Conventional brainstorming support systems have utilized minutes of meetings by inputting themes from users and linking with web conferencing tools, but they do not support the generation of ideas for specific manufacturing processes or efficiency improvements in the factory. Therefore, there is a need to generate ideas for new manufacturing processes and efficiency improvements based on the minutes of in-plant meetings.

The specific processing by specific processing unit 290 of data processing device 12 in example of application 3 is realized by the following means. In this invention, the server includes means for inputting themes from users, means for generating ideas and questions related to the themes, means for evaluating the generated ideas to support expansion, means for inputting information from the WebUI and linking with a web conferencing tool, and means for generating new manufacturing processes and efficiency ideas based on the information The system includes means to capture the minutes of meetings held in the factory and generate ideas for new manufacturing processes and efficiency improvements based on that information. This enables the generation of ideas for new manufacturing processes and efficiency improvements based on the minutes of meetings held in the factory.

The “user input method” is an interface that allows users to input discussion and idea generation themes to the system.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which users enter information into the system through the Web user interface.

The “means of linking with a web conferencing tool” is a means of linking a web conferencing tool with the system to capture meeting minutes and other information into the system.

The “means of capturing minutes of meetings held in the factory and generating ideas for new manufacturing processes and efficiency improvements based on that information” is a function for capturing the minutes of meetings held in the factory into the system and generating ideas for new manufacturing processes and efficiency improvements based on those minutes.

The system for implementing this invention includes means for inputting themes from users, generative AI, evaluation, input from the WebUI, integration with web conferencing tools, and means for capturing minutes of meetings held in the factory and generating ideas for new manufacturing processes and efficiency improvements based on that information.

The server provides an interface for the user to enter themes. Themes entered by the user are sent to the generative AI means to generate related ideas and questions. The generated ideas are evaluated by the user through the evaluation means, and the ideas are extended or improved based on the evaluation results.

The input method from the WebUI is a means for users to enter information into the system through the web user interface. This allows users to easily enter themes and evaluation results.

The means of linking with web conferencing tools is a means to link web conferencing tools with the system and to incorporate meeting minutes and other information into the system. For example, minutes are retrieved from a web conferencing tool such as Zoom, and a generative AI generates new ideas based on this information.

The means of capturing minutes of meetings held in a factory and generating ideas for new manufacturing processes and efficiency improvements based on that information is a function for capturing minutes of meetings held in a factory into the system and generating ideas for new manufacturing processes and efficiency improvements based on those minutes. This enables the generation of ideas for new manufacturing processes and efficiency improvements based on the minutes of meetings held in the factory.

As a concrete example, the following prompt sentences can be entered into a generative AI model

### Example of a Prompt Statement:

Minutes: Need to improve efficiency of production lines. In particular, bottlenecks in the assembly process are a problem. Please propose ideas to solve this problem by introducing new technologies and methods.

Based on this prompt sentence, a generative AI might generate the following ideas

1. promote automation of the assembly process by introducing a robot arm.

2. introduce an AI-based quality inspection system for early detection of defective products.

3. redesign the layout of the production line to improve work efficiency.

In this way, ideas for new manufacturing processes and efficiencies can be generated based on the minutes of meetings in the plant.

The flow of the identification process in example of application 3 is described in FIG. 16.

### Step 1:

The user enters a theme. Users enter discussion and idea generation themes through the web user interface. The entered themes are sent to the server. The input data is in text format, and the server receives it and passes it on to the next process.

### Step 2:

The server generates ideas and questions using generative AI methods. The server inputs the themes received in step 1 into the generative AI model and generates relevant ideas and questions. The generative AI model processes data based on the themes and outputs the relevant ideas and questions in text format.

### Step 3:

The server sends the generated ideas to the evaluation method. The server sends ideas and questions output from the generative AI model to the evaluation means. The evaluation method provides an interface for users to evaluate the ideas. The user evaluates the ideas using evaluation buttons such as “original,” “realistic,” “review from a manager's point of view,” etc. The server sends the ideas and questions from the generative AI model to the evaluation means.

### Step 4:

The user evaluates the ideas. The user evaluates the generated ideas through the evaluation method. The evaluation results are sent to the server and used for the next process. The evaluation data is in numerical or text format, and the server receives it and passes it on to the next process.

### Step 5:

The server extends or improves the idea based on the evaluation results. The server extends or improves ideas based on evaluation results received from users, using the generative AI model again. The generative AI model uses the evaluation results as input data to extend or improve the idea.

### Step 6:

The server retrieves the meeting minutes using a means of interfacing with the web conferencing tool. The server retrieves the meeting minutes from the web conferencing tool (e.g., Zoom). The retrieved minutes are in text format, which the server passes on to the next process.

### Step 7:

The server inputs the minutes into a generative AI method to generate ideas for new manufacturing processes and efficiency improvements. The server inputs the acquired minutes into the generative AI model and generates ideas for new manufacturing processes and efficiency improvements based on the minutes. The generative AI model analyzes the contents of the minutes and outputs related ideas in text format.

### Step 8:

The server provides the generated ideas to the user. The server provides the user with ideas for new manufacturing processes and efficiencies output from the generative AI model. The user reviews these ideas through a web user interface and provides evaluation and feedback as needed.

Further, an emotion engine that estimates the user's emotion may be combined. In other words, the specific processing unit 290 may use the emotion identification model 59 to estimate the user's emotion and perform specific processing using the user's emotion.

### Example of Implement 1

One exemplary embodiment of this invention is a brain streaming support system that includes an emotion engine that recognizes the user's emotions. The system receives thematic input from the user and generates ideas and questions related to that theme. The generated ideas are evaluated based on the user's emotions, and new ideas are generated based on the results. Specifically, if the user is exhibiting feelings of joy, positive ideas that are consistent with those feelings are generated. Conversely, if the user is expressing sadness, ideas are generated that suggest solutions that correspond to that emotion.

### Example of Implement 2

Another exemplary embodiment of the invention is a brain streaming support system in which an emotional engine adjusts the evaluation criteria of the evaluation method. In this system, the evaluation criteria are adjusted based on the user's emotions. Specifically, if the user is in an excited state, the evaluation criteria are set higher to match that emotion, making it easier for more challenging ideas to be evaluated. Conversely, when the user is calm, the evaluation criteria are set lower to match the user's emotions, and more realistic ideas are more likely to be evaluated.

### Example of Implement 3

Yet another exemplary embodiment of the invention is a brain streaming support system that utilizes information from the minutes of a web conferencing tool. In this system, new ideas are generated based on information from the minutes of a web conferencing tool. Specifically, the emotional engine analyzes the users' emotional information recorded in the minutes, and idea generation and evaluation are adjusted based on the results. For example, if “expectations for new business development” is recorded in the minutes, positive ideas that match the expectations are generated based on this information.

The following is a description of the process flow for each example of implement.

### Example of Implement 1

Step 1: Receive theme input from user.

Step 2: Generate ideas and questions related to the theme.

Step 3: The user's emotions are recognized by the emotion engine.

Step 4: Evaluate the ideas generated based on the recognized emotions.

Step 5: Generate new ideas based on evaluation results.

### Example of Implement 2

Step 1: Recognize the user's emotions with the emotion engine.

Step 2: Adjust the evaluation criteria of the evaluation instrument based on the recognized emotions.

Step 3: Evaluate ideas based on adjusted evaluation criteria.

Step 4: Generate new ideas based on evaluation results.

### Example of Implement 3

Step 1: Retrieve information from the minutes of the web conferencing tool.

Step 2: Generate new ideas based on the information obtained.

Step 3: The emotional engine analyzes the user's emotional information recorded in the minutes.

Step 4: Adjust idea generation and evaluation based on analysis results.

### Example 1

Next, example 1 of exemplary embodiment of implement will be described. In the following description, data processing device 12 is referred to as the “server” and headset-type terminal 314 is referred to as the “terminal.

Conventional brainstorming support systems generate ideas and questions without considering the user's emotions, making it difficult to provide appropriate ideas and questions according to the user's emotional state. In addition, user satisfaction may decrease because the evaluation of generated ideas and questions is not based on the user's emotions. Furthermore, there is a problem of inadequate integration with meeting tools and inability to utilize information from meeting minutes, which reduces the efficiency of brainstorming.

The specific processing by the specific processing unit 290 of the data processing device 12 in Example 1 is realized by the following means.

In this invention, the server includes theme input means from the user, generative AI means for generating ideas and questions related to the theme, evaluation means for supporting expansion on the generated ideas, emotion recognition means for recognizing the user's emotions, emotion recognition means for evaluating the ideas and questions based on the emotion information, and new means for generating ideas and questions, and means for interfacing with input means and meeting tools. This makes it possible to provide appropriate ideas and questions according to the user's emotional state and improve user satisfaction. In addition, the information from the minutes of the meeting tool can be used to improve the efficiency of brainstorming.

The “user input method” is an interface for users to input brainstorming themes.

A “generative AI means” is an artificial intelligence mechanism that generates relevant ideas and questions based on user input on a topic.

The “evaluation method” is a function that evaluates the ideas and questions generated and provides feedback to the user.

The “emotion recognition means” is a technology for recognizing the emotional state of a user by analyzing the user's facial expressions and tone of voice.

The “means for evaluating ideas and questions based on emotional information and generating new ideas and questions” is a function for evaluating generated ideas and questions based on recognized user emotional information and generating further new ideas and questions.

An “input means” is an interface that allows users to enter information into the system.

The “means of linking with conferencing tools” is a function to link with conferencing tools to utilize information such as meeting minutes.

This invention is a brain streaming support system that generates relevant ideas and questions based on thematic input from the user, and evaluates and extends them according to the user's emotional state. An exemplary embodiment of this system is described below.

First, the user enters a theme in the input field on the terminal. For example, the user enters “new business development. The terminal sends this theme to the server. The server uses a generative AI model (e.g., a general natural language processing model) to generate ideas and questions related to the entered theme. The generated ideas and questions are, for example

### Sample Questions:

What is the market need for new business development?”

What resources do you need for new business development?”

### Example Ideas:

We will leverage our existing customer base for new business development.”

“For new business development, consider the introduction of new technologies.”

The generated ideas and questions are sent from the server to the terminal. The terminal recognizes the user's emotions using emotion recognition means (e.g., common emotion recognition software). The user's facial expressions and tone of voice are analyzed to determine the emotional state of the user. For example, if the user is smiling, the emotion of joy is recognized.

The terminal sends the recognized emotion information to the server. The server evaluates the generated ideas and questions based on the emotion information and generates new ideas and questions. For example, if the user is indicating an emotion of joy, it generates positive ideas that are consistent with that emotion. Conversely, if the user is indicating an emotion of sadness, it generates ideas that suggest solutions that correspond to that emotion.

Finally, the server sends the evaluated ideas and questions to the terminal, which displays them to the user. The user can use these ideas and questions as a reference for further brainstorming.

As a specific example, if a user enters the topic “new business development,” the generative AI model will generate the following questions and ideas

### Sample Questions:

What is the market need for new business development?”

What resources do you need for new business development?”

### Example Ideas:

We will leverage our existing customer base for new business development.”

“For new business development, consider the introduction of new technologies.”

Examples of prompt statements may include the following

Generate ideas for new business development.”

Generate questions about market needs in new business development.”

In this way, the server, terminal, and user work together to create a system that supports brainstorming.

The flow of the identification process in Example 1 is described in FIG. 17.

### Step 1:

The user enters a theme.

The user enters the theme in the input field on the terminal and clicks on the submit button. For example, enter “New Business Development”. The input data is the theme text.

### Step 2:

The terminal sends the theme to the server.

The terminal sends the input theme “New Business Development” to the server using an HTTP POST request. The input data is the theme text and the output data is the request to the server.

### Step 3:

The server generates relevant ideas and questions using a generative AI model.

The server inputs the received themes into the generative AI model and generates related ideas and questions. For example, questions such as “What are the market needs for new business development?” and “What resources are needed for new business development?” are generated, as well as ideas such as “For new business development, leverage existing customer base” and “For new business development, consider introducing new technology. The input data is the theme text and the output data is a list of generated ideas and questions.

### Step 4:

Server-generated ideas and questions are sent to the terminal.

The server sends the generated ideas and questions to the terminal in JSON format. The input data is a list of generated ideas and questions, and the output data is the response to the terminal.

### Step 5:

The terminal recognizes the user's emotions using the emotion engine.

The terminal uses an emotion engine to analyze the user's facial expression and tone of voice to recognize the emotional state. For example, if the user is smiling, the emotion of joy is recognized. The input data is the user's facial expression and tone of voice, and the output data is the recognized emotion information.

### Step 6:

The terminal sends the recognized emotional information to the server.

The terminal sends the recognized emotion information to the server in JSON format.

The input data is the recognized emotion information and the output data is the request to the server.

### Step 7:

The server evaluates ideas and questions based on emotional information and generates new ideas and questions.

The server evaluates the ideas and questions generated based on the emotional information received. For example, if the user indicates a feeling of joy, it generates positive ideas that are consistent with that feeling. Conversely, if the user is indicating an emotion of sadness, ideas are generated that suggest solutions that correspond to that emotion. The input data is the emotion information and the list of generated ideas and questions, and the output data is the list of evaluated ideas and questions.

### Step 8:

The server sends the final ideas and questions to the terminal.

The server finally sends the evaluated ideas and questions to the terminal in JSON format. The input data is a list of evaluated ideas and questions, and the output data is the response to the terminal.

### Step 9:

The terminal displays the final idea or question to the user.

The terminal displays the final ideas and questions received to the user. The user can use these ideas and questions as a reference for further brainstorming. The input data is the list of ideas and questions evaluated, and the output data is what is displayed to the user.

### Example of Application 1

Next, example of application 1 of example of implement 1 will be described. In the following description, data processing device 12 is referred to as the “server” and headset-type terminal 314 is referred to as the “terminal.

Conventional brain-streaming support systems can generate ideas and questions based on thematic input from the user, but they do not take into account the user's emotions in generating and evaluating ideas, making it difficult to provide appropriate ideas according to the user's emotions. In addition, the lack of concrete means to generate ideas for new production processes and efficiency improvements in the factory makes the system less practical in the field.

The specific processing by specific processing unit 290 of data processing device 12 in example of application 1 is realized by the following means. In this invention, the server has the following means: theme input means from the user, generative AI means to generate ideas and questions related to the theme, evaluation means to support expansion on the generated ideas, input means from the WebUI and means to link with a web conferencing tool, emotion recognition means to recognize the user's emotions means, means to evaluate ideas generated based on emotions and generate new ideas, and means installed in the robot to generate ideas for new production processes and efficiencies in the factory. This allows the provision of appropriate ideas based on the user's emotions, thereby increasing their utility within the factory.

The “user input method” is an interface that allows users to enter a specific theme or topic.

Generative AI means” is an artificial intelligence function that generates relevant ideas and questions based on a theme entered by the user.

The “evaluation means” is a function for extending and evaluating the ideas generated.

The “means of input from the WebUI” is the means by which the user provides input through the web user interface.

The “means of linking with web conferencing tools” is a means of linking with web conferencing tools to share information or to utilize information from the minutes.

The “emotion recognition means” is a function to recognize the user's emotions.

The “means for evaluating ideas generated based on emotions and generating new ideas” is a function for evaluating ideas generated based on user emotions and generating new ideas based on the results.

The “means installed in a robot to generate ideas for new production processes and efficiencies in a factory” is a function installed in a robot to generate ideas for new production processes and efficiencies in a factory.

The system for implementing this invention includes theme input means from the user, generative AI means, evaluation means, input means from the WebUI, means for integration with web conferencing tools, emotion recognition means, means for evaluating ideas generated based on emotions and generating new ideas, means installed in a robot to generate new production processes in a factory and efficiency improvement ideas in the factory.

### Explanation of Program Processing

The server provides an interface for receiving theme input from users. When a user enters a theme, the server uses generative AI methods to generate ideas and questions related to that theme. The generative AI method uses a generative AI model, such as the OpenAI API, to generate relevant ideas and questions based on the input theme.

The generated ideas are extended and evaluated by the evaluation means. The evaluation means provides evaluation buttons, such as “original,” “realistic,” “review from a manager's point of view,” etc., allowing users to evaluate the generated ideas.

In addition, the emotion recognition means is used to recognize the user's emotions. The emotion recognition means uses the Emotion Recognition library and camera to analyze the user's emotions. Based on the recognized emotion, the means evaluates the generated ideas and generates new ideas. For example, if the user indicates an emotion of joy, a positive idea is added.

It will also include means that will be instructed into the robot to generate ideas for new production processes and efficiencies within the factory. The robot patrols the factory, receives thematic input from workers, and generates relevant ideas and questions using generative AI methods. The generated ideas are evaluated based on the worker's emotions and new ideas are added as needed.

### Concrete Example

For example, if a user enters the topic “Improving the efficiency of a new production line,” the generative AI method will generate the following ideas and questions.

Example of a prompt statement: “I am a member of the

Topic: New production line efficiency

Generate relevant ideas and questions.

Generated ideas and questions:

Where are the bottlenecks in the production line?

What technologies are needed to promote automation?

How can we reduce the burden on workers?

Add positive ideas.

A new robot arm was introduced to improve work efficiency.

Motivate workers to take more breaks.

In this way, appropriate ideas can be provided according to the user's emotional state, thus increasing their practicality in the factory.

The flow of the identification process in Example of Application 1 is described in FIG. 18.

### Step 1:

The user enters a theme. The user enters the theme through the web user interface (WebUI). The entered theme is sent to the server. The input data is textual information about the theme.

### Step 2:

The server receives the input themes and passes them to the generative AI means. The generative AI means generates ideas and questions related to the theme using a generative AI model such as OpenAI API. The input data is textual information of the theme, and the output data is textual information of the generated ideas and questions.

### Step 3:

The server passes the generated ideas and questions to the evaluation method. The evaluation means provides evaluation buttons, such as “original,” “current practically,” “review from a manager's point of view,” etc., to allow users to evaluate the generated ideas. The input data is the textual information of the generated ideas and questions, and the output data is the results of the user's evaluation.

### Step 4:

The server uses emotion recognition methods to recognize the user's emotions. The emotion recognition means uses the Emotion Recognition library and camera to analyze the user's emotions. The input data is the user's facial image and voice data, and the output data is information about the recognized emotion.

### Step 5:

The server evaluates the ideas generated based on the recognized emotions and uses the means to generate new ideas. For example, if the user indicates an emotion of joy, positive ideas are added. The input data is the information of the recognized emotion and the textual information of the generated ideas and questions, and the output data is the textual information of the new ideas evaluated based on the emotion.

### Step 6:

The server uses means installed on robots to generate ideas for new production processes and efficiencies within the factory. The robot patrols the factory, receives theme input from workers, and uses generative AI means to generate related ideas and questions. The input data is the textual information of the themes from the workers and the output data is the textual information of the generated ideas and questions.

### Step 7:

The server presents the generated ideas and questions to the workers. The workers can consider new production processes and ways to improve efficiency based on the ideas and questions presented. The input data is textual information of the generated ideas and questions, and the output data is feedback and new suggestions by the workers.

### Example 2

Next, example 2 of exemplary embodiment of implement will be described. In the following description, data processing device 12 is referred to as the “server” and headset-type terminal 314 is referred to as the “terminal.

In conventional brain-streaming support systems, it was difficult to provide appropriate feedback and expansion to user-generated ideas, and the quality and creativity of ideas were not sufficiently enhanced. In addition, because evaluation criteria were set without considering the user's emotional state, there was also the problem that ideas were not evaluated appropriately according to the user's state. Furthermore, there was insufficient linkage with web conferencing tools, making it difficult to effectively utilize the ideas and minutes generated during meetings.

The specific processing unit 290 of the data processing device 12 in Example 2 is realized by the following means.

In this invention, the server has a means for inputting a theme from the user, a generative AI means for generating ideas and questions related to the theme, an evaluation means for supporting expansion on the generated ideas, a means for generating prompt text based on the type of evaluation button, a means for sending the generated prompt text to the generative AI means, a means for displaying the new ideas returned from the generative AI means to the user, an emotion engine means for analyzing the user's emotional state, and a means for adjusting the evaluation criteria based on the analysis results of the emotion engine means. means, a means for displaying the new ideas returned by the generative AI means to the user, an emotion engine means for analyzing the user's emotional state, a means for adjusting the evaluation criteria based on the analysis results of the emotion engine means, and a means for input from the WebUI and for linking with a web conferencing tool. The system includes. This enables the setting of appropriate evaluation criteria according to the user's emotional state and the generation and expansion of high-quality ideas by the generative AI. In addition, the linkage with the Web conferencing tool enables effective use of ideas and minutes generated during the meeting.

The “means of theme input from users” is an interface for users to input themes, such as new business development, into the system.

Generative AI means” is an artificial intelligence function that generates relevant ideas and questions based on a theme entered by the user.

The “evaluation method” is a function that allows users to evaluate the ideas generated and helps them expand on those ideas based on their evaluation.

The “Evaluation Buttons” are buttons that allow for “creative,” “realistic,” and “management's point of view review.”

The “means of generating prompt sentences” is a function that generates prompt sentences to be sent to the generative AI means based on the type of evaluation button pressed by the user.

The “means of transmitting to the generative AI means” is a function for transmitting the generated prompt sentences to the generative AI means.

The “means for displaying new ideas returned by the generative AI means to the user” is a function that receives new ideas returned by the generative AI means and displays them on the user's terminal.

The “emotion engine means” is a function for analyzing the user's emotional state.

The “means to adjust evaluation criteria” is a function that adjusts the evaluation criteria based on the analysis results of the emotion engine means.

The “means of input from the WebUI” is the ability for users to provide input to the system through the Web interface.

The “means of linking with web conferencing tools” is a function to link with web conferencing tools to capture ideas and minutes from meetings in the system.

This invention is a system in which a user inputs a theme, such as new business development, and a generative AI method is used to generate ideas and questions related to that theme, and to support expansion on the generated ideas. An exemplary embodiment of this system is described below.

### Hardware and Software Used

Server: Performs the core processing of this system. It executes the data generation model, stores the data, and provides the user interface.

Terminal: A device operated by a user, such as a PC or a smart device.

Generative AI models: Use generative AI models such as OpenAI's GPT-4.

Emotion Engine: Software to analyze the user's emotional state. For example, using Microsoft's Azure Cognitive Services emotion recognition API.

### System Process Flow

1. the user enters an idea

The user uses a terminal to enter ideas for new business development into the system's input form. For example, the user would enter, “For new business development, consider introducing new technology.

2. the user presses the “Rate” button

The user presses one of the rating buttons, such as “original,” “realistic,” or “review from a manager's point of view,” for the ideas entered by the user.

3. the server generates prompt statements

The server generates prompt sentences to be sent to the generative AI model based on the type of evaluation button pressed by the user. For example, if the button “Originally” is pressed, the server will generate the prompt sentence “What creative business will be possible with the introduction of new technology?”.

4. the server sends prompt statements to the generated AI model

The server sends the generated prompt sentences to the generative AI model. The generative AI model is running in the cloud.

5. generation AI model generates new ideas

The generative AI model generates new ideas based on the prompt sentence. For example, it generates ideas such as “New technologies will enable personalized marketing using AI.

6. display server-generated ideas to users

The server receives the new ideas returned from the generative AI model and displays them on the user's terminal.

7. an emotional engine analyzes the user's emotions (another exemplary embodiment)

While the user is inputting ideas, the emotion engine analyzes the user's facial expressions and voice to determine whether the user is in an excited or calm state.

8. the server adjusts the evaluation criteria (another exemplary embodiment)

The server receives the results of the emotion engine analysis and sets the evaluation criteria higher when the user is in an excited state, making it easier to evaluate challenging ideas. Conversely, if the user is in a calm state, the evaluation criteria are set lower, making it easier to evaluate realistic ideas.

### Concrete Example

### Example 1: Expansion of Ideas

User's operation: User enters the idea “For new business development, consider introducing new technologies” and presses the “Originally” rating button.

Server processing: The server sends a prompt statement to the generative AI model, “What creative business will be possible with the introduction of new technology?

Generative AI Model Response: The Generative AI Model generates new ideas such as “New technologies will enable personalized marketing using AI.

Display of results: The server displays the generated ideas on the user's terminal.

### Example 2: Using the Emotion Engine

User manipulation: the user inputs the idea “For new business development, consider introducing new technologies” and the emotion engine detects the user's state of excitement.

Server processing: The server sets the evaluation criteria high based on the analysis results of the emotion engine and sends a prompt statement to the generative AI model: “What challenging projects would be possible through the introduction of new technologies?

Generative AI Model Response: The generative AI model generates challenging ideas such as “The introduction of new technologies will allow us to build a fully automated smart city.

Display of results: The server displays the generated ideas on the user's terminal.

### Example of Prompt Text

What kind of creative projects will be possible through the introduction of new technologies?”

What realistic business opportunities will be made possible by the introduction of new technologies?”

What are the benefits, from a management perspective, of implementing new technologies?”

These are the exemplary embodiments of this system.

The flow of the identification process in Example 2 is described in FIG. 19.

### Step 1:

The user enters an idea.

The user opens a browser on his/her terminal and accesses the system's web page. On the input form, the user enters “Consider new technologies for new business development”. The entered data is sent from the terminal to the server.

Input: Idea entered by user

Output: Idea data sent to server

### Step 2:

The user presses the “Evaluate” button.

The user clicks one of the evaluation buttons, such as “original,” “realistic,” or “review from a manager's perspective. When the button is clicked, the information is sent from the terminal to the server.

Input: Information about the rating button pressed by the user

Output: Information on evaluation buttons sent to the server

### Step 3:

The server generates a prompt statement.

Based on the information of the evaluation buttons received by the server, it generates prompt sentences to be sent to the generative AI model. For example, if the button “Originally” is pressed, the prompt sentence “What kind of original business will be possible through the introduction of new technology?

Input: Rating button information

Output: Generated prompt statements

### Step 4:

The server sends prompt statements to the generated AI model.

The server sends the generated prompt sentences to the generative AI model. The generative AI model is running in the cloud.

Input: Generated prompt text

Output: Prompt statements sent to the generated AI model

### Step 5:

Generative AI models generate new ideas.

The generative AI model analyzes the prompt sentence and generates new ideas. For example, it generates ideas such as “New technologies will enable personalized marketing using AI. The generated ideas are returned to the server.

Input: Prompt statement

Output: New ideas generated

### Step 6:

The server displays the generated ideas to the user.

The server receives the new ideas returned from the generative AI model and sends them to the user's terminal. The user's terminal displays the new idea on the screen.

Input: new ideas generated

Output: Idea displayed on user's terminal

### Step 7:

The emotion engine analyzes the user's emotions (another exemplary embodiment).

While the user is inputting ideas, the emotion engine analyzes the user's facial expressions and voice to determine whether the user is in an excited or calm state. The analysis results are sent to the server.

Input: user's facial expressions and voice data

Output: Results of analysis by the emotion engine

### Step 8:

The server adjusts the evaluation criteria (another exemplary embodiment).

When the server receives the results of the emotion engine analysis and the user is in an excited state, it sets the evaluation criteria higher, making it easier for challenging ideas to be evaluated. Conversely, if the user is in a calm state, the evaluation criteria are set lower, making it easier to evaluate realistic ideas.

Input: Emotion engine analysis results

Output: Adjusted evaluation criteria

### Example of Application 2

Next, example of application 2 of example of implement 2 will be described. In the following description, data processing device 12 is referred to as the “server” and headset-type terminal 314 is referred to as the “terminal.

Conventional brainstorming support systems evaluate ideas without considering the user's emotional state, making it difficult to generate appropriate ideas according to the user's emotions. In addition, since the system was not designed for use on portable devices such as smartphones, users could not easily generate ideas anywhere.

The specific processing by the specific processing unit 290 of the data processing device 12 in example of application 2 is realized by the following means.

In this invention, the server includes theme input means from the user, generative AI means to generate ideas and questions related to the theme, and evaluation means to support expansion on the generated ideas. This makes it possible to detect the user's emotional state and adjust the evaluation criteria accordingly. Also, by including application means that are installed on a smartphone, users can easily perform idea generation anywhere.

The “Theme Input Method” is an interface for users to input brainstorming themes or topics.

Generative AI means” is an artificial intelligence function that automatically generates ideas and questions related to the input theme.

The “evaluation method” is a function that allows users to evaluate the ideas generated and helps them expand on those ideas based on their evaluation.

The “means of input from the WebUI” is the means by which a user inputs information through the Web user interface.

The “means of linking with web conferencing tools” is a means of linking with web conferencing tools to share information and utilize data such as meeting minutes.

The “emotion engine means” is a function that detects the user's emotional state and adjusts the system's behavior based on that information.

The “means of adjusting evaluation criteria” is a function that dynamically changes the criteria for evaluating ideas based on the user's emotional state.

An “application means installed on a smartphone” is a function of an application that is installed on a smartphone and can be used by users anywhere.

As an exemplary embodiment of this invention, the following system can be constructed.

First, the user enters a brainstorming theme using an application installed on his/her smartphone. The theme input method receives the theme entered by the user and sends it to the server.

The server uses generative AI means to generate ideas and questions related to the input theme. This generative AI means can use a generative AI model, such as GPT-3, for example. The generated ideas are displayed on the user's smartphone.

The user then presses a rating button for the displayed idea, such as “original,” “realistic,” “review from a manager's perspective,” etc. The evaluation method receives the user's rating and assists in expanding the idea accordingly.

In addition, the emotion engine means detects the emotional state of the user. The emotion engine means can use an emotion detection library such as Affectiva, for example. Based on the emotional state, the means for adjusting the evaluation criteria operates to set the appropriate evaluation criteria according to the user's emotion.

The system also includes a means of input from the WebUI and a means of interfacing with web conferencing tools, which can extract information from meeting minutes and use it for idea generation.

As a concrete example, if a user inputs the theme “For new business development, consider introducing new technologies,” the generative AI method can generate the following prompt sentence.

Example of a prompt statement: “I am a member of the

I'm thinking about introducing new technology for new business development. What technologies should we introduce as an original approach?”

Based on this prompt statement, the generative AI model generates new ideas and provides them to the user. When the user presses the “Originally” rating button, the generative AI means generates a new idea, such as “What creative business can be made possible by the introduction of new technology?

In this way, a system in which the generative AI provides new ideas based on the user's emotional state and evaluation criteria is realized.

The flow of the identification process in example of application 2 is described in FIG. 20.

### Step 1:

Users launch the application installed on their smartphones and enter a brainstorming theme.

Input: Theme entered by user (e.g., “For new business development, consider introducing new technologies”)

Output: The input theme is sent to the server.

Specific action: The user enters a theme in the application's input field and presses the

“Submit” button.

### Step 2:

The server uses generative AI methods to generate ideas and questions related to the input theme.

Input: User entered theme

Outputs: generated ideas or questions (e.g., “What creative projects could be made possible by the introduction of new technologies?”)

Specific behavior: The server prompts a GPT-3 or other generative AI model for a theme and retrieves the generated ideas.

### Step 3:

The generated ideas are displayed on the user's smartphone.

Input: generated ideas and questions

Output: Ideas and questions displayed on the smart phone screen

Specific behavior: The server sends the generated idea to the smartphone and the application displays it.

### Step 4:

The user presses a rating button for the ideas displayed, such as “original,” “realistic,” or “review from a manager's point of view.

Input: User's rating (e.g., “creatively”)

Output: The evaluation results are sent to the server.

Specific action: The user selects the “Rate” button and presses the “Submit” button.

### Step 5:

The server uses the emotion engine means to detect the user's emotional state.

Input: emotional data of the user (e.g., input from camera or microphone)

Output: Detected emotional state (e.g., “excited”)

Specific behavior: The server analyzes the user's emotional state using an emotion detection library such as Affectiva.

### Step 6:

The means of adjusting the evaluation criteria based on the emotional state operates.

Input: Detected emotional state

Output: Adjusted evaluation criteria (e.g., “creatively”)

Specific behavior: The server re-sets the evaluation criteria according to the emotional state.

### Step 7:

The server generates new ideas based on evaluation criteria.

Input: adjusted evaluation criteria, initial ideas

Outputs: new ideas (e.g., “What creative projects could be made possible by the introduction of new technologies?”)

Specific behavior: The server again prompts the generative AI model to generate new ideas.

### Step 8:

New ideas are displayed on the user's smartphone.

Input: Newly generated ideas

Output: new ideas displayed on smartphone screens

Specific behavior: The server sends new ideas to the smartphone and the application displays them.

### Example 3

Next, example 3 of exemplary embodiment of implement will be described. In the following description, data processing device 12 is referred to as the “server” and headset-type terminal 314 is referred to as the “terminal.

Conventional brain-streaming support systems mainly generate ideas based on input information from the user, and could not utilize the minutes data from web conferencing tools. As a result, important information and ideas discussed during meetings were not fully utilized, making efficient idea generation difficult. In addition, there was insufficient support for evaluation and expansion of generated ideas, making it difficult for users to effectively utilize the generated ideas.

The specific processing by the specific processing unit 290 of the data processing device 12 in Example 3 is realized by the following means. In this invention, the server has a means for inputting themes from users, a means for generating ideas and questions related to the themes, a means for evaluating the generated ideas to support expansion, a means for input from the WebUI and a means for linking with a web conferencing tool, a means for acquiring minutes data from the web conferencing tool means to acquire the minutes data from the web conferencing tool, means to analyze the acquired minutes data and extract important information, means to generate and send prompt sentences to the generative AI model based on the extracted information, and means to store the generated ideas. This makes it possible to efficiently generate new ideas using the minutes data from the web conferencing tool, and to support evaluation and expansion on the generated ideas.

The “user input method” is an interface that allows users to input information about a particular theme or topic.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link the system with web conferencing tools to obtain and utilize information from during a meeting.

The “means to retrieve meeting minutes data from a web conferencing tool” is a function to automatically retrieve meeting minutes data from a web conferencing tool.

The “means to analyze acquired minutes data and extract important information” is a function to analyze acquired minutes data and extract important information discussed during the meeting.

The “means for generating and sending prompt sentences to the generative AI model based on the extracted information” is a function for generating and sending prompt sentences to the generative AI model based on the extracted information.

The “means of storing generated ideas” is a function for storing ideas generated from the generative AI model in a database or other location.

This invention is a system including means for inputting themes from users, generative AI means, evaluation means, input means from the WebUI, means for linking with a web conferencing tool, means for acquiring minutes data from the web conferencing tool, means for analyzing the acquired minutes data and extracting important information, means for generating prompt statements based on the extracted information to a generative AI model The system includes a means to generate and send prompt sentences to a generative AI model based on the extracted information, and a means to store the generated ideas.

### Server Operation

The server first acquires the minutes data from the web conferencing tool (e.g., a common web conferencing tool). The API of the web conferencing tool is used for this acquisition. The acquired minutes data are analyzed using a natural language processing library (e.g., NLTK or SpaCy). As a result of the analysis, important keywords and phrases are extracted.

Next, the server generates prompt sentences to be sent to the generative AI model (e.g., OpenAI's GPT-3) based on the extracted information. For example, if the minutes contain the information “New business development requires the introduction of new technologies,” the server generates the prompt sentence “What new businesses can be developed through the introduction of new technologies?

The generated prompt sentences are sent to the generative AI model to generate new ideas. The generated ideas are stored in a database by the server. The stored ideas are later provided to users.

### Terminal Operation

The terminal sends information entered by the user through the WebUI to the server. For example, the user enters specific questions or requests regarding new business development. The terminal also receives the ideas generated by the server and displays them to the user. The user can provide further feedback based on the displayed ideas, which are also sent from the terminal to the server.

### User Behavior

Users enter information about new business development through the WebUI. For example, the user enters a specific question such as, “We are seeking ideas regarding the introduction of new technology. The user also uses a web conferencing tool to conduct a meeting, and the minutes of that meeting are captured by the system. The user reviews the ideas generated and provides feedback as needed.

### Concrete Example

1. minutes of the meeting: “New business development requires the introduction of new technologies.”

2. prompt statement for the generated AI model: “What new businesses can be developed by introducing new technologies?

A generative AI model might generate the following ideas based on this prompt sentence

Developing an AI-based customer support system.”

“Building a Supply Chain Management System Using Blockchain Technology.”

Thus, the system utilizes the minutes data of the web conferencing tool to generate new ideas using a generative AI model. This allows users to efficiently obtain new business ideas. The flow of the identification process in Example 3 is described in FIG. 21.

### Step 1:

The server obtains the meeting minutes data from the web conferencing tool. Specifically, it downloads the meeting minutes data using the API of the Web conferencing tool. The input is authentication information such as meeting ID and API key, and the output is the acquired minutes data.

### Step 2:

The server analyzes the acquired minutes data. Specifically, text analysis is performed using a natural language processing library (e.g., NLTK or SpaCy). The input is the minutes data, and the output is the extracted important keywords and phrases.

### Step 3:

The server generates prompt sentences to be sent to the generative AI model based on the analysis results. For example, if the information includes “New business development requires the introduction of new technology,” the server generates the prompt sentence “What new business can be developed by introducing new technology? The input is the extracted keywords or phrases and the output is the generated prompt sentence.

### Step 4:

The server sends the generated prompt text to the generative AI model. Specifically, it sends an API request to the generative AI model (e.g., OpenAI's GPT-3). The input is the prompt sentence and the output is the generated idea.

### Step 5:

The server stores the ideas returned from the generative AI model in a database. Specifically, it executes an INSERT query against the database. The input is the generated ideas, and the output is confirmation information for the stored ideas.

### Step 6:

The terminal sends the information entered by the user through the WebUI to the server. Specifically, the user enters information into the input form and presses the submit button. The input is the information entered by the user and the output is the information sent to the server.

### Step 7:

The terminal receives the ideas generated by the server and displays them to the user. Specifically, it receives the response from the server and displays it in the WebUI. The input is the ideas received from the server and the output is the ideas displayed to the user.

### Step 8:

The terminal sends the feedback provided by the user to the server. Specifically, the user enters information into the feedback form and presses the submit button. The input is the feedback entered by the user and the output is the feedback sent to the server.

### Step 9:

Users enter information about new business development through the WebUI. Specifically, the user enters information in the input form and presses the submit button. The input is the information entered by the user and the output is the information sent to the terminal.

### Step 10:

The user uses a web conferencing tool to conduct a meeting. Specifically, the meeting is initiated and the minutes are automatically recorded. The input is the audio and text of the meeting, and the output is the recorded minutes data.

### Step 11:

The user reviews the generated ideas displayed on the terminal and provides feedback. Specifically, the user evaluates the displayed ideas, enters information in the feedback form, and presses the submit button. The input is the displayed ideas and user feedback, and the output is the feedback sent to the terminal.

### Example of Application 3

Next, example 3 of application of example of implement 3 will be described. In the following description, data processing device 12 is referred to as the “server” and headset-type terminal 314 is referred to as the “terminal.

In conventional brain-streaming support systems, themes are input by the user and ideas are generated by a generative AI, but the quality and realism of the ideas generated are limited because the system does not fully utilize the content of the discussions at the meeting and the emotional information of the participants. In addition, the evaluation of generated ideas and suggestions tend to be subjective, making it difficult to efficiently select the most useful ideas.

The specific processing by specific processing unit 290 of data processing device 12 in example of application 3 is realized by the following means. In this invention, the server has a means of inputting themes from users, a means of generating ideas and questions related to the themes, a means of evaluating the generated ideas to support expansion, a means of input from the WebUI and a means of linking with web conferencing tools, a means of analyzing the content of the minutes and extracting keywords and emotional information, an idea generation means to generate new ideas based on the extracted information, and an evaluation and suggestion means to evaluate the generated ideas and suggest the most useful ideas. This enables the generation of high-quality, realistic ideas based on the content of the discussions in the meeting and the emotional information of the participants, as well as efficient evaluation and suggestion of ideas.

The “user input method” is an interface that allows users to input discussion and idea generation themes to the system.

Generative AI means” is an artificial intelligence function that generates relevant ideas and questions based on input themes.

The “evaluation means” is a function for extending and evaluating the ideas generated.

The “means of input from the WebUI” is the means by which input is received from the user through the web user interface.

The “means of interfacing with web conferencing tools” is the means of interfacing the system with web conferencing tools to capture meeting minutes and other information.

The “analysis method for analyzing the content of minutes” is a function for analyzing the content of minutes imported from a web conferencing tool and extracting important keywords and emotional information.

The “idea generation means” is a function to generate new ideas based on the information extracted by the analysis means.

The “evaluation and suggestion means” is a function to evaluate the generated ideas and suggest the most useful ideas.

The following system configuration is an exemplary embodiment of this invention.

### System Configuration

The system includes means for theme input from users, generative AI, evaluation, input from the WebUI, integration with web conferencing tools, analysis of the content of the proceedings, idea generation, and evaluation suggestions.

### Program Processing

The server will perform the following

1. means of user input on the theme: 1.

Provide an interface for users to enter discussion and idea generation topics for the system. For example, use a form that runs on a web browser.

2. generative AI measures: (1)

Generate relevant ideas and questions based on the input theme. Generative AI models such as OpenAI's GPT-3 are used here.

3. evaluation instruments:

Extensions and evaluations are performed on the generated ideas. Evaluation is done using evaluation buttons such as “original,” “realistic,” “review from a manager's perspective,” etc.

4. input means from WebUI:

Receive input from the user through the web user interface. For example, a rating is entered by a user clicking on the rating button.

5. means of interfacing with web conferencing tools:

Integrate the system with a web conferencing tool (e.g., Zoom) to capture meeting minutes and other information; use the API to automatically retrieve meeting minutes.

6. analytical means for analyzing the content of the minutes:

Analyze the content of minutes imported from web conferencing tools to extract important keywords and emotional information. Here, natural language processing libraries such as TextBlob are used.

7. idea generation tools

Generate new ideas based on the information extracted by the analysis method.

Generate prompt sentences and generate ideas using a generative AI model.

8. proposed means of evaluation

Evaluate the generated ideas and suggest the most useful ideas. Based on the evaluation results, present the highest rated ideas to the user.

### Concrete Example

For example, if the minutes of a Zoom meeting state that “a new robot arm needs to be installed,” the analysis method extracts this information and sends the following prompt statement to the generative AI model.

Example of a prompt statement: “I am a member of the

Key words in the proceedings: new robot arm, introduction, production efficiency

Emotional information: Positive

Use this information to generate ideas for new manufacturing techniques and production line improvements.

The generative AI model generates ideas about “how the new robot arm will improve production efficiency,” based on this prompt sentence. The generated ideas are evaluated by the evaluation method, and the most useful ideas are suggested to the user.

In this way, high-quality, realistic ideas can be generated based on the content of the meeting discussions and the emotional information of the participants, and ideas can be efficiently evaluated and proposed.

The flow of the identification process in example of application 3 is described in FIG. 22.

### Step 1:

The user enters a theme. The user uses a form on a web browser to enter a discussion or idea generation theme. The entered themes are sent to the server and stored in the database.

### Step 2:

The server generates ideas using generative AI methods. The server sends prompt statements to a generative AI model (e.g., OpenAI's GPT-3) based on the stored themes to generate related ideas and questions. The generated ideas are returned to the server and stored in a database.

### Step 3:

The server provides the means of evaluation. Users review the generated ideas through the web UI and enter their evaluations by clicking on evaluation buttons such as “original,” “realistic,” “review from management's point of view,” etc. The evaluation results are sent to the server and stored in a database.

### Step 4:

The server uses a means of interfacing with the web conferencing tool to capture the minutes of the meeting. The server automatically retrieves the meeting minutes using the API of the web conferencing tool (e.g., Zoom). The retrieved minutes are stored on the server.

### Step 5:

The server analyzes the content of the minutes. The server analyzes the stored minutes and extracts important keywords and emotional information using a natural language processing library such as TextBlob. The extracted information is stored on the server.

### Step 6:

The server generates new ideas using idea generation methods. The server sends prompt sentences to the generative AI model based on the extracted keywords and emotional information to generate new ideas. The generated ideas are returned to the server and stored in the database.

### Step 7:

The server evaluates and suggests ideas using the evaluation and suggestion method. The server evaluates the generated ideas and suggests the most useful ideas to the user. Based on the evaluation results, the highest rated idea is presented to the user.

The specific processing unit 290 transmits the results of the specific processing to the headset-type terminal 314. At headset-type terminal 314, control unit 46A causes speaker 240 and display 343 to output the results of the specific processing. Microphone 238 acquires audio indicating user input to the results of the specific processing. The control unit 46A transmits the voice data indicating the user input acquired by the microphone 238 to the data processing device 12. In data processing device 12, specific processing unit 290 acquires the voice data.

The data generation model 58 is a so-called Generative AI (Artificial Intelligence). An example of a data generation model 58 is a generative AI such as ChatGPT (Internet Search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the headset-type terminal 314.

### Fourth Exemplary Embodiment

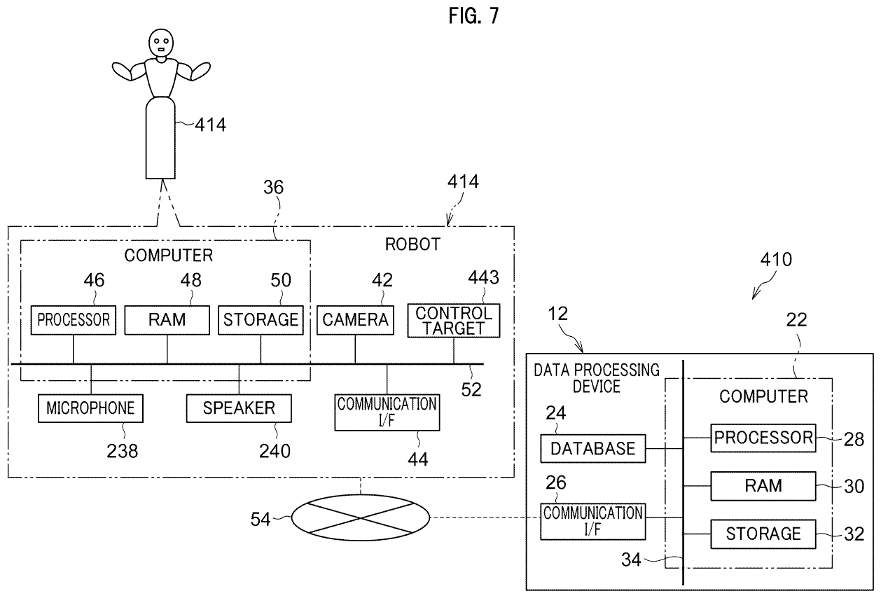

FIG. 7 shows an example of implement of a data processing system 410 for the fourth exemplary embodiment.

As shown in FIG. 7, the data processing system 410 has a data processing device 12 and a robot 414. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Robot 414 has computer 36, microphone 238, speaker 240, camera 42, communication I/F 44, and control target 443. The computer 36 has a processor 46, RAM 48, and storage 50. Processor 46, RAM 48, and storage 50 are connected to bus 52. The microphone 238, speaker 240, camera 42, and control target 443 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and images the surroundings of the user 20 (for example, the imaging range defined by an angle of view equivalent to the field of view of an average healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

The control target 443 includes the display unit, the LEDs in the eyes, and the motors that drive the arms, hands, and feet, etc. The posture and gestures of robot 414 are controlled by controlling the motors of the arms, hands, and feet, etc. Some of the emotions of the robot 414 can be expressed by controlling these motors. The facial expressions of the robot 414 can also be expressed by controlling the light emission state of the LEDs in the eyes of the robot 414.

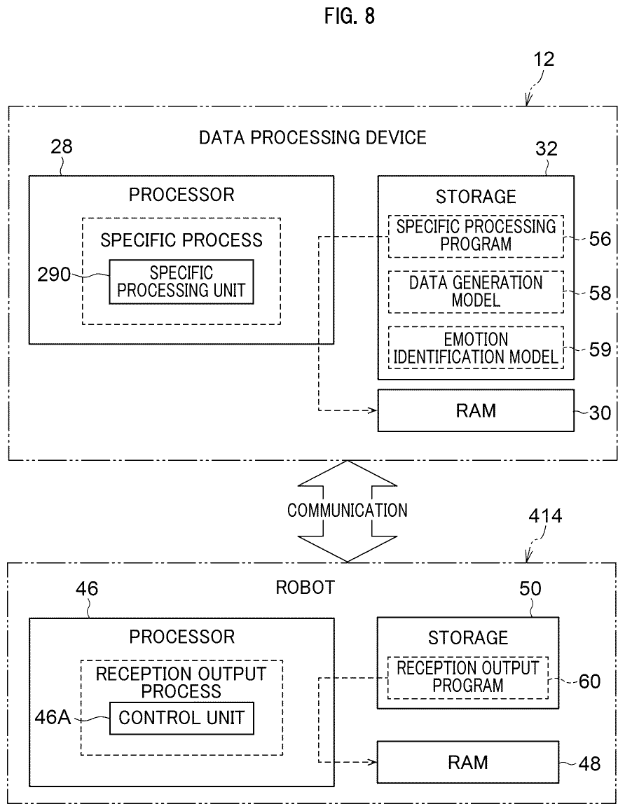

FIG. 8 shows an example of the key functions of the data processing device 12 and robot 414. As shown in FIG. 8, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

In robot 414, the reception output process is performed by processor 46. The reception output program 60 is stored in the storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48.

Next, the specific processing by the specific processing unit 290 of the data processing device 12 is described.

### Example of Implement 1

The brain streaming support system uses a generative AI to generate relevant ideas and questions based on the user's theme input. Specifically, if the user inputs “new business development” as a theme, the generative AI generates questions such as “What are the market needs for new business development?” and “What resources are needed for new business development?” and ideas such as “For new business development, utilize the existing customer base” and “For new business development, consider introducing new technology. Generate ideas such as.

### Example of Implement 2

For generated ideas, the system provides evaluation buttons such as “original,” “realistic,” “review from a manager's point of view,” etc., to support the expansion of ideas. Specifically, if a user presses the “original” evaluation button for the generated idea, “Consider introducing new technologies to develop new businesses,” the generative AI generates a new idea, such as “What kind of original business will be possible by introducing new technologies?

### Example of Implement 3

The system will utilize not only input from the WebUI, but also information from the minutes of the meeting in conjunction with the web conferencing tool. Specifically, the system takes the minutes of a meeting held with a web conferencing tool such as Zoom, and the generative AI generates new ideas based on the information contained in the minutes. For example, if the minutes include the information that “introduction of new technology is necessary for new business development,” the generative AI generates new ideas based on this information, such as “What kind of new business can be developed by introducing new technology?

The following is a description of the process flow for each example of implement.

### Example of Implement 1

Step 1: The user accesses the Brainstorming Support System WebUI and enters “New Business Development” as the theme.

Step 2: The system's generative AI receives thematic input from the user and generates relevant ideas and questions. Specifically, the system generates questions such as “What are the market needs for new business development?” and “What resources are needed for new business development?” as well as ideas such as “For new business development, utilize the existing customer base” and “For new business development, consider introducing new technologies”.

Step 3: Present the generated ideas and questions to the user. The user can add his/her own thoughts and evaluate the ideas presented.

### Example of Implement 2

Step 1: The user presses the “Originally” rating button for the generated idea “For new business development, consider introducing new technologies.

Step 2: The system's generative AI receives evaluation input from the user and generates new ideas based on the evaluation. Specifically, the system generates new ideas such as “What kind of creative business will be possible through the introduction of new technologies?

Step 3: Present the generated new ideas to the user. The user can add his/her own thoughts and evaluate the ideas presented.

### Example of Implement 3

Step 1: The user conducts a meeting using a web conferencing tool such as Zoom, and the minutes of the meeting are imported into the system.

Step 2: The system's generative AI analyzes information from the minutes and generates new ideas based on this information. For example, if the minutes of the meeting include the information that “introduction of new technology is necessary for new business development,” the generative AI generates new ideas based on this information, such as “What kind of new business can be developed by introducing new technology?

Step 3: Present the generated new ideas to the user. The user can add his/her own thoughts and evaluate the ideas presented.

### Example 1

Next, example 1 of exemplary embodiment of implement will be described. In the following description, data processing device 12 is referred to as the “server” and robot 414 is referred to as the “terminal.

Conventional brain-streaming support systems lack the ability to automatically generate specific ideas and questions related to a theme when a user enters a theme. They also lack the means to evaluate and further expand on the generated ideas and questions. Furthermore, there is insufficient integration with web conferencing tools, making it difficult to effectively utilize the information obtained during meetings.

The specific processing by the specific processing unit 290 of the data processing device 12 in Example 1 is realized by the following means.

In this invention, the server includes means for inputting themes from the user, converting the themes into prompt sentences, sending the prompt sentences to the generative AI model, receiving output from the generative AI model, displaying the generated ideas and questions to the user, input from the WebUI means and means of interfacing with the web conferencing tool. This allows for the automatic generation of specific ideas and questions based on user input on a theme, which can then be evaluated and expanded upon. In addition, the linkage with the Web conferencing tool allows the user to effectively utilize the information obtained during the meeting.

The “user input method” is a means of providing an interface for users to input brainstorming themes.

The “means of converting the theme into a prompt sentence” refers to the means of converting the theme input by the user into a prompt sentence in a format suitable for the generated AI model.

The “means for transmitting the prompt text to the generating AI model” is a means for transmitting the generated prompt text to the generating AI model.

A “means of receiving output from the generative AI model” is a means of receiving ideas or questions returned by the generative AI model.

A “means of displaying generated ideas and questions to the user” is a means of displaying ideas and questions received from the generated AI model to the user.

The “means of input from the WebUI” is the means by which the user provides input through the Web interface.

The “means of linking with web conferencing tools” is a means of obtaining information in conjunction with web conferencing tools and utilizing it within the system.

### Exemplary Embodiment of the Invention

This invention is a brain-streaming support system that allows users to input a theme, which is then used to generate relevant ideas and questions using a generative AI model. An exemplary embodiment of this system is described below.

### System Configuration

The system consists of the following major components
1. means for users to input themes
2. means of converting such themes into prompt text
3. means of transmitting such prompt sentences to a generative AI model
4. means of receiving output from the generated AI model
5. a means of displaying the generated ideas and questions to the user
6. input method from WebUI
7. means of cooperation with web conferencing tools

### Hardware and Software Used

Hardware: servers, terminals (user's PC or smartphone)
Software: Generative AI model (e.g. GPT-4), Web browser, HTML, JavaScript, Python

### Program Processing

The user enters a theme through a web browser. For example, the user enters the theme “New Business Development”. The terminal sends this theme to the server. The server converts the received theme into a prompt text. Specifically, the server generates the prompt statement, “Please generate questions and ideas about ‘new business development’.” The prompt sentence “Please generate questions and ideas about ‘new business development” is generated.

The server sends this prompt sentence to the Generative AI model (GPT-4). The Generative AI model generates relevant questions and ideas based on the prompt sentence. For example, “What are the market needs for new business development?” or “For new business development, we will leverage our existing customer base” will be generated.

The generated questions and ideas are sent to the terminal via the server. The terminal displays this information on a web browser, and users can brainstorm based on this information.

### Concrete Example

The user enters the theme “New Business Development”. The terminal sends this theme to the server. The server generates the prompt “Please generate questions and ideas about ‘new business development” and sends it to the generative AI model (GPT-4), and sends it to the generative AI model (GPT-4). The generative AI model will ask questions such as “What are the market needs for new business development?” and “Use the existing customer base for new business development. The server receives these generated results and sends them to the terminal. The terminal displays the received questions and ideas on the browser, and the user brainstorms based on them.

In this way, users can gain a variety of perspectives and ideas related to the topic and receive assistance in brainstorming.

The flow of the identification process in Example 1 is described in FIG. 11.

### Step 1:

The user enters a theme.

The user accesses the interface on the web browser and enters the theme they wish to brainstream in the theme entry field. For example, enter “new business development. The entered theme is temporarily stored in the memory of the terminal.

### Step 2:

The terminal sends the theme to the server.

The terminal sends the theme entered by the user to the server as an HTTP request. This request is made using the JavaScript fetch function. The input data is the theme “New Business Development” and the output is a request sent to the server.

### Step 3:

The server converts the theme into a prompt statement.

The server generates prompt statements based on the theme received. For example, for the theme “New Business Development,” the server generates the prompt statement, “Please generate questions and ideas about ‘New Business Development’.” The input data is the theme “New Business Development” and the output is the theme “New Business Development”. The input data is the theme “New Business Development” and the output is the prompt sentence “Please generate questions and ideas for ‘New Business Development’. The output is “Please generate questions and ideas about ‘new business development”.

### Step 4:

The server sends prompt statements to the generating AI model.

The server sends the generated prompt statements to the generating AI model (GPT-4). This communication is done using API requests. The input data is the prompt sentence and the output is the request sent to the generation AI model.

### Step 5:

Generative AI models generate questions and ideas.

The Generative AI model generates relevant questions and ideas based on the prompt sentences received. For example, it can generate questions such as “What is the market need for new business development?” or “Leverage the existing customer base for new business development”. The input data are the prompt sentences and the output are the questions and ideas generated.

### Step 6:

The server receives the generated questions and ideas.

The server receives questions and ideas returned from the generative AI model. This data is received in JSON format. The input data is the output from the data generation model and the output is the data received by the server.

### Step 7:

The server sends questions and ideas to the terminal.

The server sends the received questions or ideas to the terminal as an HTTP response. This response is also in JSON format. The input data are the questions and ideas generated, and the output is the data sent to the terminal.

### Step 8:

The terminal displays questions and ideas to the user.

The terminal displays the questions and ideas received from the server on the browser.

Users can brainstorm based on this information. The input data is the response from the server and the output is the display on the browser.

### Example of Application 1

Next, example of application 1 of example of implement 1 will be described. In the following description, the data processing device 12 is referred to as the “server” and the robot 414 is referred to as the “terminal.

Conventional brain-streaming support systems have the ability to generate ideas and questions based on themes entered by the user, but lack support specific to a particular industry or application. In particular, they lack the ability to generate specific ideas and questions to improve production efficiency in a factory, making it difficult for factory managers and engineers to efficiently find ways to improve production lines.

The specific processing by the specific processing unit 290 of the data processing device 12 in example of application 1 is realized by the following means.

In this invention, the server includes theme input means from the user, generative AI means to generate ideas and questions related to the theme, evaluation means to support expansion on the generated ideas, input means from the WebUI and with web conferencing tools, and learning means to improve production efficiency in the factory. The system includes means to generate ideas and questions for improving production efficiency in the factory, and learning means to provide feedback on the generated ideas and questions and reflect them in the next and subsequent generations. This enables factory managers and engineers to efficiently generate specific ideas and questions to improve production efficiency and find improvement measures.

The “user input method” is an interface that allows users to enter a specific theme or issue.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link with web conferencing tools to share information and utilize data such as meeting minutes.

The “means of generating ideas and questions to improve production efficiency in a factory” is the ability to generate ideas and questions specifically designed to improve production efficiency in a factory.

A “learning method that provides feedback on generated ideas and questions and reflects it in the next generation” is a function that collects feedback from users, which is then used by the generative AI to generate ideas and questions for the next and subsequent generations.

As an exemplary embodiment of this invention, a brain-streaming support system for improving production efficiency in a factory is described in detail.

### System Configuration

The system includes the following major hardware and software components

Server: hosts a generative AI model, receives thematic input from users, and generates relevant ideas and questions.

User Terminal: Device (e.g., PC, tablet) for plant managers and engineers to enter topics and review generated ideas and questions.

Web User Interface (WebUI): An interface for users to enter themes and view generated ideas and questions.

Web conferencing tools: Tools for capturing meeting minutes and interfacing with the system.

### Program Processing

The server performs data processing and data computation using the following means

1. theme input method: The user enters a theme through the WebUI. For example, the user enters the theme of “improving production line efficiency”.

Generative AI means: Generate relevant ideas and questions based on input themes using a generative AI model such as OpenAI's GPT-3. The generated ideas and questions are processed on the server and sent to the user's terminal.

Means of evaluation: Users evaluate the ideas and questions generated. The evaluation results are sent to the server and will be reflected in the next and subsequent generations.

4. means of input from the WebUI: users provide feedback through the WebUI to evaluate the ideas and questions generated.

5. means of linking with web conferencing tools: Information is obtained from the minutes of the web conferencing tool and used as training data for the generative AI model.

6. learning means: update the generative AI model based on user feedback and reflect it in the generation of ideas and questions in the next and subsequent sessions.

### Concrete Example

For example, if a factory manager inputs the theme “improving production line efficiency,” the generative AI model will generate the following ideas and questions.

Where are the bottlenecks in the production line?”

What processes can be automated?”

Would changing the layout of the production line increase efficiency?”

These ideas and questions are displayed in the WebUI on the user's terminal, and the user can provide ratings and feedback on them.

### Example of Prompt Text

Topic: Improving production line efficiency

Generate relevant ideas and questions.

In this way, specific ideas and questions can be efficiently generated to improve production efficiency in the plant, allowing managers and engineers to find ways to improve.

The flow of the identification process in Example of Application 1 is described in FIG. 12.

### Step 1:

The user enters the theme through the WebUI.

Input: The user enters a theme, such as “improving the efficiency of the production line”.

Output: The input theme is sent to the server.

Specific action: The user enters the theme in the input field of the WebUI and clicks on the “Submit” button.

### Step 2:

The server uses a generative AI model to generate relevant ideas and questions based on the input themes.

Input: The server receives the theme submitted by the user.

Output: list of ideas and questions generated by the generative AI model.

Specific behavior: The server sends themes as prompt sentences to OpenAI's GPT-3 and other generative AI models, and receives generated ideas and questions.

### Step 3:

The server sends the generated ideas and questions to the user terminal.

Input: a list of ideas and questions generated by the generative AI model.

Output: Ideas and questions displayed on the user's terminal.

Specific operation: The server sends the generated ideas and questions to the WebUI of the user terminal for display.

### Step 4:

Users evaluate the ideas and questions generated.

Input: User evaluates the ideas and questions displayed.

Output: Evaluation results are sent to the server.

Specific behavior: User clicks on evaluation buttons on the WebUI, such as “original,” “realistic,” “review from management's point of view,” etc.

### Step 5:

The server receives the evaluation results from the user and stores them as training data to be reflected in the next generation.

Input: Evaluation results sent by the user.

Output: The evaluation results are stored and used as training data for the generative AI model.

Specific operation: The server stores the evaluation results in a database and provides them as feedback to the learning algorithm of the generative AI model.

### Step 6:

The server retrieves information from the minutes of the web conferencing tool and uses it as training data for the generative AI model.

Input: Minutes data from web conferencing tools.

Output: the minutes data is used as training data for the generative AI model.

Specific operation: The server obtains the minutes data through the API of the web conferencing tool and provides it to the training algorithm of the generative AI model.

In this way, specific ideas and questions can be efficiently generated to improve production efficiency in the plant, allowing managers and engineers to find ways to improve.

### Example 2

Next, example 2 of exemplary embodiment of implement will be described. In the following description, data processing device 12 is referred to as the “server” and robot 414 is referred to as the “terminal.

Conventional brainstorming support systems have a problem in that it is difficult to obtain appropriate feedback and expansion on ideas entered by users. In addition, the evaluation perspective was limited, making it difficult to expand on ideas from multiple perspectives. Furthermore, there was a lack of concrete means to improve the quality and relevance of the ideas generated.

The specific processing unit 290 of the data processing device 12 in Example 2 is realized by the following means.

In this invention, the server includes theme input means from the user, generative AI means to generate ideas and questions related to the theme, evaluation means to support expansion on the generated ideas, means to generate prompt sentences based on the evaluation, means to send the generated prompt sentences to the generative AI model means, a means to return a response from the generated AI model to the user, and means for input from the WebUI and linkage with the web conferencing tool. This allows for evaluation and expansion from multiple perspectives on user input ideas, thereby enhancing the quality and relevance of the generated ideas.

The “user input method” is an interface for users to enter ideas and themes into the system.

Generative AI means” is an artificial intelligence function that generates relevant ideas and questions based on a theme entered by the user.

The “evaluation means” is an interface for users to evaluate the generated ideas, and includes evaluation buttons such as “original,” “realistic,” and “review from a manager's perspective.

The “means of generating prompt sentences” is the ability to create prompt sentences for transmission to the generative AI model based on the user's ratings.

The “means of transmitting to the generated AI model” is the communication means for transmitting the generated prompt sentences to the generated AI model.

The “means of returning responses from the generative AI model to the user” is the ability to return to the user new ideas and responses received from the generative AI model.

The “means of input from the WebUI” is the means by which users enter information into the system through the Web interface.

The “means of linking with web conferencing tools” is a function to link with web conferencing tools to utilize information such as meeting minutes.

This invention is a system that supports the evaluation and expansion of ideas by utilizing a generative AI model based on themes entered by the user. An exemplary embodiment of this system is described below.

First, the user uses a terminal (e.g., PC or smartphone) to enter a theme through the system's WebUI. For example, the user would enter, “For new business development, consider the introduction of new technologies.

Next, the user presses one of the rating buttons for the theme entered, such as

“Originally,” “Realistically,” or “Review from Management's Perspective.” For example, the user presses the “Originally” button.

The server generates the appropriate prompt sentence based on the evaluation button pressed by the user. For example, if the button “Creatively” is pressed, the server will generate the prompt sentence “What creative business will be possible with the introduction of the new technology?

Next, the server sends the generated prompt sentence to the generating AI model (e.g., OpenAI's GPT-4). Specifically, the prompt sentences are sent through the API.

The generative AI model generates new ideas based on the prompt sentences it receives. For example, in response to the prompt sentence “What kind of creative business will be possible through the introduction of new technology?”, the model generates ideas such as “A new logistics service that utilizes AI-based automated driving technology.

Finally, the server returns the new ideas received from the generative AI model to the user. Specifically, the new ideas are displayed on the terminal screen.

The system allows users to evaluate and expand on the ideas they enter from multiple perspectives, enhancing the quality and relevance of the ideas generated. In addition, the system can be integrated with web conferencing tools to utilize information from meeting minutes.

As a specific example, consider a case in which a user enters “Consider introducing new technology for new business development” and presses the “Review from Management's Perspective” evaluation button. In this case, the server generates the prompt sentence “What are the benefits and risks of introducing new technology from a manager's perspective? The generative AI model generates new ideas and reviews based on this prompt sentence, and the server returns the results to the user.

Examples of prompt statements include the following

What kind of creative projects will be possible through the introduction of new technologies?”

What are the benefits and risks of implementing new technologies from a management perspective?”

What is the practical impact of introducing new technologies?”

In this way, users can evaluate and further extend their ideas using the generative AI model.

The flow of the identification process in Example 2 is described in FIG. 13.

### Step 1:

The user enters the theme in the input form on the terminal.

Input: Theme to be entered by user (e.g., “For new business development, consider introducing new technologies”)

Output: The input theme is sent to the server.

Specific operation: The user uses the WebUI on the terminal to enter the theme and press the submit button.

### Step 2:

The user presses the “Evaluate” button.

Input: User-selected rating button (e.g., “Creatively”)

Output: The selected evaluation is sent to the server.

Specific action: The user presses one of the evaluation buttons for the entered theme, such as “original,” “realistic,” or “review from a manager's point of view.

### Step 3:

The server generates a prompt statement.

Input: User entered theme and rating button selection information

Output: Generated prompt text (e.g., “What creative business will be possible with the new technology?”)

Specific behavior: The server generates the appropriate prompt sentence based on the evaluation button pressed by the user.

### Step 4:

The server sends prompt statements to the generated AI model.

Input: Generated prompt text

Output: Prompt statements sent to the generated AI model Specific behavior: The server sends the generated prompt sentences to the generated

AI model (e.g., OpenAI's GPT-4) via API.

### Step 5:

Generative AI models generate new ideas.

Input: Prompt sentences sent to the generated AI model

Output: New ideas generated (e.g., “New logistics services using AI-based automated driving technology”)

Specific behavior: The generative AI model generates new ideas based on the prompt sentences it receives.

### Step 6:

The server returns the generated ideas to the user.

Input: new ideas received from the generative AI model

Output: New ideas displayed on the user's terminal

Specific operation: The server sends new ideas received from the generated AI model to the user's terminal and displays them on the screen.

### Example of Application 2

Next, example of application 2 of example of implement 2 will be described. In the following description, the data processing device 12 is referred to as the “server” and the robot 414 is referred to as the “terminal.

Conventional brainstorming support systems lacked concrete means to further expand on user-generated ideas. They also lacked a function to assist content creators in generating new content ideas and further extending them using a rating button. This made it difficult to improve creativity and efficient idea generation.

The specific processing by the specific processing unit 290 of the data processing device 12 in example of application 2 is realized by the following means.

In this invention, the server includes theme input means from the user, generative AI means to generate ideas and questions related to the theme, evaluation means to support expansion on the generated ideas, input means from the WebUI and with web conferencing tools, and means for content creators to create new content ideas, means to support further extensions to them using the evaluation buttons, and application means installed on a smartphone or head-mounted display. This enables users to further expand on the ideas they generate using the evaluation buttons, thereby improving creativity and efficient idea generation.

The “user input method” is an interface that allows users to enter specific themes or topics into the system.

A “generative AI means” is an artificial intelligence function that automatically generates relevant ideas and questions based on the input theme at.

The “evaluation means” is an interface that allows users to evaluate the generated ideas “creatively,” “realistically,” or “reviewed from a manager's point of view.

The “means of input from the WebUI” is the means by which a user inputs information through the Web user interface.

The “means of linking with web conferencing tools” is a function to link with web conferencing tools to utilize information such as meeting minutes.

The “means to support content creators in generating new content ideas and further extending them using the evaluation buttons” is a support function for content creators to generate new ideas and further develop them using the evaluation buttons.

An “application means installed on a smartphone or head-mounted display” is a means for using the system through an application installed on a smartphone or head-mounted display.

The system for implementing this invention includes theme input means from the user, generative AI means, evaluation means, input means from the WebUI, means for integration with web conferencing tools, means to help content creators generate new content ideas and further extend them with evaluation buttons means, including application means installed on smartphones and head-mounted displays.

### Description of the System's Program Processing

Hardware and Software Use
Hardware: (1)
Smart phone
HMD
Server
Software: C
OpenAI API
Python Programs
WebUI
Web conferencing tools
Data processing and data computation

### User Operation:

The user uses a smartphone or head-mounted display to enter a theme. For example, the user would enter the theme, “For new business development, consider introducing new technologies.

### Generative AI Processing:

The server generates relevant ideas and questions using a generative AI (e.g., GPT-3) based on the input theme. The ideas generated are, for example, “What kind of creative business will be possible through the introduction of new technologies?

### Operation of Evaluation Instruments:

The user presses a rating button for the generated idea, such as “original,” “realistic,” or “review from a manager's point of view. For example, if the user presses the “Originally” evaluation button, the generative AI will generate a new idea such as “Provide an AI-based personalized content delivery service by introducing new technology.

Integration with WebUI and Web Conferencing Tools:

Users can enter information through the WebUI and utilize information from the minutes of the web conferencing tool for further detailed idea generation.

### Support for Content Creators:

Content creators can further expand on the generated ideas using the evaluation buttons to generate new content ideas. This allows for increased creativity and efficient idea generation.

### Specific Examples and Prompt Statements

### Specific Examples

Initial Idea: “For new business development, consider implementing new technologies.”

User rating: “Ingenious”

Idea generated: “Implement new technologies to provide personalized content delivery services using AI.”

Example of a prompt statement: “I am a member of the

“For new business development, think creatively about introducing new technologies.”

In this way, the generative AI generates new ideas based on user evaluations, and the system supports the creativity of content creators.

The flow of the identification process in example of application 2 is described in FIG. 14.

### Step 1:

The user uses a smartphone or head-mounted display to enter a theme. For example, the user enters the theme, “For new business development, consider introducing new technologies. The entered theme is sent to the server.

Input: User entered theme

Output: Themes sent to server

### Step 2:

The server sends the received themes to the generative AI model (e.g., GPT-3), which generates related ideas and questions. The generative AI model generates prompt sentences based on the theme and outputs corresponding ideas.

Input: Themes sent to the server

Output: Ideas and questions generated by generative AI models

### Step 3:

The server sends the generated ideas and questions to the user's device. The user reviews the generated ideas through a smartphone or head-mounted display.

Input: ideas and questions generated by generative AI models

Output: Ideas or questions sent to the user's terminal

### Step 4:

The user presses an evaluation button for the generated ideas, such as “original,” “realistic,” “review from a manager's perspective,” etc. The evaluation button selection information is transmitted to the server.

Input: Selection information for the evaluation button pressed by the user

Output: Evaluation button selection information sent to the server

### Step 5:

The server generates new prompt sentences based on the selection information of the evaluation button and sends them to the generative AI model again. The generative AI model generates further extended ideas based on the new prompt sentences.

Input: Selection information for the evaluation button sent to the server

Output: Extended ideas generated by the generative AI model

### Step 6:

The server sends the augmented idea to the user's device. The user sees the augmented idea through a smartphone or head-mounted display.

Input: extended ideas generated by generative AI models

Output: Extension ideas sent to the user's terminal

### Step 7:

The user may continue to expand on the idea, pressing further evaluation buttons as needed. This process is repeated until the user is satisfied.

Input: Selection information for the evaluation button pressed by the user

Output: Further extended ideas generated by the generative AI model

In this way, users can further expand on the generated ideas using the evaluation buttons, thus improving creativity and efficient idea generation.

### Example 3

Next, example 3 of exemplary embodiment of implement will be described. In the following description, the data processing device 12 is referred to as the “server” and the robot 414 is referred to as the “terminal.

Conventional brain-streaming support systems allow users to input themes and generate ideas using a generative AI, but they are not fully integrated with web conferencing tools, making it difficult to effectively use the information obtained from meeting minutes. In addition, evaluation and extension support for generated ideas was limited, making it difficult to obtain the specific and practical ideas that users were seeking. This reduced the efficiency and effectiveness of brain streaming.

The specific processing unit 290 of the data processing device 12 in Example 3 is realized by the following means.

In this invention, the server has a means for inputting a theme from the user, a generative AI means for generating ideas and questions related to the theme, an evaluation means for supporting expansion on the generated ideas, a means for input from the WebUI and a means for interfacing with a web conferencing tool, a means for analyzing minutes from the web conferencing tool and The system includes means for extracting important information, means for creating and sending prompt sentences to the generated AI model based on the extracted information, and means for displaying the ideas generated from the generated AI model to the user. This enables the system to effectively utilize information obtained from the minutes of the web conferencing tool to generate specific and practical ideas that users seek.

A “user input method” is a means of providing an interface for a user to enter a specific theme or topic into the system.

Generative AI means” are means that use artificial intelligence technology to generate relevant ideas and questions based on input themes.

The “evaluation means” is a means for users to evaluate and provide feedback on the ideas generated.

The “means of input from the WebUI” is the means by which users enter information into the system through a Web browser.

The “means of linking with a web conferencing tool” is a means of linking a web conferencing tool with the system to capture meeting minutes and other information into the system.

Means for analyzing the minutes of a web conference tool and extracting important information” means a means for analyzing the minutes obtained from a web conference tool and extracting important information from them.

The “means for creating and sending prompt sentences to the generated AI model” is a means for creating and sending appropriate prompt sentences to the generated AI model based on the extracted information.

The “means for displaying ideas generated from the generative AI model to the user” is a means for displaying ideas generated from the generative AI model to the user.

This invention is a brain streaming support system in which the user, terminal, and server work together. Specific exemplary embodiments of this system are described below.

### User Operation

Users access the system's WebUI using a web browser; the WebUI has input fields, such as text boxes and drop-down menus, where users enter information such as “I would like you to generate ideas about new business development.

### Terminal Operation

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by the user's operation. The minutes are saved in text file or PDF format.

### Server Processing

The server receives the uploaded minutes and analyzes them using natural language processing (NLP) technology. Specifically, tools such as Python's NLTK library and SpaCy are used to extract important information from the minutes, such as “New business development requires the introduction of new technologies.

Based on the extracted information, the server creates prompt sentences to be sent to the generative AI model. For example, the server creates a prompt sentence “What new business can be developed by introducing new technology? The created prompt sentence is sent to the generative AI model via the API.

The generative AI model (e.g., OpenAI's GPT-3) generates new ideas based on the prompt text received. The generated ideas are returned to the server in text format.

The server receives the ideas returned from the generated AI model and sends them to the terminal. Communication protocols such as HTTP requests and WebSockets are used for transmission.

### Terminal Display

The terminal displays the ideas received from the server to the user; the WebUI displays the generated ideas, which the user can review. The user can also provide feedback and request the idea be generated again, if necessary.

### Concrete Example

1. a user enters through the WebUI, “I would like you to generate ideas for new business development.

2. the user conducts a meeting using a web conferencing tool and uploads the minutes of the meeting to the system.

3. the server analyzes the minutes and extracts information that “new business development requires the introduction of new technology.

4. the server creates a prompt sentence for the generated AI model, “What new business can be developed by introducing new technology?

5. the generative AI model generates new ideas and displays them to the user through the terminal.

### Example of Prompt Text

“Generate ideas about what new businesses could be developed through the introduction of new technologies.”

Thus, by linking the WebUI with a web conferencing tool, the system utilizes information obtained from the minutes and generates new ideas using a generative AI model. This allows users to obtain concrete and practical ideas. The flow of the specific process in Example 3 is described in FIG. 15.

### Step 1:

The user enters information through the WebUI.

The user opens a web browser and accesses the system's WebUI, which has input fields such as text boxes and drop-down menus where the user enters information such as “I would like you to generate ideas for new business development. The input information is sent to the server. The input data is in text format, which the server receives.

### Step 2:

The terminal uses a web conferencing tool to conduct the meeting.

The user uses a terminal (PC or smartphone) to launch the web conferencing tool and conduct a meeting. The content discussed during the meeting is recorded using the recording and minute taking functions of the conferencing tool. After the meeting is over, the terminal uploads the minutes of the meeting to the server, either automatically or by user operation. The minutes are saved in text file or PDF format. The input data is the minutes file, which the server receives.

### Step 3:

The server analyzes the minutes and extracts important information.

The server receives the uploaded minutes and analyzes them using natural language processing (NLP) technology. Specifically, tools such as Python's NLTK library and SpaCy are used to extract important information from the minutes, such as “new technology is needed for new business development. The input data is the text of the minutes and the output data is the extracted critical information.

### Step 4:

The server creates and sends prompt statements to the generated AI model.

The server creates prompt sentences to be sent to the generative AI model based on the extracted information. For example, the server creates a prompt sentence “What new business can be developed by introducing new technology? The created prompt sentence is sent to the generative AI model via the API. The input data is the extracted information and the output data is the prompt sentence.

### Step 5:

Generative AI models generate new ideas.

The generative AI model (e.g., OpenAI's GPT-3) generates new ideas based on the prompt text received. The generated ideas are returned to the server in text format. The input data is the prompt sentence and the output data is the generated idea.

### Step 6:

The server sends the generated ideas to the terminal.

The server receives the ideas returned from the generated AI model and sends them to the terminal. Communication protocols such as HTTP requests and WebSockets are used for transmission. The input data are the generated ideas and the output data are the ideas sent to the terminal.

### Step 7:

The terminal displays the ideas generated to the user.

The terminal displays the ideas received from the server to the user; the WebUI displays the generated ideas and the user can review them. The user can also provide feedback and ask to generate ideas again, if necessary. The input data are the ideas sent from the server and the output data are the ideas displayed to the user.

### Example of Application 3

Next, example 3 of application of example of implement 3 will be described. In the following description, data processing device 12 is referred to as the “server” and robot 414 is referred to as the “terminal.

Conventional brainstorming support systems have utilized minutes of meetings by inputting themes from users and linking with web conferencing tools, but they do not support the generation of ideas for specific manufacturing processes or efficiency improvements in the factory. Therefore, there is a need to generate ideas for new manufacturing processes and efficiency improvements based on the minutes of in-plant meetings.

The specific processing by specific processing unit 290 of data processing device 12 in example of application 3 is realized by the following means. In this invention, the server includes means for inputting themes from users, means for generating ideas and questions related to the themes, means for evaluating the generated ideas to support expansion, means for inputting information from the WebUI and linking with a web conferencing tool, and means for generating new manufacturing processes and efficiency ideas based on the information The system includes means to capture the minutes of meetings held in the factory and generate ideas for new manufacturing processes and efficiency improvements based on that information. This enables the generation of ideas for new manufacturing processes and efficiency improvements based on the minutes of meetings held in the factory.

The “user input method” is an interface that allows users to input discussion and idea generation themes to the system.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which users enter information into the system through the Web user interface.

The “means of linking with a web conferencing tool” is a means of linking a web conferencing tool with the system to capture meeting minutes and other information into the system.

The “means of capturing minutes of meetings held in the factory and generating ideas for new manufacturing processes and efficiency improvements based on that information” is a function for capturing the minutes of meetings held in the factory into the system and generating ideas for new manufacturing processes and efficiency improvements based on those minutes.

The system for implementing this invention includes means for inputting themes from users, generative AI, evaluation, input from the WebUI, integration with web conferencing tools, and means for capturing minutes of meetings held in the factory and generating ideas for new manufacturing processes and efficiency improvements based on that information.

The server provides an interface for the user to enter themes. Themes entered by the user are sent to the generative AI means to generate related ideas and questions. The generated ideas are evaluated by the user through the evaluation means, and the ideas are expanded or improved based on the evaluation results.

The input method from the WebUI is a means for users to enter information into the system through the web user interface. This allows users to easily input themes and evaluation results.

The means of linking with web conferencing tools is a means to link web conferencing tools with the system and to incorporate meeting minutes and other information into the system. For example, minutes are retrieved from a web conferencing tool such as Zoom, and a generative AI generates new ideas based on this information.

The means to capture the minutes of meetings held in a factory and generate ideas for new manufacturing processes and efficiency improvements based on that information is a function that allows the system to capture the minutes of meetings held in a factory and generate ideas for new manufacturing processes and efficiency improvements based on those minutes. This enables the generation of ideas for new manufacturing processes and efficiency improvements based on the minutes of meetings held in the factory.

As a concrete example, the following prompt sentences can be entered into a generative AI model

### Example of a Prompt Statement:

Minutes: Need to improve efficiency of production lines. In particular, bottlenecks in the assembly process are a problem. Please propose ideas to solve this problem by introducing new technologies and methods.

Based on this prompt sentence, a generative AI might generate the following ideas

1. promote automation of the assembly process by introducing a robot arm.

2. introduce an AI-based quality inspection system for early detection of defective products.

3. redesign the layout of the production line to improve work efficiency.

In this way, ideas for new manufacturing processes and efficiencies can be generated based on the minutes of meetings in the plant.

The flow of the identification process in example of application 3 is described in FIG. 16.

### Step 1:

The user enters a theme. Users enter discussion and idea generation themes through the web user interface. The entered themes are sent to the server. The input data is in text format, and the server receives it and passes it on to the next process.

### Step 2:

The server generates ideas and questions using generative AI methods. The server inputs the themes received in step 1 into the generative AI model and generates relevant ideas and questions. The generative AI model processes data based on the themes and outputs the relevant ideas and questions in text format.

### Step 3:

The server sends the generated ideas to the evaluation method. The server sends ideas and questions output from the generative AI model to the evaluation means. The evaluation means provides an interface for users to evaluate the ideas. The user evaluates the ideas using evaluation buttons such as “original,” “realistic,” “review from a manager's point of view,” etc.

### Step 4:

The user evaluates the ideas. The user evaluates the generated ideas through the evaluation method. The evaluation results are sent to the server and used for the next process. The evaluation data is in numerical or text format, and the server receives it and passes it on to the next process.

### Step 5:

The server extends or improves the idea based on the evaluation results. The server extends or improves ideas based on evaluation results received from users, using the generative AI model again. The generative AI model uses the evaluation results as input data to extend or improve the idea.

### Step 6:

The server retrieves the meeting minutes using a means of interfacing with the web conferencing tool. The server retrieves the meeting minutes from the web conferencing tool (e.g., Zoom). The retrieved minutes are in text format, which the server passes on to the next process.

### Step 7:

The server inputs the minutes into the generative AI method to generate ideas for new manufacturing processes and efficiency improvements. The server inputs the acquired minutes into the generative AI model and generates ideas for new manufacturing processes and efficiency improvements based on the minutes. The generative AI model analyzes the contents of the minutes and outputs related ideas in text format.

### Step 8:

The server provides the generated ideas to the user. The server provides the user with ideas for new manufacturing processes and efficiencies output from the generative AI model. The user reviews these ideas through a web user interface and provides evaluation and feedback as needed.

Further, an emotion engine that estimates the user's emotion may be combined. In other words, the specific processing unit 290 may use the emotion identification model 59 to estimate the user's emotion and perform specific processing using the user's emotion.

### Example of Implement 1

One exemplary embodiment of this invention is a brain streaming support system that includes an emotion engine that recognizes the user's emotions. The system receives thematic input from the user and generates ideas and questions related to that theme. The generated ideas are evaluated based on the user's emotions, and new ideas are generated based on the results. Specifically, if the user is exhibiting feelings of joy, positive ideas that are consistent with those feelings are generated. Conversely, if the user is expressing sadness, ideas are generated that suggest solutions that correspond to that emotion.

### Example of Implement 2

Another exemplary embodiment of the invention is a brain streaming support system in which an emotional engine adjusts the evaluation criteria of the evaluation method. In this system, the evaluation criteria are adjusted based on the user's emotions. Specifically, if the user is in an excited state, the evaluation criteria are set higher to match that emotion, making it easier for more challenging ideas to be evaluated. Conversely, when the user is calm, the evaluation criteria are set lower to match the user's emotions, and more realistic ideas are more likely to be evaluated.

### Example of Implement 3

Yet another exemplary embodiment of the invention is a brain streaming support system that utilizes information from the minutes of a web conferencing tool. In this system, new ideas are generated based on information from the minutes of a web conferencing tool. Specifically, the emotional engine analyzes the users' emotional information recorded in the minutes, and idea generation and evaluation are adjusted based on the results. For example, if “expectations for new business development” is recorded in the minutes, positive ideas that match the expectations are generated based on this information.

The following is a description of the process flow for each example of implement.

### Example of Implement 1

Step 1: Receive theme input from user.

Step 2: Generate ideas and questions related to the theme.

Step 3: The user's emotions are recognized by the emotion engine.

Step 4: Evaluate the ideas generated based on the recognized emotions.

Step 5: Generate new ideas based on evaluation results.

### Example of Implement 2

Step 1: Recognize the user's emotions with the emotion engine.

Step 2: Adjust the evaluation criteria of the evaluation instrument based on the recognized emotions.

Step 3: Evaluate ideas based on adjusted evaluation criteria.

Step 4: Generate new ideas based on evaluation results.

### Example of Implement 3

Step 1: Retrieve information from the minutes of the web conferencing tool.

Step 2: Generate new ideas based on the information obtained.

Step 3: The emotional engine analyzes the user's emotional information recorded in the minutes.

Step 4: Adjust idea generation and evaluation based on analysis results.

### Example 1

Next, example 1 of exemplary embodiment of implement will be described. In the following description, data processing device 12 is referred to as the “server” and robot 414 is referred to as the “terminal.

Conventional brainstorming support systems generate ideas and questions without considering the user's emotions, making it difficult to provide appropriate ideas and questions according to the user's emotional state. In addition, user satisfaction may decrease because the evaluation of generated ideas and questions is not based on the user's emotions. Furthermore, there is a problem of inadequate integration with meeting tools and inability to utilize information from meeting minutes, which reduces the efficiency of brainstorming.

The specific processing by the specific processing unit 290 of the data processing device 12 in Example 1 is realized by the following means.

In this invention, the server includes theme input means from the user, generative AI means for generating ideas and questions related to the theme, evaluation means for supporting expansion on the generated ideas, emotion recognition means for recognizing the user's emotions, emotion recognition means for evaluating the ideas and questions based on the emotion information, and new means for generating ideas and questions, and means for interfacing with input means and meeting tools. This makes it possible to provide appropriate ideas and questions according to the user's emotional state and improve user satisfaction. In addition, the information from the minutes of the meeting tool can be used to improve the efficiency of brainstorming.

The “user input method” is an interface for users to input brainstorming themes.

A “generative AI means” is an artificial intelligence mechanism that generates relevant ideas and questions based on user input on a topic.

The “evaluation method” is a function that evaluates the ideas and questions generated and provides feedback to the user.

The “emotion recognition means” is a technology for recognizing the emotional state of a user by analyzing the user's facial expressions and tone of voice.

The “means for evaluating ideas and questions based on emotional information and generating new ideas and questions” is a function for evaluating generated ideas and questions based on recognized user emotional information and generating further new ideas and questions.

An “input means” is an interface that allows users to enter information into the system.

The “means of linking with conferencing tools” is a function to link with conferencing tools to utilize information such as meeting minutes.

This invention is a brain streaming support system that generates relevant ideas and questions based on thematic input from the user, and evaluates and extends them according to the user's emotional state. An exemplary embodiment of this system is described below.

First, the user enters a theme in the input field on the terminal. For example, the user enters “new business development. The terminal sends this theme to the server. The server uses a generative AI model (e.g., a general natural language processing model) to generate ideas and questions related to the entered theme. The generated ideas and questions are, for example

### Sample Questions:

What are the market needs in new business development?”

What resources do you need for new business development?”

### Example Ideas:

We will leverage our existing customer base for new business development.”

“For new business development, consider the introduction of new technologies.”

The generated ideas and questions are sent from the server to the terminal. The terminal recognizes the user's emotions using emotion recognition means (e.g., common emotion recognition software). The user's facial expressions and tone of voice are analyzed to determine the emotional state of the user. For example, if the user is smiling, the emotion of joy is recognized.

The terminal sends the recognized emotion information to the server. The server evaluates the generated ideas and questions based on the emotion information and generates new ideas and questions. For example, if the user is indicating an emotion of joy, it generates positive ideas that are consistent with that emotion. Conversely, if the user is indicating an emotion of sadness, it generates ideas that suggest solutions that correspond to that emotion.

Finally, the server sends the evaluated ideas and questions to the terminal, which displays them to the user. The user can use these ideas and questions as a reference for further brainstorming.

As a specific example, if a user enters the topic “new business development,” the generative AI model will generate the following questions and ideas

### Sample Questions:

What is the market need for new business development?”

What resources do you need for new business development?”

### Example Ideas:

We will leverage our existing customer base for new business development.”

“For new business development, consider the introduction of new technologies.”

Examples of prompt statements may include the following

Generate ideas for new business development.”

Generate questions about market needs in new business development.”

In this way, the server, terminal, and user work together to create a system that supports brainstorming.

The flow of the identification process in Example 1 is described in FIG. 17.

### Step 1:

The user enters a theme.

The user enters the theme in the input field on the terminal and clicks on the submit button. For example, enter “New Business Development”. The input data is the theme text.

### Step 2:

The terminal sends the theme to the server.

The terminal sends the input theme “New Business Development” to the server using an HTTP POST request. The input data is the theme text and the output data is the request to the server.

### Step 3:

The server generates relevant ideas and questions using a generative AI model.

The server inputs the received themes into the generative AI model and generates related ideas and questions. For example, questions such as “What are the market needs for new business development?” and “What resources are needed for new business development?” are generated, as well as ideas such as “For new business development, leverage existing customer base” and “For new business development, consider introducing new technology. The input data is the theme text and the output data is a list of generated ideas and questions.

### Step 4:

Server-generated ideas and questions are sent to the terminal.

The server sends the generated ideas and questions to the terminal in JSON format. The input data is a list of generated ideas and questions, and the output data is the response to the terminal.

### Step 5:

The terminal recognizes the user's emotions using the emotion engine.

The terminal uses an emotion engine to analyze the user's facial expression and tone of voice to recognize the emotional state. For example, if the user is smiling, the emotion of joy is recognized. The input data is the user's facial expression and tone of voice, and the output data is the recognized emotion information.

### Step 6:

The terminal sends the recognized emotional information to the server.

The terminal sends the recognized emotion information to the server in JSON format. The input data is the recognized emotion information and the output data is the request to the server.

### Step 7:

The server evaluates ideas and questions based on emotional information and generates new ideas and questions.

The server evaluates the ideas and questions generated based on the emotional information received. For example, if the user indicates a feeling of joy, it generates positive ideas that are consistent with that feeling. Conversely, if the user is indicating an emotion of sadness, ideas are generated that suggest solutions that correspond to that emotion. The input data is the emotion information and the list of generated ideas and questions, and the output data is the list of evaluated ideas and questions.

### Step 8:

The server sends the final ideas and questions to the terminal.

The server finally sends the evaluated ideas and questions to the terminal in JSON format. The input data is the list of evaluated ideas and questions, and the output data is the response to the terminal.

### Step 9:

The terminal displays the final idea or question to the user.

The terminal displays the final ideas and questions received to the user. The user can use these ideas and questions as a reference for further brainstorming. The input data is the list of ideas and questions evaluated, and the output data is what is displayed to the user.

### Example of Application 1

Next, example of application 1 of example of implement 1 will be described. In the following description, the data processing device 12 is referred to as the “server” and the robot 414 is referred to as the “terminal.

Conventional brain-streaming support systems can generate ideas and questions based on thematic input from the user, but they do not take into account the user's emotions in generating and evaluating ideas, making it difficult to provide appropriate ideas according to the user's emotions. In addition, the lack of concrete means to generate ideas for new production processes and efficiency improvements in the factory makes the system less practical in the field.

The specific processing by specific processing unit 290 of data processing device 12 in example of application 1 is realized by the following means. In this invention, the server has the following means: theme input means from the user, generative AI means to generate ideas and questions related to the theme, evaluation means to support expansion on the generated ideas, input means from the WebUI and means to link with a web conferencing tool, emotion recognition means to recognize the user's emotions means, means to evaluate ideas generated based on emotions and generate new ideas, and means installed in the robot to generate ideas for new production processes and efficiencies in the factory. This makes it possible to provide appropriate ideas based on the user's emotions, thereby increasing their utility within the factory.

The “user input method” is an interface that allows users to enter a specific theme or topic.

Generative AI means” is an artificial intelligence function that generates relevant ideas and questions based on a theme entered by the user.

The “evaluation means” is a function for extending and evaluating the ideas generated.

The “means of input from the WebUI” is the means by which the user provides input through the web user interface.

The “means of linking with web conferencing tools” is a means of linking with web conferencing tools to share information or to use information from the minutes.

The “emotion recognition means” is a function to recognize the user's emotions.

The “means for evaluating ideas generated based on emotions and generating new ideas” is a function for evaluating ideas generated based on user emotions and generating new ideas based on the results.

The “means installed in a robot to generate ideas for new production processes and efficiencies in a factory” is a function installed in a robot to generate ideas for new production processes and efficiencies in a factory.

The system for implementing this invention includes theme input means from the user, generative AI means, evaluation means, input means from the WebUI, means for integration with web conferencing tools, emotion recognition means, means for evaluating ideas generated based on emotions and generating new ideas, means installed in a robot to generate new production processes in a factory and efficiency improvement ideas in the factory.

### Explanation of Program Processing

The server provides an interface for receiving theme input from users. When a user enters a theme, the server uses generative AI methods to generate ideas and questions related to that theme. The generative AI method uses a generative AI model, such as the OpenAI API, to generate relevant ideas and questions based on the input theme.

The generated ideas are extended and evaluated by the evaluation means. The evaluation means provides evaluation buttons, such as “original,” “realistic,” “review from a manager's point of view,” etc., allowing users to evaluate the generated ideas.

In addition, the emotion recognition means is used to recognize the user's emotions. The emotion recognition means uses the Emotion Recognition library and camera to analyze the user's emotions. Based on the recognized emotion, the means evaluates the generated ideas and generates new ideas. For example, if the user indicates an emotion of joy, a positive idea is added.

This includes means installed on robots to generate ideas for new production processes and efficiencies within the factory. The robot patrols the factory, receives thematic input from workers, and generates relevant ideas and questions using generative AI means. The generated ideas are evaluated based on the worker's emotions and new ideas are added as needed.

### Concrete Example

For example, if a user enters the theme “making a new production line more efficient,” the generative AI method will generate the following ideas and questions.

Example of a prompt statement: “I am a member of the

Topic: New production line efficiency

Generate relevant ideas and questions.

Generated ideas and questions:

Where are the bottlenecks in the production line?

What technologies are needed to promote automation?

How can we reduce the burden on workers?

Add positive ideas.

A new robot arm was introduced to improve work efficiency.

Motivate workers to take more breaks.

In this way, appropriate ideas can be provided according to the user's emotional state, thus increasing their practicality in the factory.

The flow of the identification process in Example of Application 1 is described in FIG. 18.

### Step 1:

The user enters a theme. The user enters the theme through the web user interface (WebUI). The entered theme is sent to the server. The input data is textual information about the theme.

### Step 2:

The server receives the input themes and passes them to the generative AI means. The generative AI means generates ideas and questions related to the theme using a generative AI model such as OpenAI API. The input data is textual information of the theme, and the output data is textual information of the generated ideas and questions.

### Step 3:

The server passes the generated ideas and questions to the evaluation means. The evaluation means provides evaluation buttons such as “original,” “realistic,” “review from a manager's point of view,” etc., to allow users to evaluate the generated ideas. The input data is the textual information of the generated ideas and questions, and the output data is the results of the user's evaluation.

### Step 4:

The server uses emotion recognition methods to recognize the user's emotions. The emotion recognition means uses the Emotion Recognition library and camera to analyze the user's emotions. The input data is the user's facial image and voice data, and the output data is information about the recognized emotion.

### Step 5:

The server evaluates the ideas generated based on the recognized emotions and uses the means to generate new ideas. For example, if the user indicates an emotion of joy, positive ideas are added. The input data is the information of the recognized emotion and the textual information of the generated ideas and questions, and the output data is the textual information of the new ideas evaluated based on the emotion.

### Step 6:

The server uses means installed on robots to generate ideas for new production processes and efficiencies within the factory. The robot patrols the factory, receives theme input from workers, and uses generative AI means to generate related ideas and questions. The input data is the textual information of the themes from the workers and the output data is the textual information of the generated ideas and questions.

### Step 7:

The server presents the generated ideas and questions to the workers. The workers can consider new production processes and ways to improve efficiency based on the ideas and questions presented. The input data is textual information of the generated ideas and questions, and the output data is feedback and new suggestions by the workers.

### Example 2

Next, example 2 of exemplary embodiment of implement will be described. In the following description, data processing device 12 is referred to as the “server” and robot 414 is referred to as the “terminal.

In conventional brain-streaming support systems, it was difficult to provide appropriate feedback and expansion to user-generated ideas, and the quality and creativity of ideas were not sufficiently enhanced. In addition, because evaluation criteria were set without considering the user's emotional state, there was also the problem that ideas were not evaluated appropriately according to the user's state. Furthermore, there was insufficient linkage with web conferencing tools, making it difficult to effectively utilize the ideas and minutes generated during meetings.

The specific processing unit 290 of the data processing device 12 in Example 2 is realized by the following means.

In this invention, the server has a means for inputting a theme from the user, a generative AI means for generating ideas and questions related to the theme, an evaluation means for supporting expansion on the generated ideas, a means for generating prompt text based on the type of evaluation button, a means for sending the generated prompt text to the generative AI means, a means for displaying the new ideas returned from the generative AI means to the user, an emotion engine means for analyzing the user's emotional state, and a means for adjusting the evaluation criteria based on the analysis results of the emotion engine means. means, a means for displaying the new ideas returned by the generative AI means to the user, an emotion engine means for analyzing the user's emotional state, a means for adjusting the evaluation criteria based on the analysis results of the emotion engine means, and a means for input from the WebUI and for linking with a web conferencing tool. The system includes. This enables the setting of appropriate evaluation criteria according to the user's emotional state and the generation and expansion of high-quality ideas by the generative AI. In addition, the linkage with the Web conferencing tool enables effective use of ideas and minutes generated during the meeting.

The “means of theme input from users” is an interface for users to input themes, such as new business development, into the system.

Generative AI means” is an artificial intelligence function that generates relevant ideas and questions based on a theme entered by the user.

The “evaluation method” is a function that allows users to evaluate the ideas generated and helps them expand on those ideas based on their evaluation.

The “Evaluation Buttons” are buttons that allow for “creative,” “realistic,” and “management's point of view review.”

The “means of generating prompt sentences” is a function that generates prompt sentences to be sent to the generative AI means based on the type of evaluation button pressed by the user.

The “means of transmitting to the generative AI means” is a function for transmitting the generated prompt sentences to the generative AI means.

The “means for displaying new ideas returned by the generative AI means to the user” is a function that receives new ideas returned by the generative AI means and displays them on the user's terminal.

The “emotion engine means” is a function for analyzing the user's emotional state.

The “means to adjust evaluation criteria” is a function that adjusts the evaluation criteria based on the analysis results of the emotion engine means.

The “means of input from the WebUI” is the ability for users to provide input to the system through the Web interface.

The “means of linking with web conferencing tools” is a function to link with web conferencing tools to capture ideas and minutes from meetings in the system.

This invention is a system in which a user inputs a theme, such as new business development, and a generative AI method is used to generate ideas and questions related to that theme, and to support expansion on the generated ideas. An exemplary embodiment of this system is described below.

### Hardware and Software Used

Server: Performs the core processing of this system. It executes the AI generation model, stores data, and provides the user interface.

Terminal: A device operated by a user, such as a PC or a smart device.

Generative AI models: Use generative AI models such as OpenAI's GPT-4.

Emotion Engine: Software to analyze the user's emotional state. For example, using Microsoft's Azure Cognitive Services emotion recognition API.

### System Process Flow

1. the user enters an idea

The user uses a terminal to enter ideas for new business development into the system's input form. For example, the user would enter, “For new business development, consider introducing new technology.

2. the user presses the “Rate” button

The user presses one of the rating buttons, such as “original,” “realistic,” or “review from a manager's point of view,” for the ideas entered by the user.

3. the server generates prompt statements

The server generates prompt sentences to be sent to the generative AI model based on the type of evaluation button pressed by the user. For example, if the button “Originally” is pressed, the server will generate the prompt sentence “What creative business will be possible with the introduction of new technology?”.

4. the server sends prompt statements to the generated AI model

The server sends the generated prompt sentences to the generative AI model. The generative AI model is running in the cloud.

5. generation AI model generates new ideas

The generative AI model generates new ideas based on the prompt sentence. For example, it generates ideas such as “New technologies will enable personalized marketing using AI.

6. display server-generated ideas to users

The server receives the new ideas returned from the generative AI model and displays them on the user's terminal.

7. an emotional engine analyzes the user's emotions (another exemplary embodiment)

While the user is inputting ideas, the emotion engine analyzes the user's facial expressions and voice to determine whether the user is in an excited or calm state.

8. the server adjusts the evaluation criteria (another exemplary embodiment)

The server receives the results of the emotion engine analysis and sets the evaluation criteria higher when the user is in an excited state, making it easier to evaluate challenging ideas. Conversely, if the user is in a calm state, the evaluation criteria are set lower, making it easier to evaluate realistic ideas.

### Concrete Example

### Example 1: Expansion of Ideas

User's operation: user enters the idea “For new business development, consider introducing new technologies” and presses the “Originally” rating button.

Server processing: The server sends a prompt statement to the generative AI model, “What creative business will be possible with the introduction of new technology?

Generative AI Model Response: The Generative AI Model generates new ideas such as “New technologies will enable personalized marketing using AI.

Display of results: The server displays the generated ideas on the user's terminal.

### Example 2: Using the Emotion Engine

User manipulation: the user inputs the idea “For new business development, consider introducing new technologies” and the emotion engine detects the user's state of excitement.

Server processing: The server sets the evaluation criteria high based on the analysis results of the emotion engine and sends a prompt statement to the generative AI model: “What challenging projects would be possible through the introduction of new technologies?

Generative AI Model Response: The generative AI model generates challenging ideas such as “The introduction of new technologies will allow us to build a fully automated smart city.

Display of results: The server displays the generated ideas on the user's terminal.

### Example of Prompt Text

What kind of creative projects will be possible through the introduction of new technologies?”

What realistic business opportunities will be made possible by the introduction of new technologies?”

What are the benefits, from a management perspective, of implementing new technologies?”

These are the exemplary embodiments of this system.

The flow of the identification process in Example 2 is described in FIG. 19.

### Step 1:

The user enters an idea.

The user opens a browser on his/her terminal and accesses the system's web page. In the input form, the user enters the following information: “For new business development, consider the introduction of new technologies. The entered data is sent from the terminal to the server.

Input: Idea entered by user

Output: Idea data sent to server

### Step 2:

The user presses the “Evaluate” button.

The user clicks one of the evaluation buttons, such as “original,” “realistic,” or “review from a manager's perspective. When the button is clicked, the information is sent from the terminal to the server.

Input: Information about the rating button pressed by the user

Output: Information on evaluation buttons sent to the server

### Step 3:

The server generates a prompt statement.

Based on the information of the evaluation buttons received by the server, it generates prompt sentences to be sent to the generative AI model. For example, if the button “Originally” is pressed, the prompt sentence “What kind of original business will be possible through the introduction of new technology?

Input: Rating button information

Output: Generated prompt statements

### Step 4:

The server sends prompt statements to the generated AI model.

The server sends the generated prompt sentences to the generative AI model. The generative AI model is running in the cloud.

Input: Generated prompt text

Output: Prompt statements sent to the generated AI model

### Step 5:

Generative AI models generate new ideas.

The generative AI model analyzes the prompt sentence and generates new ideas. For example, it generates ideas such as “New technologies will enable personalized marketing using AI. The generated ideas are returned to the server.

Input: Prompt statement

Output: New ideas generated

### Step 6:

The server displays the generated ideas to the user.

The server receives the new ideas returned from the generated AI model and sends them to the user's terminal at. The user's terminal displays the new idea on the screen.

Input: new ideas generated

Output: Idea displayed on user's terminal

### Step 7:

The emotion engine analyzes the user's emotions (another exemplary embodiment).

While the user is inputting ideas, the emotion engine analyzes the user's facial expressions and voice to determine whether the user is in an excited or calm state. The analysis results are sent to the server.

Input: user's facial expressions and voice data

Output: Results of analysis by the emotion engine

### Step 8:

The server adjusts the evaluation criteria (another exemplary embodiment).

When the server receives the results of the emotion engine analysis and the user is in an excited state, it sets the evaluation criteria higher, making it easier for challenging ideas to be evaluated. Conversely, if the user is in a calm state, the evaluation criteria are set lower, making it easier to evaluate realistic ideas.

Input: Emotion engine analysis results

Output: Adjusted evaluation criteria

### Example of Application 2

Next, example of application 2 of example of implement 2 will be described. In the following description, the data processing device 12 is referred to as the “server” and the robot 414 is referred to as the “terminal.

Conventional brainstorming support systems evaluate ideas without considering the user's emotional state, making it difficult to generate appropriate ideas according to the user's emotions. In addition, since the system was not designed for use on portable devices such as smartphones, users could not easily generate ideas anywhere.

The specific processing by the specific processing unit 290 of the data processing device 12 in example of application 2 is realized by the following means.

In this invention, the server includes theme input means from the user, generative AI means to generate ideas and questions related to the theme, and evaluation means to support expansion on the generated ideas. This makes it possible to detect the user's emotional state and adjust the evaluation criteria accordingly. Also, by including application means that are installed on a smartphone, users can easily perform idea generation anywhere.

The “Theme Input Method” is an interface for users to input brainstorming themes or topics.

Generative AI means” is an artificial intelligence function that automatically generates ideas and questions related to the input theme.

The “evaluation method” is a function that allows users to evaluate the ideas generated and helps them expand on those ideas based on their evaluation.

The “means of input from the WebUI” is the means by which a user inputs information through the Web user interface.

The “means of linking with web conferencing tools” is a means of linking with web conferencing tools to share information and utilize data such as meeting minutes.

The “emotion engine means” is a function that detects the user's emotional state and adjusts the system's behavior based on that information.

The “means of adjusting evaluation criteria” is a function that dynamically changes the criteria for evaluating ideas based on the user's emotional state.

An “application means installed on a smartphone” is a function of an application that is installed on a smartphone and can be used by users anywhere.

As an exemplary embodiment of this invention, the following system can be constructed.

First, the user enters a brainstorming theme using an application installed on his/her smartphone. The theme input method receives the theme entered by the user and sends it to the server.

The server uses generative AI means to generate ideas and questions related to the input theme. This generative AI means can use a generative AI model, such as GPT-3, for example. The generated ideas are displayed on the user's smartphone.

The user then presses a rating button for the displayed idea, such as “original,” “realistic,” “review from a manager's perspective,” etc. The evaluation method receives the user's rating and assists in expanding the idea accordingly.

In addition, the emotion engine means detects the user's emotional state. The emotion engine means can use an emotion detection library such as Affectiva, for example. Based on the emotional state, the means for adjusting the evaluation criteria operates to set the appropriate evaluation criteria according to the user's emotion.

The system also includes a means of input from the WebUI and a means of interfacing with web conferencing tools, which can extract information from meeting minutes and use it for idea generation.

As a concrete example, if a user inputs the theme “For new business development, consider introducing new technologies,” the generative AI method can generate the following prompt sentence.

Example of a prompt statement: “I am a member of the

I'm thinking about introducing new technology for new business development. What technologies should we introduce as an original approach?”

Based on this prompt statement, the generative AI model generates new ideas and provides them to the user. When the user presses the “Originally” rating button, the generative AI means generates a new idea, such as “What creative business can be made possible by the introduction of new technology?

In this way, a system in which the generative AI provides new ideas based on the user's emotional state and evaluation criteria is realized.

The flow of the identification process in example of application 2 is described in FIG. 20.

### Step 1:

Users launch the application installed on their smartphones and enter a brainstorming theme.

Input: Theme entered by user (e.g., “For new business development, consider introducing new technologies”)

Output: The input theme is sent to the server.

Specific action: The user enters a theme in the application's input field and presses the “Submit” button.

### Step 2:

The server uses generative AI methods to generate ideas and questions related to the input theme.

Input: User entered theme

Outputs: generated ideas or questions (e.g., “What creative projects could be made possible by the introduction of new technologies?”)

Specific behavior: The server prompts a GPT-3 or other generative AI model for a theme and retrieves the generated ideas.

### Step 3:

The generated ideas are displayed on the user's smartphone.

Input: generated ideas and questions

Output: Ideas and questions displayed on the smart phone screen

Specific behavior: The server sends the generated idea to the smartphone and the application displays it.

### Step 4:

The user presses a rating button for the ideas displayed, such as “original,” “realistic,” or “review from a manager's point of view.

Input: User's rating (e.g., “creatively”)

Output: The evaluation results are sent to the server.

Specific action: The user selects the “Rate” button and presses the “Submit” button.

### Step 5:

The server uses the emotion engine means to detect the user's emotional state.

Input: emotional data of the user (e.g., input from camera or microphone)

Output: Detected emotional state (e.g., “excited”)

Specific behavior: The server analyzes the user's emotional state using an emotion detection library such as Affectiva.

### Step 6:

The means of adjusting the evaluation criteria based on the emotional state operates.

Input: Detected emotional state

Output: Adjusted evaluation criteria (e.g., “creatively”)

Specific behavior: The server re-sets the evaluation criteria according to the emotional state.

### Step 7:

The server generates new ideas based on evaluation criteria.

Input: adjusted evaluation criteria, initial ideas

Outputs: new ideas (e.g., “What creative projects could be made possible by the introduction of new technologies?”)

Specific behavior: The server again prompts the generative AI model to generate new ideas.

### Step 8:

New ideas are displayed on the user's smartphone.

Input: Newly generated ideas

Output: New ideas displayed on smartphone screens

Specific behavior: The server sends new ideas to the smartphone and the application displays them.

### Example 3

Next, example 3 of exemplary embodiment of implement will be described. In the following description, the data processing device 12 is referred to as the “server” and the robot 414 is referred to as the “terminal.

Conventional brain-streaming support systems mainly generate ideas based on input information from the user, and could not utilize the minutes data from web conferencing tools. As a result, important information and ideas discussed during the meeting were not fully utilized, making efficient idea generation difficult. In addition, there was insufficient support for evaluation and expansion of generated ideas, making it difficult for users to effectively utilize the generated ideas.

The specific processing by the specific processing unit 290 of the data processing device 12 in Example 3 is realized by the following means. In this invention, the server has a means for inputting themes from users, a means for generating ideas and questions related to the themes, a means for evaluating the generated ideas to support expansion, a means for input from the WebUI and a means for linking with a web conferencing tool, a means for acquiring minutes data from the web conferencing tool means to acquire the minutes data from the web conferencing tool, means to analyze the acquired minutes data and extract important information, means to generate and send prompt sentences to the generative AI model based on the extracted information, and means to store the generated ideas. This makes it possible to efficiently generate new ideas using the minutes data from the web conferencing tool, and to support evaluation and expansion on the generated ideas.

The “user input method” is an interface that allows users to input information about a particular theme or topic.

Generative AI means” is an artificial intelligence function that generates relevant ideas and questions based on input themes.

The “evaluation method” is a function that allows users to evaluate the ideas generated, and then supports the expansion and improvement of those ideas based on the evaluation results.

The “means of input from the WebUI” is the means by which a user inputs information through the Web user interface.

The “means of linking with web conferencing tools” is a function to link the system with web conferencing tools to obtain and utilize information during a meeting.

The “means to retrieve the minutes data from the web conferencing tool” is a function to automatically retrieve the minutes data of a meeting from the web conferencing tool.

The “means to analyze acquired minutes data and extract important information” is a function to analyze acquired minutes data and extract important information discussed during the meeting.

The “means to generate and send prompt sentences to a generative AI model based on the extracted information” is a function to generate and send prompt sentences to a generative AI model based on the extracted information.

A “means of storing generated ideas” is a function for storing ideas generated from a generative AI model in a database or other location.

This invention is a system including means for inputting themes from users, generative AI means, evaluation means, input means from the WebUI, means for linking with a web conferencing tool, means for acquiring minutes data from the web conferencing tool, means for analyzing the acquired minutes data and extracting important information, means for generating prompt statements based on the extracted information to a generative AI model The system includes a means to generate and send prompt sentences to a generative AI model based on the extracted information, and a means to store the generated ideas.

### Server Operation

The server first acquires the minutes data from the web conferencing tool (e.g., a common web conferencing tool). The API of the web conferencing tool is used for this acquisition. The acquired minutes data are analyzed using a natural language processing library (e.g., NLTK or SpaCy). As a result of the analysis, important keywords and phrases are extracted.

Next, the server generates prompt sentences to be sent to the generative AI model (e.g., OpenAI's GPT-3) based on the extracted information. For example, if the minutes contain the information “New business development requires the introduction of new technologies,” the server generates the prompt sentence “What new businesses can be developed through the introduction of new technologies?

The generated prompt sentences are sent to the generative AI model to generate new ideas. The generated ideas are stored in a database by the server. The stored ideas are later provided to users.

### Terminal Operation

The terminal sends information entered by the user through the WebUI to the server. For example, the user enters specific questions or requests regarding new business development. The terminal also receives the ideas generated by the server and displays them to the user. The user can provide further feedback based on the displayed ideas, which are also sent from the terminal to the server.

### User Behavior

Users enter information about new business development through the WebUI. For example, the user enters a specific question such as, “We are seeking ideas regarding the introduction of new technology. The user also uses a web conferencing tool to conduct a meeting, and the minutes of that meeting are captured by the system. The user reviews the ideas generated and provides feedback as needed.

### Concrete Example

1. minutes of the meeting: “New business development requires the introduction of new technologies.”

2. prompt statement for the generated AI model: “What new businesses can be developed by introducing new technologies?

A generative AI model might generate the following ideas based on this prompt sentence:

Developing an AI-based customer support system.”

“Building a Supply Chain Management System Using Blockchain Technology.”

Thus, the system utilizes the minutes data of the web conferencing tool to generate new ideas using a generative AI model. This allows users to efficiently obtain new business ideas. The flow of the identification process in Example 3 is described in FIG. 21.

### Step 1:

The server obtains the meeting minutes data from the web conferencing tool. Specifically, it downloads the meeting minutes data using the API of the Web conferencing tool. The input is authentication information such as meeting ID and API key, and the output is the acquired minutes data.

### Step 2:

The server analyzes the acquired minutes data. Specifically, text analysis is performed using a natural language processing library (e.g., NLTK or SpaCy). The input is the minutes data, and the output is the extracted important keywords and phrases.

### Step 3:

The server generates prompt sentences to be sent to the generative AI model based on the analysis results. For example, if the information includes “New business development requires the introduction of new technology,” the server generates the prompt sentence “What new business can be developed by introducing new technology? The input is the extracted keywords or phrases and the output is the generated prompt sentence.

### Step 4:

The server sends the generated prompt text to the generative AI model. Specifically, it sends an API request to the generative AI model (e.g., OpenAI's GPT-3). The input is the prompt sentence and the output is the generated idea.

### Step 5:

The server stores the ideas returned from the generative AI model in a database. Specifically, it executes an INSERT query against the database. The input is the generated ideas and the output is the confirmation information of the stored ideas.

### Step 6:

The terminal sends the information entered by the user through the WebUI to the server. Specifically, the user enters information into the input form and presses the submit button. The input is the information entered by the user and the output is the information sent to the server.

### Step 7:

The terminal receives the ideas generated by the server and displays them to the user. Specifically, it receives the response from the server and displays it in the WebUI. The input is the ideas received from the server and the output is the ideas displayed to the user.

### Step 8:

The terminal sends the feedback provided by the user to the server. Specifically, the user enters information into the feedback form and presses the submit button. The input is the feedback entered by the user and the output is the feedback sent to the server.

### Step 9:

Users enter information about new business development through the WebUI. Specifically, the user enters information in the input form and presses the submit button. The input is the information entered by the user and the output is the information sent to the terminal.

### Step 10:

The user uses a web conferencing tool to conduct a meeting. Specifically, the meeting is initiated and the minutes are automatically recorded. The input is the audio and text of the meeting, and the output is the recorded minutes data.

### Step 11:

The user reviews the generated ideas displayed on the terminal and provides feedback. Specifically, the user evaluates the displayed ideas, enters information in the feedback form, and presses the submit button. The input is the displayed ideas and user feedback, and the output is the feedback sent to the terminal.

### Example of Application 3

Next, example 3 of application of example of implement 3 will be described. In the following description, data processing device 12 is referred to as the “server” and robot 414 is referred to as the “terminal.

In conventional brain-streaming support systems, themes are input by the user and ideas are generated by a generative AI, but the quality and realism of the ideas generated are limited because the system does not fully utilize the content of the discussions at the meeting and the emotional information of the participants. In addition, the evaluation of generated ideas and suggestions tend to be subjective, making it difficult to efficiently select the most useful ideas.

The specific processing by specific processing unit 290 of data processing device 12 in example of application 3 is realized by the following means. In this invention, the server has a means of inputting themes from users, a means of generating ideas and questions related to the themes, a means of evaluating the generated ideas to support expansion, a means of input from the WebUI and a means of linking with web conferencing tools, a means of analyzing the content of the minutes and extracting keywords and emotional information, an idea generation means to generate new ideas based on the extracted information, and an evaluation and suggestion means to evaluate the generated ideas and suggest the most useful ideas. This enables the generation of high-quality, realistic ideas based on the content of the discussions in the meeting and the emotional information of the participants, as well as efficient evaluation and suggestion of ideas.

The “user input method” is an interface that allows users to input discussion and idea generation themes to the system.

Generative AI means” is an artificial intelligence function that generates relevant ideas and questions based on input themes.

The “evaluation means” is a function for extending and evaluating the ideas generated.

The “means of input from the WebUI” is the means by which input is received from the user through the web user interface.

The “means of interfacing with web conferencing tools” is the means of interfacing the system with web conferencing tools to capture meeting minutes and other information.

The “analysis method for analyzing the content of minutes” is a function for analyzing the content of minutes imported from a web conferencing tool and extracting important keywords and emotional information.

The “idea generation means” is a function for generating new ideas based on the information extracted by the analysis means.

The “evaluation and suggestion means” is a function to evaluate the generated ideas and suggest the most useful ideas.

The following system configuration is an exemplary embodiment of this invention.

### System Configuration

The system includes means for theme input from users, generative AI, evaluation, input from the WebUI, integration with web conferencing tools, analysis of the content of the proceedings, idea generation, and evaluation suggestions.

### Program Processing

The server will perform the following

1. means of user input on the theme: 1.

Provide an interface for users to enter discussion and idea generation topics for the system. For example, use a form that runs on a web browser.

2. generative AI measures: (1)

Generate relevant ideas and questions based on the input theme. Generative AI models such as OpenAI's GPT-3 are used here.

3. evaluation instruments:

Extensions and evaluations are performed on the generated ideas. Evaluation is done using evaluation buttons such as “original,” “realistic,” “review from a manager's perspective,” etc.

4. input means from WebUI:

Receive input from the user through the web user interface. For example, a rating is entered by a user clicking on the rating button.

5. means of interfacing with web conferencing tools:

Integrate the system with a web conferencing tool (e.g., Zoom) to capture meeting minutes and other information; use the API to automatically retrieve meeting minutes.

6. analytical means for analyzing the content of the minutes:

Analyze the content of minutes imported from web conferencing tools to extract important keywords and emotional information. Here, natural language processing libraries such as TextBlob are used.

7. idea generation tools

Generate new ideas based on the information extracted by the analysis method. Generate prompt sentences and generate ideas using a generative AI model.

8. proposed means of evaluation

Evaluate the generated ideas and suggest the most useful ideas. Based on the evaluation results, present the highest rated ideas to the user.

### Concrete Example

For example, if the minutes of a Zoom meeting state that “a new robot arm needs to be installed,” the analysis method extracts this information and sends the following prompt statement to the generative AI model.

Example of a prompt statement: “I am a member of the

Key words in the proceedings: new robot arm, introduction, production efficiency

Emotional information: Positive

Use this information to generate ideas for new manufacturing techniques and production line improvements.

The generative AI model generates ideas about “how the new robot arm will improve production efficiency” based on this prompt sentence. The generated ideas are evaluated by the evaluation method, and the most useful ideas are suggested to the user.

In this way, high-quality, realistic ideas can be generated based on the content of the meeting discussions and the emotional information of the participants, and ideas can be efficiently evaluated and proposed.

The flow of the identification process in example of application 3 is described in FIG. 22.

### Step 1:

The user enters a theme. The user uses a form on a web browser to enter a discussion or idea generation theme. The entered themes are sent to the server and stored in the database.

### Step 2:

The server generates ideas using generative AI methods. The server sends prompt statements to a generative AI model (e.g., OpenAI's GPT-3) based on the stored themes to generate related ideas and questions. The generated ideas are returned to the server and stored in a database.

### Step 3:

The server provides the means of evaluation. Users review the generated ideas through the web UI and enter their evaluation by clicking on the evaluation buttons such as “original,” “realistic,” “review from management's point of view,” etc. The evaluation results are sent to the server and stored in a database.

### Step 4:

The server uses a means of interfacing with the web conferencing tool to capture the minutes of the meeting. The server automatically retrieves the meeting minutes using the API of the web conferencing tool (e.g., Zoom). The retrieved minutes are stored on the server.

### Step 5:

The server analyzes the content of the minutes. The server analyzes the stored minutes and extracts important keywords and emotional information using a natural language processing library such as TextBlob. The extracted information is stored on the server.

### Step 6:

The server generates new ideas using idea generation methods. The server sends prompt sentences to the generative AI model based on the extracted keywords and emotional information to generate new ideas. The generated ideas are returned to the server and stored in the database.

### Step 7:

The server evaluates and suggests ideas using the evaluation and suggestion method. The server evaluates the generated ideas and suggests the most useful ideas to the user. Based on the evaluation results, the highest rated idea is presented to the user.

The specific processing unit 290 sends the results of the specific processing to the robot 414. In robot 414, control unit 46A causes speaker 240 and control target 443 to output the results of specific processing. Microphone 238 acquires audio indicating user input to the result of the specific processing. The control unit 46A transmits the voice data indicating the user input acquired by the microphone 238 to the data processing device 12. In the data processing device 12, the specific processing unit 290 acquires the voice data.

The data generation model 58 is so-called Generative AI (Artificial Intelligence). An example of a data generation model 58 is a generative AI such as ChatGPT (Internet search <URL: https://openai.com/blog/chatgpt>). The data generation model 58 is obtained by having a neural network perform deep learning. Prompts containing instructions are input to the data generation model 58, as well as data for inference, such as voice data indicating voice, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the robot 414.

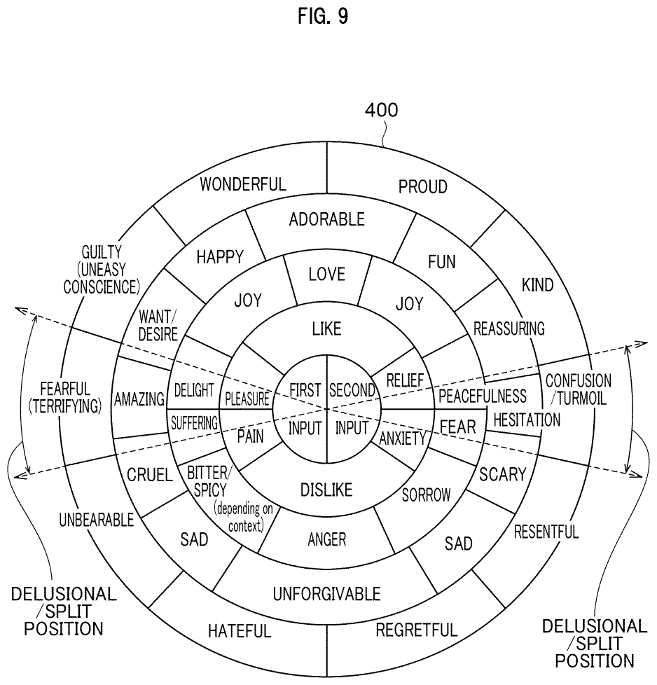

The emotion identification model 59, as the emotion engine, may determine the user's emotion according to a specific mapping. Specifically, the emotion identification model 59 may determine the user's emotion according to a specific mapping, the emotion map (see FIG. 9). The emotion identification model 59 may similarly determine the robot's emotion, and the specific processing unit 290 may perform the identification process using the robot's emotion.

FIG. 9 shows an emotion map 400 in which multiple emotions are mapped. In emotion map 400, the emotions are arranged in concentric circles radiating from the center. The closer to the center of the concentric circles, the more primitive state emotions are arranged. The more outward of the concentric circles are placed the emotions that represent states of mind and actions that arise from the state of mind. Emotion is a concept that includes emotional and mental states. On the left side of the concentric circles are the emotions that are generally generated from the reactions that occur in the brain. On the right side of the concentric circles are the emotions that are generally induced by situational judgments. On the upper and lower sides of the concentric circles are the emotions that are generally generated from the reactions that occur in the brain and are guided by situational judgments. In addition, “pleasant” emotions are placed on the upper side of the concentric circles, and “unpleasant” emotions are placed on the lower side. Thus, in emotion map 400, multiple emotions are mapped based on the structure in which emotions are generated, and emotions that tend to occur simultaneously are mapped close together.

These emotions are distributed in the 3 o'clock direction of the emotion map 400 and usually move back and forth between relief and anxiety. In the right half of the emotion map 400, situational awareness predominates over internal sensations, resulting in a calm impression.

Since the inside of the emotion map 400 represents the mind and the outside of the emotion map 400 represents behavior, the further outside of the emotion map 400, the more visible the emotion becomes (expressed in behavior).

Here, human emotions are based on various balances such as posture and blood glucose level, and when these balances move away from the ideal, they are unpleasant, and when they move closer to the ideal, they are pleasant. In robots, cars, motorcycles, etc., emotions can also be created based on various balances such as posture and battery level, with the state of discomfort when these balances move away from the ideal and pleasure when they move closer to the ideal. An emotion map may be generated based on, for example, Dr. Mitsuyoshi's emotion map (Research on Speech Emotion Recognition and Brain Physiological Signal Analysis System for Emotions, The University of Tokushima, PhD thesis: https://ci.nii.ac.jp/naid/500000375379). In the left half of the emotion map, emotions belonging to a region called “reaction,” in which the senses predominate, are lined up. In the right half of the emotion map, emotions belonging to the “situation” domain, in which situational awareness predominates, are lined up.

The emotion map defines two emotions that facilitate learning: one is the emotion around the middle of negative “repentance” or “remorse” on the situational side. That is, when the robot experiences negative emotions such as “I don't want to feel this way again” or “I don't want to be scolded again. The other emotion is around the positive “greed” on the reaction side. In other words, it is when the robot has a positive feeling of “wanting more” or “wanting to know more.

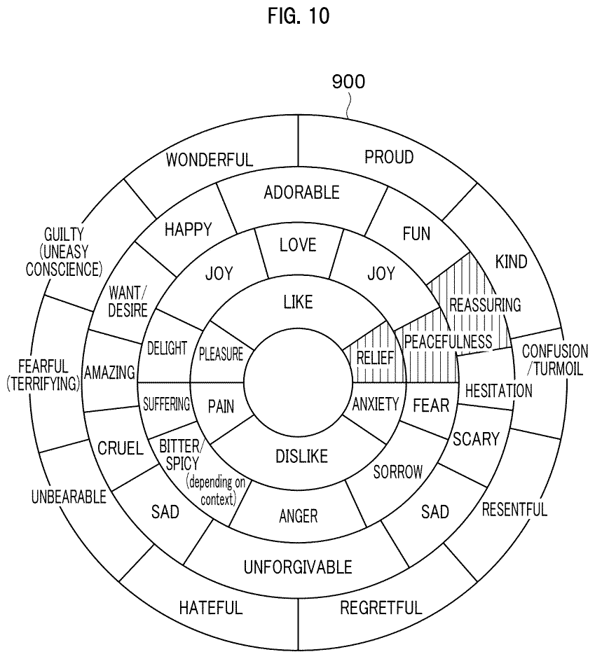

The emotion identification model 59 determines the user's emotion by inputting the user input into a neural network that has been trained in advance and obtaining an emotion value indicating each emotion shown in the emotion map 400. This neural network is pre-trained based on a plurality of training data, which are combinations of user input and emotion values indicating each emotion shown in the emotion map 400. This neural network is also learned so that emotions that are placed close to each other have close values, as shown in the emotion map 900 in FIG. 10. FIG. 10 shows an example in which multiple emotions, such as “safe,” “peaceful,” and “reassuring,” have close emotion values.

In the above exemplary embodiment, an example of implement in which specific processing is performed by one computer 22 is given, but the technology of the present disclosure is not limited to this, and distributed processing for specific processing may be performed by multiple computers including computer 22.

In the above exemplary embodiment, an example of implement in which specific processing program 56 is stored in storage 32 has been described, but the technology of the present disclosure is not limited to this. For example, the specific processing program 56 may be stored in a portable, computer-readable, non-transitory storage medium such as a USB (Universal Serial Bus) memory. The specific processing program 56 stored on the non-transitory storage medium is installed on the computer 22 of the data processing device 12. Processor 28 performs specific processing according to specific processing program 56.

The specific processing program 56 may be stored on a server or other storage device connected to the data processing device 12 via network 54, and the specific processing program 56 may be downloaded and installed on the computer 22 at the request of the data processing device 12.

It is not necessary to have all of the specific processing program 56 stored in a server or other storage device connected to the data processing device 12 via network 54, or to have all of the specific processing program 56 stored in storage 32, but a portion of the specific processing program 56 may be stored.

The following various processors can be used as hardware resources that execute the specific processing. Processors include, for example, CPUs, which are general-purpose processors that function as hardware resources that execute specific processing programs by executing software, i.e., programs. A processor can also be, for example, a field-programmable gate array (FPGA), programmable logic device (PLD), or application-specific integrated circuit (ASIC). For example, a dedicated electrical circuit, which is a processor with a circuit configuration designed specifically to perform a particular process, such as a FPGA (Field Programmable Gate Array), PLD (Programmable Logic Device), or ASIC (Application Specific Integrated Circuit). Any of these processors has a memory built in or connected to it, and any of them performs a specific process by using the memory.

The hardware resource that executes the specific processing may consist of one of these various processors or a combination of two or more processors of the same or different types (e.g., a combination of multiple FPGAs or a CPU and an FPGA). The hardware resource that performs the specific processing may be a single processor.

An example of implementing a single processor is, first, a form in which one processor is composed of a combination of one or more CPUs and software, and this processor functions as a hardware resource that executes a specific process. Second, there is a form that uses a processor that realizes the functions of the entire system, including multiple hardware resources that execute specific processing, in a single IC chip, as typified by a system-on-a-chip (SoC). Thus, the specific processing is realized using one or more of the various processors mentioned above as hardware resources.

Furthermore, the hardware structure of these various processors can be more specifically an electric circuit that combines circuit elements such as semiconductor devices. In addition, the above specific process is only an example. Therefore, it goes without saying that unnecessary steps may be deleted, new steps may be added, or the order of processing may be replaced to the extent that it does not deviate from the main purpose.

The descriptions and illustrations shown above are detailed descriptions of portions pertaining to the technology of the present disclosure and are only examples of the technology of the present disclosure. For example, the above description of the configuration, functions, actions, and effects is a description of one example of the configuration, functions, actions, and effects of the portion pertaining to the technology of the disclosure. Therefore, it goes without saying that unnecessary portions may be deleted, new elements may be added, or new elements may be substituted for the above description and illustration to the extent that it does not depart from the main purpose of the technology of the present disclosure. In addition, in order to avoid confusion and to facilitate understanding of the parts pertaining to the technology of the present disclosure, explanations regarding technical common sense, etc. that do not require particular explanation to enable implementation of the technology of the present disclosure have been omitted from the descriptions and illustrations shown above.

All references, patent applications, and technical standards described herein are incorporated by reference herein to the same extent that individual references, patent applications, and technical standards are specifically and individually noted as being incorporated by reference.

With respect to the above exemplary embodiments, the following is further disclosed

### (Claim 1)

A brain streaming support system that includes means for theme input from the user, generative AI means for generating ideas and questions related to the theme, evaluation means to support expansion on the generated ideas, and means for input from the WebUI and integration with web conferencing tools.

### (Claim 2)

Brain streaming support system according to claim 1, wherein the evaluation means provides evaluation buttons such as “creatively”, “realistically”, “review from a manager's point of view”, etc.

### (Claim 3)

A brain streaming support system, wherein the linkage means utilizes information from the minutes of a web conferencing tool.

### (Claim 4)

A brain streaming support system as claimed in claim 1, wherein the generative AI means includes an emotion engine that recognizes the user's emotions.

### (Claim 5)

The brain streaming support system of claim 4, wherein the emotion engine adjusts idea generation based on the user's emotions.

### (Claim 6)

The brain streaming support system of claim 4, wherein the emotion engine adjusts the evaluation criteria of the evaluation means based on the user's emotions.

### Example 1.”

### (Claim 1)

A means for users to input themes,
A means of converting the theme into a prompt sentence,
A means of transmitting the prompt sentence to the generative AI model, means of receiving output from the generated AI model,
A means of displaying the generated ideas and questions to the user,
A system that includes means of input from the WebUI and means of interfacing with web conferencing tools.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

### Example of Application 1.”

### (Claim 1)

A means for users to input themes,
Generative AI means to generate ideas and questions related to the theme,
An evaluation method that supports extensions to the generated ideas,
Input means from the WebUI and means of linking with web conferencing tools, means of generating ideas and questions to improve production efficiency in the plant,
A system that includes a learning method that provides feedback on generated ideas and questions and reflects this feedback in the next and subsequent generations.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

### Example 2.”

### (Claim 1)

A means for users to input themes,
Generative AI means to generate ideas and questions related to the theme,
An evaluation method that supports extensions to the generated ideas,
A means of generating prompt statements based on the evaluation, means of transmitting the generated prompt sentences to the generative AI model,
A means of returning responses from the generative AI model to the user,
A system that includes means of input from the WebUI and means of interfacing with web conferencing tools.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

### Example of Application 2.”

### (Claim 1)

A means for users to input themes,
Generative AI means to generate ideas and questions related to the theme,
An evaluation method that supports extensions to the generated ideas,
Input means from the WebUI and means of linking with web conferencing tools,
A means to help content creators generate new content ideas and extend them further with a rating button,
With application means installed on smartphones and head-mounted displays,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

### Example 3.”

### (Claim 1)

A means for users to input themes,
Generative AI means to generate ideas and questions related to the theme,
An evaluation method that supports extensions to the generated ideas,
Input means from the WebUI and means of linking with web conferencing tools,
A means of analyzing the minutes of web conferencing tools and extracting important information,
A means to create and send prompt sentences to the generative AI model based on the extracted information,
A system including means to display ideas generated from a generative AI model to users.

### (Claim 2)

The system as claimed in claim 1, wherein the evaluation means provides evaluation buttons such as “original”, “realistic”, “review from a manager's point of view”, etc.

### (Claim 3)

The system as described in the application is characterized in that the means of coordination utilizes information from the minutes of the proceedings of the web conferencing tool.

### Example of Application 3.”

### (Claim 1)

A means for users to input themes,
Generative AI means to generate ideas and questions related to the theme,
An evaluation method that supports extensions to the generated ideas,
Input means from the WebUI and means of linking with web conferencing tools,
A means of capturing the minutes of meetings that take place in the plant and using that information to generate ideas for new manufacturing processes and efficiencies,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

Example 1 for the combined emotional engine.”

### (Claim 1)

A means for users to input themes,
Generative AI means to generate ideas and questions related to the theme,
An evaluation method that supports extensions to the generated ideas,
Emotion recognition means to recognize the user's emotions,
A means of evaluating ideas and questions based on emotional information and generating new ideas and questions,
A system that includes input means and means of interfacing with conferencing tools.

### (Claim 2)

The system as claimed in claim 1, wherein the evaluation means provides evaluation buttons such as “original”, “realistic”, “review from a manager's point of view”, etc.

### (Claim 3)

The system described in claim 1, characterized in that the linkage means utilizes information from the minutes of the meeting tool.

Example of application 1 when combined with the Emotional Engine.”

### (Claim 1)

A means for users to input themes,
Generative AI means to generate ideas and questions related to the theme,
An evaluation method that supports extensions to the generated ideas,
Input means from the WebUI and means of linking with web conferencing tools,
Emotion recognition means to recognize the user's emotions,
A means of evaluating ideas generated based on emotions and generating new ideas,
With the means to be installed in robots to generate new production processes and efficiency ideas in the factory,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

Example 2 for the combined emotional engine.”

### (Claim 1)

A means for users to input themes,
Generative AI means to generate ideas and questions related to the theme,
An evaluation method that supports extensions to the generated ideas,
A means of generating prompt text based on the type of evaluation button,
A means of transmitting the generated prompt sentences to the generative AI means,
A means of displaying to the user the new ideas returned from the generative AI means,
Emotional engine means to analyze the emotional state of the user, means of adjusting the evaluation criteria based on the analysis results of the emotion engine means,
A system that includes means of input from the WebUI and means of interfacing with web conferencing tools.

### (Claim 2)

A system according to claim 1, characterized in that the evaluation means provides evaluation buttons such as “original”, “realistic”, “review from a manager's point of view”, etc.

### (Claim 3)

The system as described in claim 1, characterized in that the means of coordination utilizes information from the minutes of the web conferencing tool.

Example of application 2 when combined with an “emotional engine.”

### (Claim 1)

A means for users to input themes,
Generative AI means to generate ideas and questions related to the theme,
An evaluation method that supports extensions to the generated ideas,
Input means from the WebUI and means of linking with web conferencing tools,
An emotion engine means to detect the user's emotional state, means of adjusting the evaluation criteria based on the emotional state,
An application means to be installed on a smartphone,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

Example 3 for the combined emotional engine.”

### (Claim 1)

A means for users to input themes,
Generative AI means to generate ideas and questions related to the theme,
An evaluation method that supports extensions to the generated ideas,
Input means from the WebUI and means of linking with web conferencing tools,
A means of retrieving the minutes data from the web conferencing tool,
A means of analyzing the acquired minutes data and extracting important information,
A means to generate and send prompt sentences to the generative AI model based on the extracted information,
A means of storing the generated ideas,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

An example of application3 when combined with an “emotional engine.”

### (Claim 1)

A means for users to input themes,
Generative AI means to generate ideas and questions related to the theme,
An evaluation method that supports extensions to the generated ideas,
Input means from the WebUI and means of linking with web conferencing tools,
An analysis method that analyzes the content of the minutes and extracts keywords and emotional information,
An idea generation method to generate new ideas based on the extracted information,
An evaluation and suggestion method that evaluates the generated ideas and suggests the most useful ideas,
The system includes.

### (Claim 2)

The system as claimed in claim 1, wherein the evaluation means provides evaluation buttons such as “original”, “realistic”, “review from a manager's point of view”, etc.

### (Claim 3)

The system as described in claim 1, wherein the linking means utilizes information from the minutes of the web conferencing tool.

What is claimed is:

1. A system comprising:
a processor configured to:
accept theme input from a user;
generate ideas and questions related to the theme;
support extensions of the generated ideas;
recognize an emotional state of the user;
evaluate the generated ideas and questions based on the recognized emotional state and generate new ideas and questions; and
interact with an input device and conferencing tools.

2. The system of claim 1, wherein the processor is further configured to:
provide an interface for the user to evaluate the generated ideas.

3. The system of claim 1, wherein the processor is further configured to:
utilize information from meeting minutes of a web conferencing tool.
